(19) United States
(12) Patent Application Publication
(10) Pub. No.: US 2026/0303305 A1
(43) Pub. Date: Oct. 1, 2026

(54) Methods and Apparatus for Improved Resource Unit Allocation Signaling in Wireless Local Area Networks (WLANs)

(71) Applicant: Charter Communications Operating, LLC, St. Louis, MO (US)

(72) Inventors: Mehdi Ganji, Santa Rosa, CA (US); Maulik Vaidya, Escondido, CA (US); Nima Namvar, Charlotte, NC (US); Aditi Singh, Clovis, CA (US)

(21) Appl. No.: 19/097,815

(22) Filed: Apr. 1, 2025

(51) Int. Cl. H04L 5/00; H04L 69/322

(52) U.S. Cl. CPC H04L 5/0094; H04L 5/0044; H04L 69/322

(57) ABSTRACT

Efficient methods for signaling resource unit (RU) allocation in PPDUs, e.g., DL MU-PPDUs are implemented. An AP supports both joint type RU allocation and individual type RU allocation. The type of RU allocation, to be used for a particular PPDU, is selected based on the bandwidth of the PPDU and/or the number of multiplexed STA, which are to be allocation resources in the PPDU. The AP signals the type of RU allocation being used for the PPDU in a new RU allocation type subfield, e.g., included in U-SIG or in common field of EHT-SIG. If joint type RU allocation type is being used, RU allocation subfields are included as part of common field(s) with the number of RU allocation fields being a function of the BW. However, if the RU allocation type is individual RU allocation, then new per-STA RU allocation fields are included in the user specific field.

### FIELD

The present invention is directed to wireless communications, and more particularly, to methods and apparatus for efficiently signaling resource unit (RU) allocation, e.g., in Downlink (DL) Multi-User Physical layer Protocol Data Units (MU-PPDUs).

### BACKGROUND

IEEE 802.11 is a group of wireless standards for wireless local area networks (WLANs) sometimes referred to as Wi-Fi or WiFi. The IEEE 802.11 working group is currently developing the next generation of Wi-Fi, IEEE 802.11bn (Wi-Fi 8), also known as Ultra High Reliability (UHR). The latest approved amendment (before WiFi 8) is called Extremely High Throughput (EHT).

EHT includes support for various new fields including a new preamble field called the U-SIG field which stands for universal signal field. The U-SIG field will be used in IEEE 802.11be and future IEEE 802.11 generations.

Resource Units (RUs) in IEEE 802.11 will now be described. Resource Unit (RU) is a frequency unit in Orthogonal Frequency-Division Multiplexing (OFDM) transmission first introduced in 802.11ax Wireless Local Area Network (WLAN) which comprises a group of 78.125 kHz subcarriers (tones) that are 78.125 kHz apart. If several stations (STAs) share the same spectrum via different/non-overlapping RUs, the resulting Physical layer Protocol Data Unit (PPDU) is called an Orthogonal Frequency-Division Multiple Access (OFDMA) PPDU. If a single user occupies the whole transmission bandwidth (BW), the resulting PPDU is called a non-OFDMA PPDU.

In 802.11ax, only a single RU can be assigned to a station (STA) and an Access Point (AP) for both DownLink (DL) or UpLink (UL) transmissions.

Small-size RUs are: 26-tone RUs, 52-tone RUs, and 106-tone RUs. Large-size RUs are: 242-tone RUs, 484-tone RUs, 996-tone RUs, 2×996-tone RUs and 4×996-tone RUs. Drawing 100 of FIG. 1 represents the RU allocation for an 80 MHz BW. Drawing 100 illustrates: different sizes and different combinations of RUs, 12 guard tones 102 at one end of the BW, 11 guard tones 110 at the other end of the BW, null subcarriers 104, 108, and DC tones 106. Row 112 illustrates 80 MHz BW which includes 36 26-tone RUs. Row 114 illustrates 80 MHz BW which includes 16 52-tone RUs and 4 26-tone RUs. Row 118 illustrates 80 MHz BW which includes 8 106-tone RUs and 4 26-tone RUs. Row 120 illustrates 80 MHz BW which includes 4 242-tone RUs. Row 120 illustrates 80 MHz BW which includes 2 484-tone RUs. Row 122 illustrates 80 MHz spectrum which includes 1 966-tone RU.

Multiple Resource Units (MRUs) in IEEE 802.11 will now be described. Multiple Resource Unit (MRU) is one of the new key features introduced by IEEE 802.11 be amendment. In contrast to 802.11ax standard, which supports assigning only one RU to each STA, 802.11be supports assigning a MRU to each STA to enhance resource utilization. Small-size RUs can only be combined with other small-size RUs to form a small size MRU. Small-size MRUs are used for both uplink and downlink transmission in OFDMA format. Large-size RUs can only be combined with other large-size RUs to form a large size MRU. The large size MRUs are defined for both uplink and downlink transmission in non-OFDMA and OFDMA format. The small size MRUs defined for DL and UL OFDMA transmission are as follows: 52+26 tone MRU and 106+26 tone MRU. The large size MRUs defined for DL and UL non-OFDMA transmissions are as follows: 484+242 tone MUR, 996+484 tone MRU, 996+484+242 tone MRU, 2×996+484 tone MRU, 3×996 tone MRU, and 3×996+484 tone MRU. The large size MRUs defined for DL and UL OFDMA transmissions are as follows: 484+242 tone MUR, 996+484 tone MRU, 2×996+484 tone MRU, 3×996+484 tone MRU, 3×996 tone MRU, and 3×996+484 tone MRU.

FIGS. 2-5 illustrate examples of small-size MRUs. FIG. 2 is a drawing 200 which illustrates 52+26-tone MRUs in a OFDMA 20 MHz EHT PPDU, as indicated by title box 201. The 20 MHz BW includes RUs and/or MRUs as well as null subcarriers 202, 206 and DC tones 204. Row 208 illustrates 9 26-tone RUs within the 20 MHz BW. Row 210 illustrates 4 52-tone RUs within the 20 MHz BW. Grouping 212 illustrates 3 52+26-tone MRUs, which may be formed by combining a 26 tone RU and a 56 tone RU.

FIG. 3 is a drawing 300 which illustrates 52+26-tone MRUs in an each 80 MHz frequency subblock of an OFDMA 80 MHz, 160 MHz, or 320 MHz EHT PPDU, as indicated by title box 301. The 80 MHz BW includes RUs and/or MRUs as well as null subcarriers 302, 306 and DC tones 304. Row 308 illustrates 36 26-tone RUs within the 80 MHz BW. Row 310 illustrates 16 52-tone RUs within the 80 MHz BW. Grouping 312 illustrates 8 52+26-tone MRUs, which may be formed by combining a 26 tone RU and a 56 tone RU.

FIG. 4 is a drawing 400 which illustrates 106+26-tone MRUs in an OFDMA 20 MHz EHT PPDU, as indicated by title box 401. The 20 MHz BW includes RUs and/or MRUs as well as null subcarriers 402, 406 and DC tones 404. Row 408 illustrates 9 26-tone RUs within the 20 MHz BW. Row 410 illustrates 2 106-tone RUs within the 20 MHz BW. Grouping 412 illustrates 2 106+26-tone MRUs, which may be formed by combining a 106 tone RU and a 26 tone RU.

FIG. 5 is a drawing 500 which illustrates 106+26-tone MRUs in an each 80 MHz frequency subblock of an OFDMA 80 MHz, 160 MHz, or 320 MHz EHT PPDU, as indicated by title box 501. The 80 MHz BW includes RUs and/or MRUs as well as null subcarriers 502, 506 and DC tones 504. Row 508 illustrates 36 26-tone RUs within the 80 MHz BW. Row 510 illustrates 8 106-tone RUs within the 80 MHz BW. Grouping 512 illustrates 4 106+26-tone MRUs, which may be formed by combining a 106-tone RU and a 26-tone RU.

FIGS. 6-9 illustrate examples of large-size MRUs. FIG. 6 is a drawing 600 which illustrates allowed 996+484-tone MRUs in a 160 MHz BW, as indicated by title box 601. The 160 MHz BW includes RUs and/or MRUs as well as null subcarriers 602, 606 and DC tones 604. Row 608 illustrates 4 484-tone RUs within the 160 MHz BW. Row 610 illustrates 2 996-tone RUs within the 160 MHz BW. Row 612 illustrates an allowed 996+484-tone MRU1, which is formed by combining a 484 tone RU with a 996 tone RU, as shown. Row 614 illustrates an allowed 996+484-tone MRU2, which is formed by combining a 484 tone RU with a 996 tone RU, as shown. Row 616 illustrates an allowed 996+484-tone MRU3, which is formed by combining a 996 tone RU with a 484 tone RU, as shown. Row 618 illustrates an allowed 996+484-tone MRU4, which is formed by combining a 996-tone RU with a 484-tone RU, as shown.

FIG. 7 is a drawing 700 which illustrates allowed 484+242-tone MRUs in a 80 MHz BW, as indicated by title box 701. The 80 MHz BW includes RUs and/or MRUs as well as null subcarriers 702, 706 and DC tones 704. Row 708 illustrates 4 242-tone RUs within the 80 MHz BW. Row 710 illustrates 2 484-tone RUs within the 80 MHz BW. Row 712 illustrates an allowed 484+242-tone MRU1, which is formed by combining a 242 tone RU with a 484 tone RU, as shown. Row 714 illustrates an allowed 484+242-tone MRU2, which is formed by combining a 242 tone RU with a 484 tone RU, as shown. Row 716 illustrates an allowed 484+242-tone MRU3, which is formed by combining a 484 tone RU with a 242 tone RU, as shown. Row 718 illustrates an allowed 484+242-tone MRU4, which is formed by combining a 484-tone RU with a 242-tone RU, as shown.

FIG. 8 is a drawing 800 which illustrates allowed 3×996+484-tone MRUs in a 320 MHz BW, as indicated by title box 801. The 320 MHz BW includes RUs and/or MRUs as well as null subcarriers 802, 806 and DC tones 804. Row 808 illustrates 8 484-tone RUs within the 320 MHz BW. Row 810 illustrates 4 996-tone RUs within the 320 MHz BW. Row 812 illustrates an allowed 3×996+484-tone MRU1, which is formed by combining 1 484-tone RU with 3 996-tone RUs, as shown. Row 814 illustrates an allowed 3×996+484-tone MRU2, which is formed by combining 1 484-tone RU with 3 996-tone RUs, as shown. Row 816 illustrates an allowed 3×996+484-tone MRU3, which is formed by combining 3 996-tone RUs and 1 484-tone RU, as shown. Row 818 illustrates an allowed 3×996+484-tone MRU4, which is formed by combining 3 996-tone RUs and 1 484-tone RU, as shown. Row 820 illustrates an allowed 3×996+484-tone MRU5, which is formed by combining 3 996-tone RUs and 1 484-tone RU, as shown. Row 822 illustrates an allowed 3×996+484-tone MRU6, which is formed by combining 3 996-tone RUs and 1 484-tone RU, as shown. Row 824 illustrates an allowed 3×996+484-tone MRU7, which is formed by combining 3 996-tone RUs and 1 484-tone RU, as shown. Row 826 illustrates an allowed 3×996+484-tone MRU8, which is formed by combining 3 996-tone RUs and 1 484-tone RU, as shown.

RU allocation, in general, will now be described. An access point (AP) can assign specific RUs/MRUs to stations (STAs) for both uplink and downlink transmission.

For uplink transmission, AP can send a Trigger Frame to notify one or a few STAs to transmit their data stored in their buffer. The uplink transmission can be concurrent, either separated in Frequency Domain [OFDMA], or separated in spatial domain [Multi-User, Multiple Input, Multiple Output (MU-MIMO)]. In the Trigger frame, each STA is assigned specific RUs/MRUs for its transmission. A Trigger Frame, that is not a Multi-User Request-To-Send (MU-RTS) Trigger frame, allocates resources for and solicits one or more Trigger-Based (TB) PPDU transmissions. The Trigger frame also carries other information required by the responding STA to send a TB PPDU. In response to a Trigger Frame, STAs can send TB PPDUs to AP carrying their uplink data.

For downlink transmission, AP can send a MU PPDU to a few STAs concurrently carrying their corresponding DL data. In the PHY header of the MU PPDU, each STA is assigned specific RUs/MRUs. Then, each STA knows their assigned RUs/MRUs and will decode their received data correspondingly.

The RU allocation signaling for uplink transmission is per individual basis, meaning each STA is notified of its assigned RUs individually based on a look-up table. On the other hand, RU allocation signaling for downlink transmission is performed jointly. Based on a look-up table, a joint RU allocation configuration is sent to all the STAs that have data in the PPDU.

RU allocation, with regard to uplink, will now be described. From IEEE 802.11 ax, joint uplink transmission of STAs in frequency and spatial domain has been introduced which are called, OFDMA and MU-MIMO, respectively. In 802.11 ax, each STA would be assigned one RU only and the number of spatial streams would be up to 8 in total and 4 per STA. In 802.11 be, assigning multiple RUs (MRUs) to a single STA became possible and the number of spatial streams would increase to 16 in total and 4 per STA.

FIG. 9 includes drawing 900, which includes a Trigger frame 901, and illustrates Trigger frame format. The Trigger frame 901 includes a MAC header 902, which includes a frame control field 904, a duration field 906, a Receiver Address (RA) field 908, and a Transmitter Address (TA) field 910, as shown. The Trigger frame 901 further includes a common information field 912, a user information list field 914, a padding field 916, and a Frame Check Sequence (FCS) field 918, as shown. Row 920 indicates the size, in octets, of each of the fields (frame control field 904, duration field 906, RA field 908, TA field 910, common information field 912, user information list field 914, padding field 916, FCS field 918) is (2, 2,6, 6, 8 or more, variable, variable, 4), respectively. The User Info List field 914 contains 0 or more User Info fields.

FIG. 10 includes drawing 1000, which includes the EHT variant User Info field 1001. User Info field 1001 includes an AID12 field 1002, a RU allocation field 1004, a UL Forward Error Correction (FEC) coding Type field 1006, a UL Extremely High Throughput-Modulation and Coding Scheme (EHT-MCS) field 1008, a Reserved field 1010, a Spatial Stream (SS) Allocation Random Access Resource Units (RA-RU) Information field 1012, a UL Target Received Power field 1014, a PS160 field 1016 and a Trigger Dependent User Info field 1018. Row 1020 indicates the bit designation ranges for each of the fields (AID12 field 1002, RU allocation field 1004, UL FEC coding Type field 1006, UL EHT-MCS field 1008, Reserved field 1010, SS Allocation RA-RU Information field 1012, UL Target Received Power field 1014, PS160 field 1016) are (B0 to B11, B12 to B19, B20, B21 to B24, B25, B26 to B31, B32 to B38, B39), respectively. Row 1022 indicates the size, in bits, of each of the fields (AID12 field 1002, RU allocation field 1004, UL FEC coding Type field 1006, UL EHT-MCS field 1008, Reserved field 1010, SS Allocation RA-RU Information field 1012, UL Target Received Power field 1014, PS160 field 1016, Trigger Dependent User Info field 1018), is (12, 8, 1, 4, 1, 6, 7, 1, variable), respectively.

The RU allocation subfield 1014 along with the UL BW subfield in the Common information field 912 identifies the size and location of the RU. If the AID12 subfield 1002 is in the range of 1 to 2007, then the RU Allocation subfield indicates the RU allocated to the STA identified by the AID12 subfield. If the AID12 subfield is 0 or 2045, then the RU Allocation sub-filed 1004 indicating the starting RU of one or more contiguous RA-RUs allocated by the User Information field. If the AID 12 subfield 1002 is 2046, then the RU allocation subfield 1004 indicates an unallocated RU. The mapping of B7-B1 of the RU Allocation subfield 1004 along with their setting of B0 of the RU allocation subfield 1004 and the PS160 subfield 1016 in the EHT variant User Info field 1001 is defined in Table 9-46l of IEEE P802.11be Draft Standard for information technology-Tele-communications and information exchange between systems Local and metropolitan area networks-Specific requirements: Part 11: Wireless LAN Medium Access Control (MAC) and Physical Layer (PHY) Specifications, Amendment 2: Enhancements for extremely high throughput (EHT), D7.0 August 2024 which will be hereinafter referred to as Reference [1] and which is hereby expressly incorporated by reference in its entirety.

Note that the RU allocation overhead for each STA is 9 bits.

RU allocation, with regard to downlink, will now be described. In IEEE 802.11 be, MU PPDU format (EHT_MU) carries one or more Physical Layer (PHY) Service Data Units (PSDUs) to one or more users. FIG. 11 is a drawing 1100 including an exemplary EHT MU PPDU 1101 and illustrates EHT MU PPDU format. EHT MU PPDU 1101 includes a L-STF field 1102, a L-LTF field 1104, a L-SIG field 1106, a RL-SIG field 1118, a U-SIG field 1110, an EHT-SIG field 1111, an EHT-STF field 1114, EHT-LTF field 1116, . . . , EHT-LTF field 1118, data field 1120, and a PE field 1122. Row 1124 indicates the symbol duration for each of the fields (L-STF field 1102, a L-LTF field 1104, a L-SIG field 1106, a RL-SIG field 1108, a U-SIG field 1110, a EHT-SIG field 1112, a EHT-STF field 1114, and combination EHT-LTF field 1116, . . . , EHT-LTF field 1118), as (8 μs, 8 μs, 4 μs, 4 μs, 8 μs: 4 μs per symbol, 4 μs per symbol, depends on the GI+LTF size), respectively.

The EHT-SIG field 1112 provides signaling information required for STAs to interpret an EHT MU PPDU. In an EHT MU PPDU, the EHT-SIG field contains resource allocation information to allow STAs to look up the corresponding resources to be used in EHT modulated fields of the PPDU.

The EHT-SIG field of a 20 MHz EHT MU PPDU contains one EHT-SIG content channel. For OFDMA transmission and for non-OFDMA transmission to multiple users, the EHT-SIG field of an EHT MU PPDU that is 40 MHz or 80 MHz contains two EHT-SIG content channels. For OFDMA transmission and for non-OFDMA transmission to multiple users, the EHT-SIG field of an EHT MU PPDU that is 160 MHz or wider contains two EHT-SIG content channels per 80 MHz. For OFDMA transmission, EHT-SIG content channel includes common and user specific field. The Common field(s) contain information regarding the resource unit allocation such as the RU assignment to be used in the EHT modulated fields of the PPDU.

FIG. 12 is a drawing 1200 which illustrates EHT-SIG content channel 1202 for a 20 MHz EHT MU PPDU. The EHT-SIG content channel 1202 includes a common field 1204 and a user specific field 1206. The common field 1204 includes common encoding block 1207 including information 1208, which includes U-SIG overflow+1 RU Allocation-A subfields+CRC+Tail. The user specific field 1206 includes a plurality of user encoding blocks (1st user encoding block 1209, 2nd user encoding block 1211, . . . , final user encoding clock 1213), and padding 1216 (if present). Each of the user encoding blocks (1209, 1211) includes 2 user fields+CRC+Tail. Final user encoding block 1213 includes 1 or 2 user fields+CRC+Tail.

As the BW increases, the number of RU allocation subfields increases proportionally. Summing over all content channels, a single RU allocation subfield is required for every 20 MHz of BW. In short, for 20/40/80/160/320 MHz BW MU PPDUs, there are 1/2/4/8/16 RU allocation subfields. Each RU allocation subfield consists of a 9-bit mapping to the RU assignment listed in Table 36-34 Reference [1]. Note that the overhead for RU allocation signaling is: i) 9 bits for a 20 MHz PPDU; ii) 18 bits for a 40 MHz PPDU; 36 bits for an 80 MHz PPDU; 72 bits for a 160 MHz PPDU; and 144 bits for a 320 MHz PPDU.

The main problem with existing RU allocation in downlink is that the bit overhead increases proportionally to the BW, irrespective of the number of frequency multiplexed STAs. This issue of high bit overhead for RU allocations is especially prominent when the number of assigned STAs is small. Based on the above, there is a need for more efficient methods and apparatus to perform RU allocation in downlink.

### SUMMARY

Methods and apparatus, in accordance with the present invention, implement an efficient solution to the existing problem of bit overhead for RU allocation increasing proportionally to the BW irrespective of the number of frequency multiplexed STAs. An efficient solution, in accordance with the present invention, takes the number of multiplexed STAs into account and reduces the bit overhead for RU allocation for MU PPDUs. In accordance, with a feature of various embodiments, of the present invention, a hybrid solution is implemented, which comprises both joint and individual RU assignments, with the type of RU assignment being based on the BW and/or the number of STAs in the assigned RU allocations. In some such embodiments, for large BW MU PPDUs, an individual RU assignment approach is utilized, when the number of assigned STAs is less than a threshold; otherwise, a joint RU assignment approach is utilized. Using the method of the current invention, the bit overhead for signaling RU assignments in larger BW MU PPDUs is greatly reduced, on average over each of the possible scenarios, as compared to the current approach which uses a joint RU assignment approach irrespective of the number of STAs.

A exemplary method of operating an access point (AP), in accordance with some embodiments, comprises: determining, at the AP, a bandwidth to be used for a first physical layer protocol data unit (PPDU), said determined bandwidth being the bandwidth of the first PPDU; determining, at the AP, a number of stations (STAs) allowed to use resources of the first PPDU; determining a resource unit (RU) allocation type for the first PPDU based on at least one of: i) the bandwidth of the first PPDU and ii) the number of stations allowed to use resources of the first PPDU; and transmitting the first PPDU, said first PPDU including an allocation type subfield with a bit indicating the determined RU allocation type of the first PPDU.

A exemplary method of operating a first station (STA), in accordance with some embodiments, comprise: receiving a DL MU-PPDU; recovering a RU allocation type value communicated in an RU allocation type subfield of a PHY header of the received DL MU-PPDU; determining an RU allocation type being used in the DL MU-PPDU based on the recovered RU allocation type value; and identifying, based on the determined RU allocation type, set of RUs of the DL MU-PPDU which have been allocated to the first STA.

While various features are discussed in the above summary, all features discussed above need not be supported in all embodiments and numerous variations are possible. Additional features, details and embodiments are discussed in the detailed description which follows.

### BRIEF DESCRIPTION OF THE FIGURES

FIG. 1 is a drawing which represents RU allocation for an 80 MHz BW.

FIG. 2 is a drawing which illustrates 52+26-tone MRUs in an OFDMA 20 MHz EHT PPDU.

FIG. 3 is a drawing which illustrates 52+26-tone MRUs in an each 80 MHz frequency subblock of an OFDMA 80 MHz, 160 MHz, or 320 MHz EHT PPDU.

FIG. 4 is a drawing which illustrates 106+26-tone MRUs in an OFDMA 20 MHz EHT PPDU.

FIG. 5 is a drawing which illustrates 106+26-tone MRUs in an each 80 MHz frequency subblock of an OFDMA 80 MHz, 160 MHz, or 320 MHz EHT PPDU.

FIG. 6 is a drawing which illustrates allowed 996+484-tone MRUs in a 160 MHz BW.

FIG. 7 is a drawing which illustrates allowed 484+242-tone MRUs in a 80 MHz BW.

FIG. 8 is a drawing which illustrates allowed 3×996+484-tone MRUs in a 320 MHz BW.

FIG. 9 includes drawing which includes a Trigger frame and illustrates Trigger frame format.

FIG. 10 includes drawing, which includes the EHT variant User Info field.

FIG. 11 is a drawing which an exemplary EHT MU PPDU and illustrates EHT MU PPDU format.

FIG. 12 is a drawing which illustrates EHT-SIG content channel for a 20 MHz EHT MU PPDU.

FIG. 13 is a drawing illustrating an existing U-SIG field.

FIG. 14 is a drawing illustrating a novel U-SIG field, in accordance with the some embodiments of the present invention, which includes bit B20 as the new RU allocation type (RU AT) subfield.

FIG. 15 is a drawing illustrating an existing EHT-SIG field which includes a common field.

FIG. 16 is a drawing illustrating a novel EHT-SIG field, in accordance with the some embodiments of present invention, which includes bit B13 as the new RU allocation type (RU AT) subfield.

FIG. 17 is a drawing which includes an exemplary 20 MHz EHT MU PPDU, for the joint RU allocation type, in accordance with an exemplary embodiment.

FIG. 18 is a drawing which includes an exemplary 40 MHz EHT MU PPDU, for the joint RU allocation type, in accordance with an exemplary embodiment.

FIG. 19 is a drawing which includes an exemplary 80 MHz EHT MU PPDU, for the joint RU allocation type, in accordance with an exemplary embodiment.

FIG. 20 is a drawing which includes an exemplary 160 MHz EHT MU PPDU, for the joint RU allocation type, in accordance with an exemplary embodiment.

FIG. 21 is a drawing which includes an exemplary 320 MHz EHT MU PPDU, for the joint RU allocation type, in accordance with an exemplary embodiment.

FIG. 22 is a drawing which includes an exemplary 80 MHz or 160 MHz or 320 MHz EHT MU PPDU, for the individual RU allocation type, in accordance with an exemplary embodiment.

FIG. 23 is a drawing of a flowchart used to illustrate access point (AP) operation with regard to determination of a RU allocation type subfield value and RU allocation signaling to STAs, e.g., for a MU-PPDU, in accordance with the present invention.

FIG. 24 is a drawing of a plot, which illustrates Bit overhead comparisons of alternative RU allocation type communication methods for different size BW PPDUs.

FIG. 25 illustrates an example in which a 80 MHz PPDU is to be allocated to 2 OFDMA multiplexed STAs, with each STA occupying 40 MHz.

FIG. 26 illustrates a comparison, for the scenario of the example of FIG. 25, between the existing RU allocation approach and the proposed RU allocation approach, which uses individual RU allocation type signaling for this particular scenario, resulting in a reduction in the number of bits used for RU allocation.

FIG. 27 illustrates an example in which a 160 MHz PPDU is to be allocated to 2 OFDMA multiplexed STAs, with each STA occupying 80 MHz.

FIG. 28 illustrates a comparison, for the scenario of the example of FIG. 27, between the existing RU allocation approach and the proposed RU allocation approach, which uses individual RU allocation type signaling for this particular scenario, resulting in a reduction in the number of bits used for RU allocation.

FIG. 29 illustrates an example in which a 80 MHz PPDU is to be allocated to 4 OFDMA multiplexed STAs, with each STA occupying 20 MHz.

FIG. 30 illustrates a comparison, for the scenario of the example of FIG. 29, between the existing RU allocation approach, and a proposed RU allocation approach in which uses joint type RU allocation signaling for this particular scenario, and an alternative proposed RU allocation approach, which uses individual RU allocation type signaling for this particular scenario, resulting in a reduction in the number of bits used for RU allocation.

FIG. 31 illustrates an example in which a 80 MHz PPDU is to be allocated to 5 OFDMA multiplexed STAs, with 3 STAs occupying 20 MHz, 1 STA occupying a 106+25-RU#4, and 1 STA occupying a 106-RU#5.

FIG. 32 illustrates a comparison, for the scenario of the example of FIG. 31, between the existing RU allocation approach and the proposed RU allocation approach, which uses joint RU allocation type signaling for this particular scenario.

FIG. 33A is a first part of a flowchart of an exemplary method of operating an access point (AP) in accordance with an exemplary embodiment.

FIG. 33B is a second part of a flowchart of an exemplary method of operating an access point (AP) in accordance with an exemplary embodiment.

FIG. 33 comprises the combination of FIG. 33A and FIG. 33B.

FIG. 34A is a first part of a flowchart of an exemplary method of operating a station (STA) in accordance with an exemplary embodiment.

FIG. 34B is a second part of a flowchart of an exemplary method of operating a station (STA) in accordance with an exemplary embodiment.

FIG. 34 comprises the combination of FIG. 34A and FIG. 34B.

FIG. 35 is a drawing of an exemplary communications system in accordance with an exemplary embodiment.

FIG. 36 is a drawing of an exemplary access point (AP) in accordance with an exemplary embodiment.

FIG. 37 is a drawing of an exemplary station (STA) in accordance with an exemplary embodiment.

FIG. 38 is drawing of a plot, which illustrates a bit overhead comparison of the proposed hybrid RU allocation communication method to the existing RU allocation communication method for 80 MHz BW PPDUs.

FIG. 39 is drawing of a plot, which illustrates a bit overhead comparison of the proposed hybrid RU allocation communication method to the existing RU allocation communication method for 160 MHz BW PPDUs.

FIG. 40 is drawing of a plot, which illustrates a bit overhead comparison of the proposed hybrid RU allocation communication method to the existing RU allocation communication method for 320 MHz BW PPDUs.

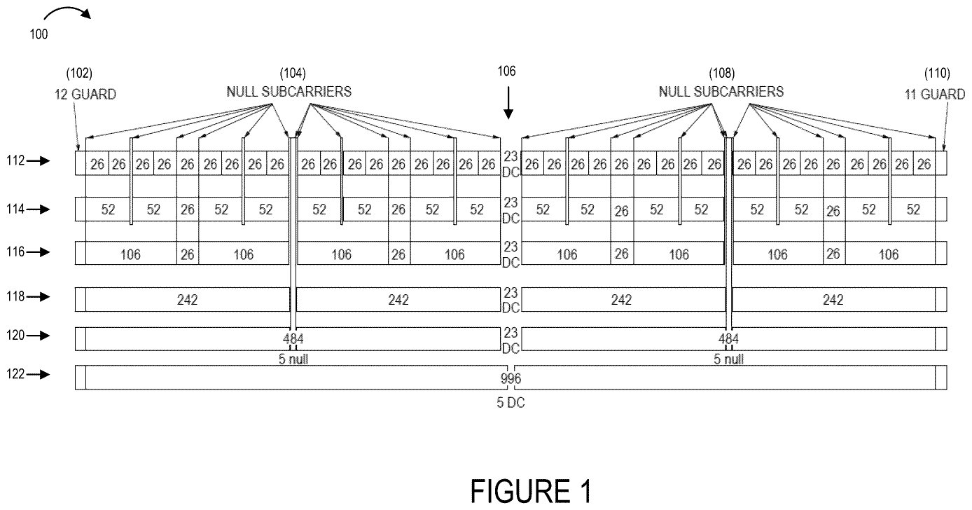

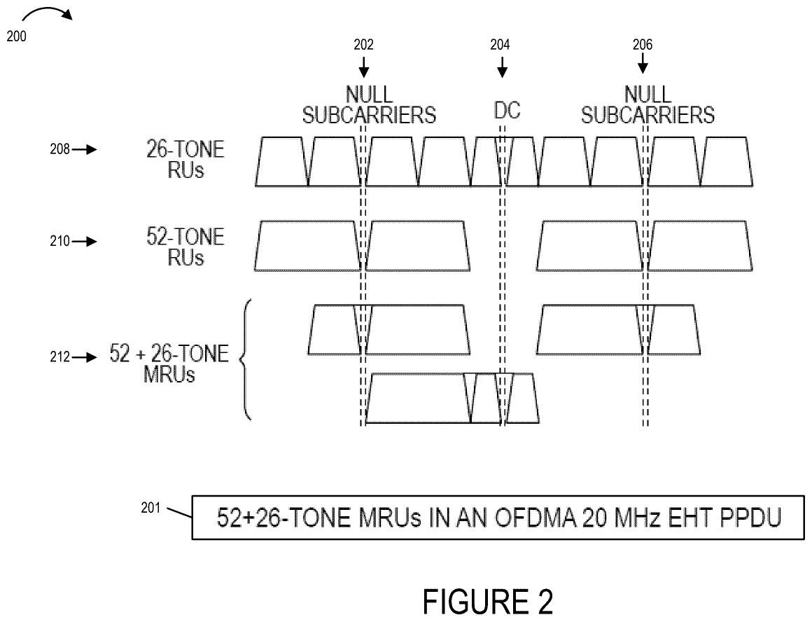

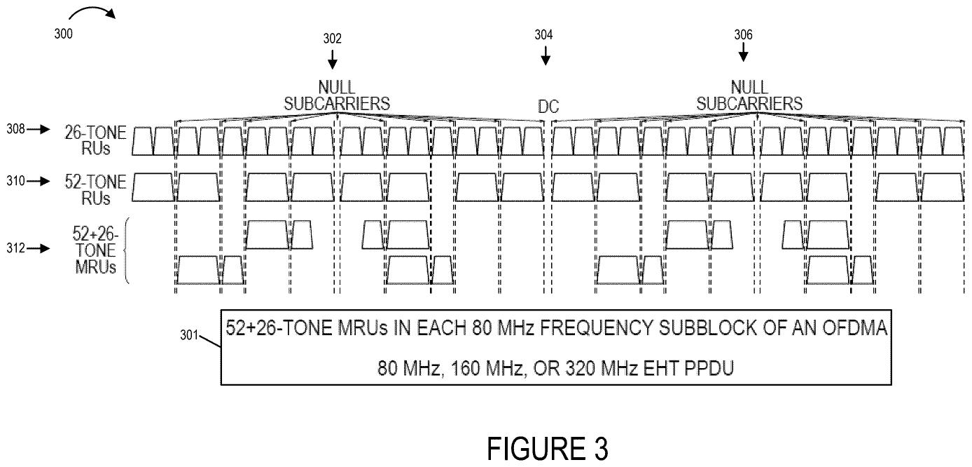

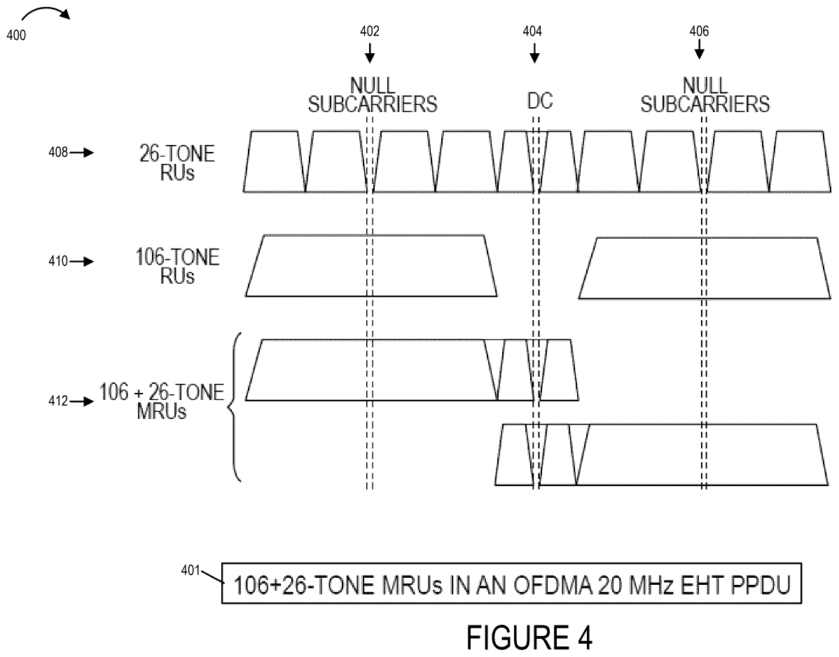

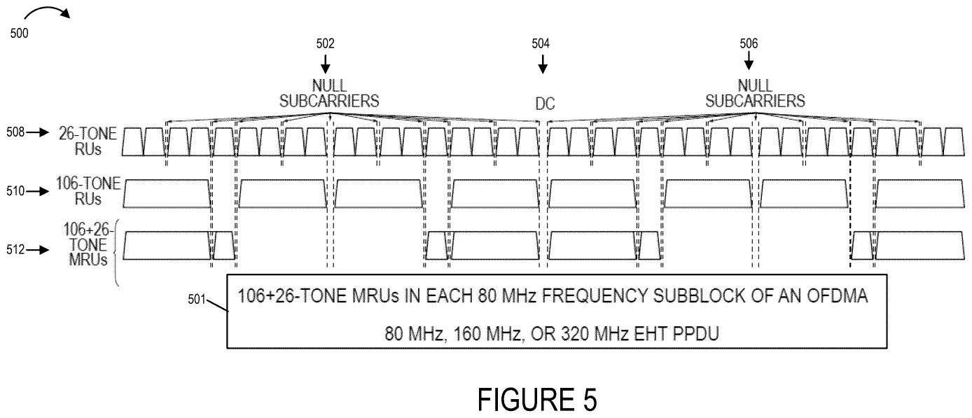

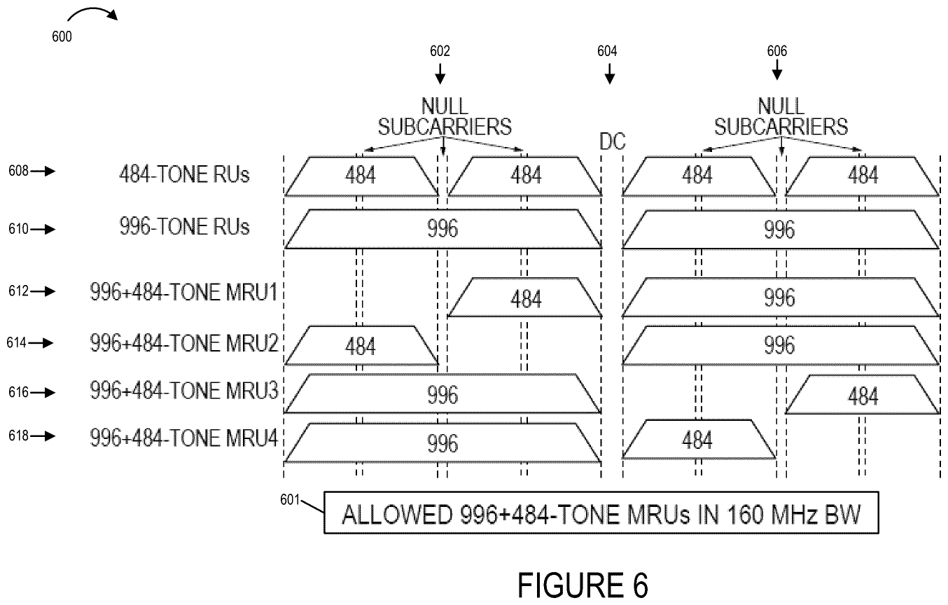

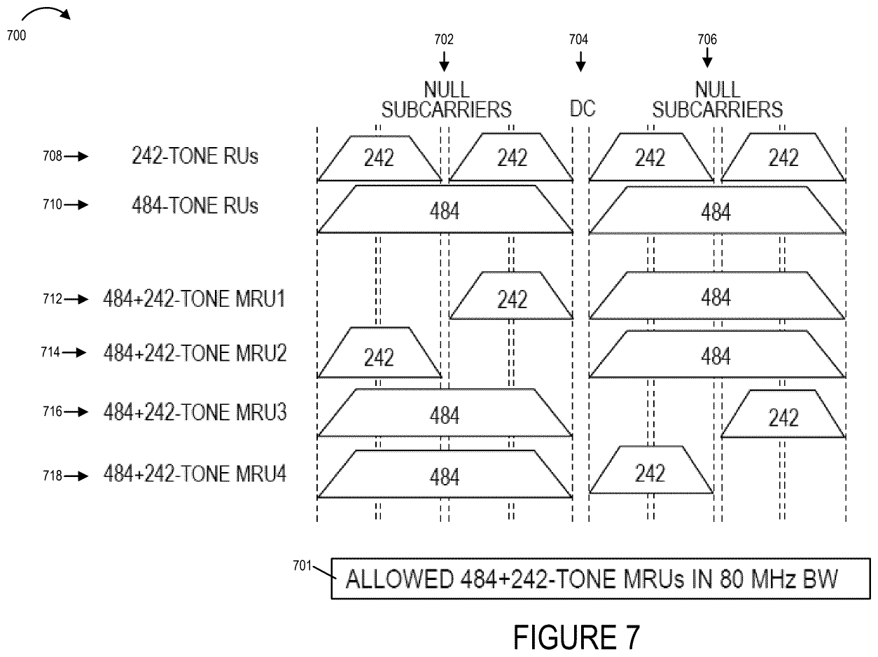

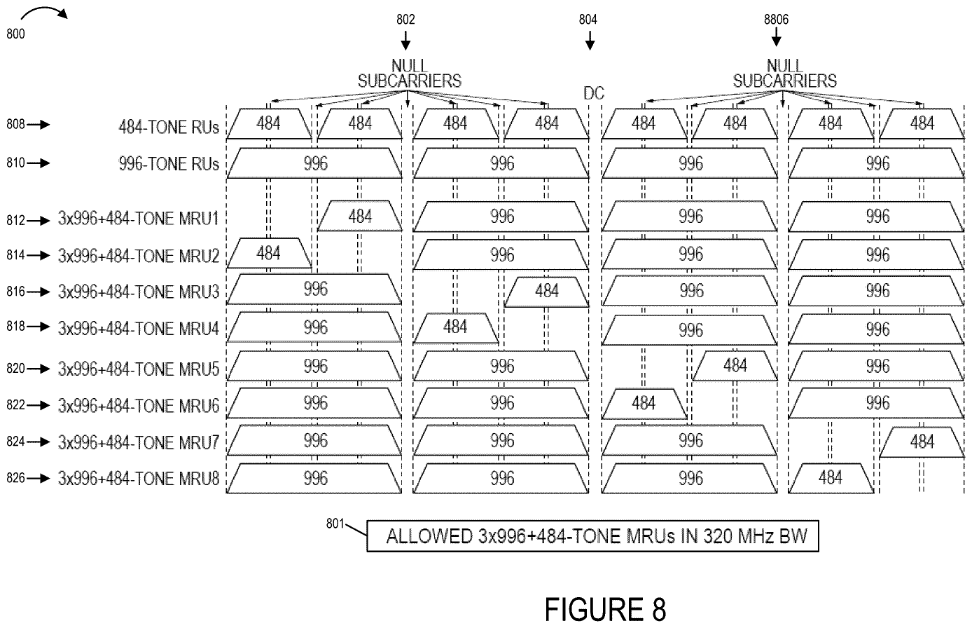

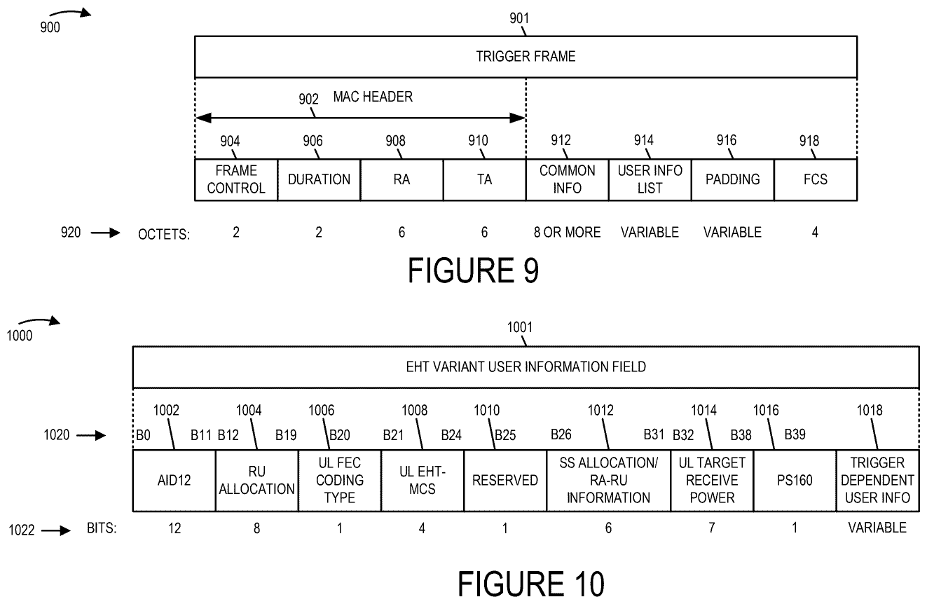

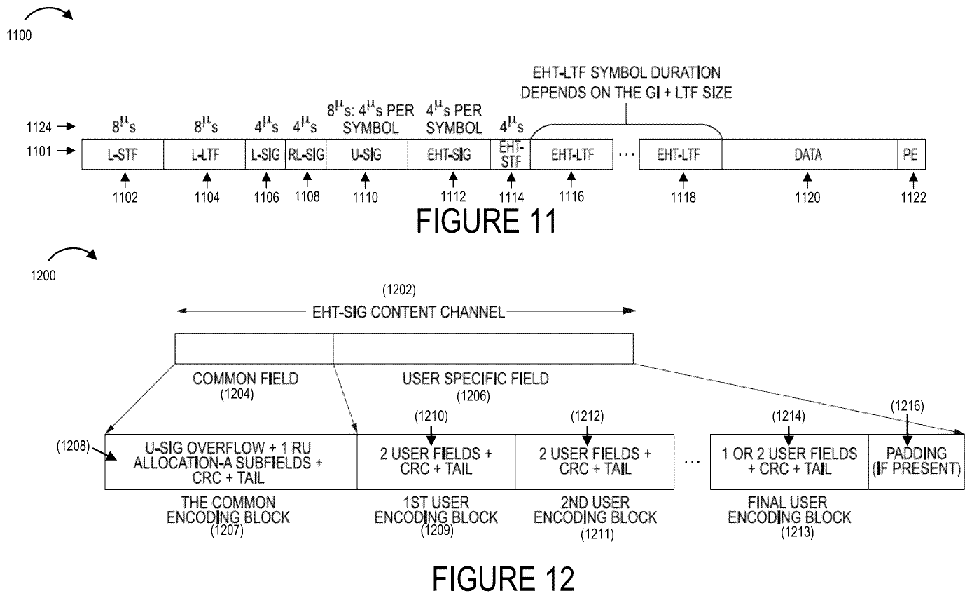

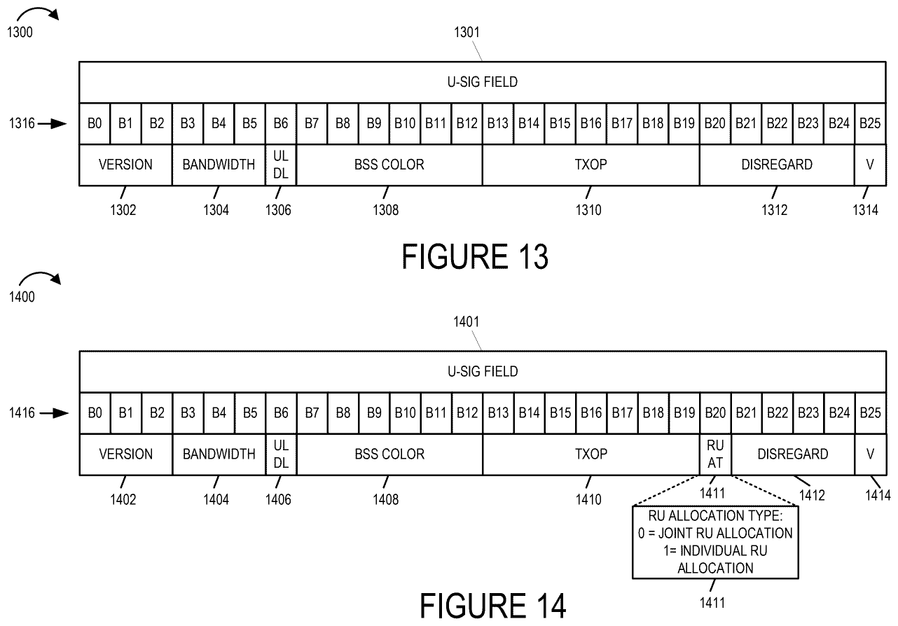

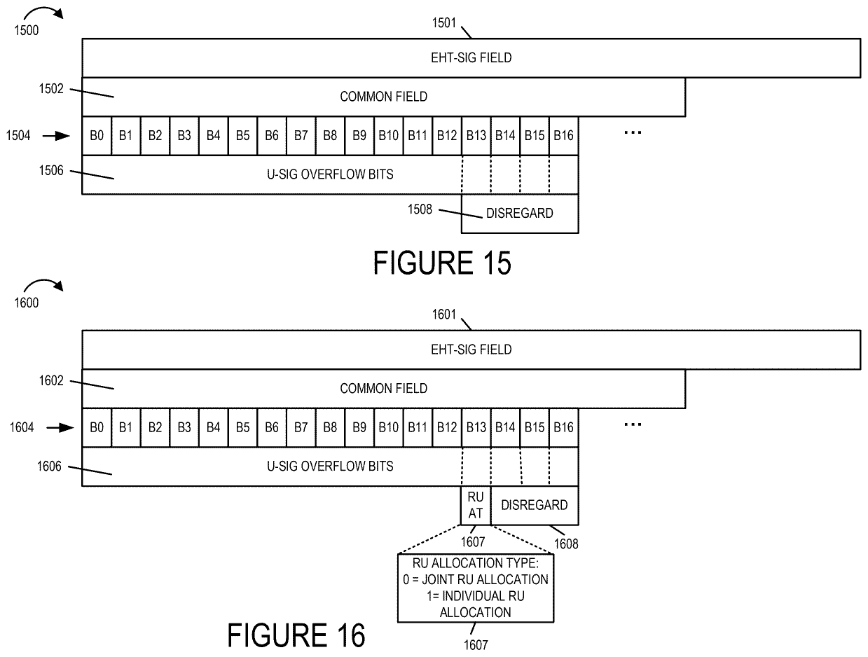

### DETAILED DESCRIPTION

For the individual RU assignment, in accordance with a feature of some embodiments of the present invention, existing mapping Table (Table 9-46l of Reference [1]) is utilized. Using the aforementioned Table (Table 9-46l of Reference [1]), the individual RU assignment approach requires 9 bits for signaling RU allocation to each STA. The existing lookup table enumerates mappings between possible RUs that are illustrated in this application and a 9 bit string.

For joint RU allocations in a mu-ppdu in some exemplary embodiments lookup table (Table 36-34) of Reference [1] is used. Lookup table (Table 36-34) of Reference [1] enumerates mappings between possible MRU/RU assignments to up to 9 users per 20 MHz BW. When using the table, the joint allocation overhead increases linearly with the size of PPDU bandwidth irrespective of number of users served on that PPDU.

In accordance with some embodiments of the present invention, hybrid signaling is applied for 80/160 and 320 MHz MU PPDUs. If the number of multiplexed STAs in the PPDU is less than Apr. 8, 2016, for 80/160/320 MHz PPDUs, respectively, the individual RU allocation approach is applied; otherwise, joint RU allocation approach is applied.

In various embodiments of the present invention, a new subfield, called RU allocation type, is introduced, implemented and used. In some such embodiments, the new RU allocation type subfield is included as part of U-SIG. In other embodiments, the new RU allocation type subfield is included as part of a SIG common field, e.g., an EHT-SIG common field. The RU allocation type is used to signal the type of RU allocation. In some embodiments, the RU allocation type subfield is a single bit field. In some embodiments, the RU allocation type field can take values of 0 and 1. In some such embodiments, a RU allocation type field value of 0 represents joint RU allocation, and a RU allocation type field value of 1 represents individual RU allocation.

For individual RU allocation, the RU allocation subfields are removed from the SIG common field, e.g. EHT-SIG common field, and instead a new subfield is added to each User field, signaling their individual RU assignment, e.g., using existing Table 9-46l of Reference [1].

For joint RU allocation, no changes are needed to existing fields/subfields typically used to communicate RU joint type allocation, e.g., for MU PPDUs.

With the introduction of this hybrid scheme, the bit overhead for RU signaling is greatly reduced when the number of users meets the aforementioned condition (number of multiplexed STAs in the PPDU is less than Apr. 8, 2016 for 80/160/320 MHz PPDUs, respectively). The reduced signaling bits can improve the spectrum efficiency and be utilized to optimize performance through other means such as repetition for higher reliability, and/or can be used to provide more occasions for inserting pilot/synchronization signals.

New subfields, in accordance with various embodiments of the present invention, will now be described. A new subfield, referred to as RU allocation type, is added in the preamble, e.g., of a MU-PPDU, e.g., an EHT MU-PPDU.

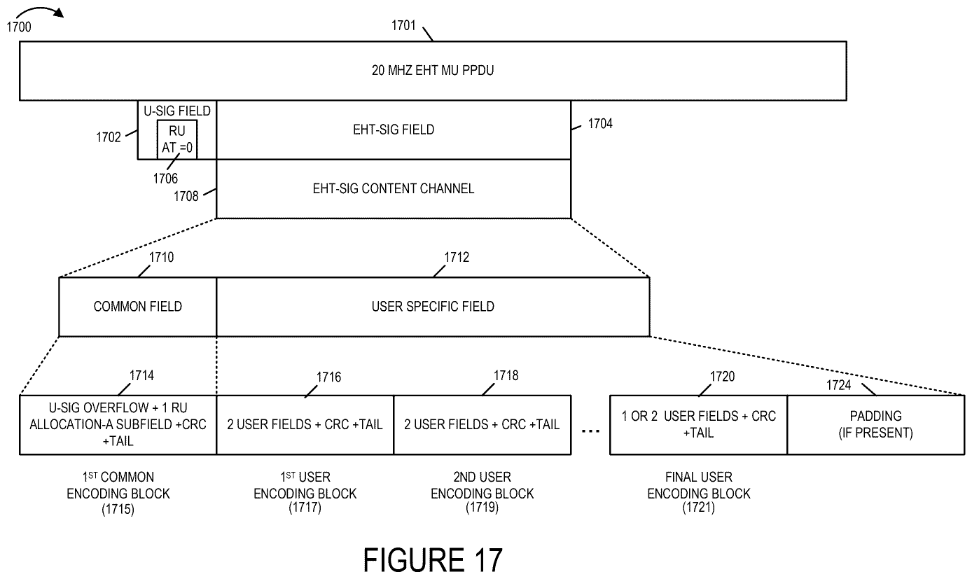

In a first approach, the new RU allocation type subfield is added into the U-SIG field. FIG. 13 is a drawing 1300 illustrating an existing U-SIG field 1301. The U-SIG field includes a version subfield 1302, a bandwidth subfield 1304, an uplink/downlink (UL/DL) subfield 1306, a basic service set (BSS) color subfield 1308, a Transmission Opportunity (TXOP) subfield 1310, a disregard field 1312, and a V field 1314. Row 1316 identifies bit designations for each of the subfields. The U-SIG field 1301 carries information necessary to interpret EHT PPDUs. Existing Table 36-28 of Reference [1] explains the subfields in existing U-SIG 1301. In U-SIG 1301, the bits B20-B24 are functioned as Disregard bits.

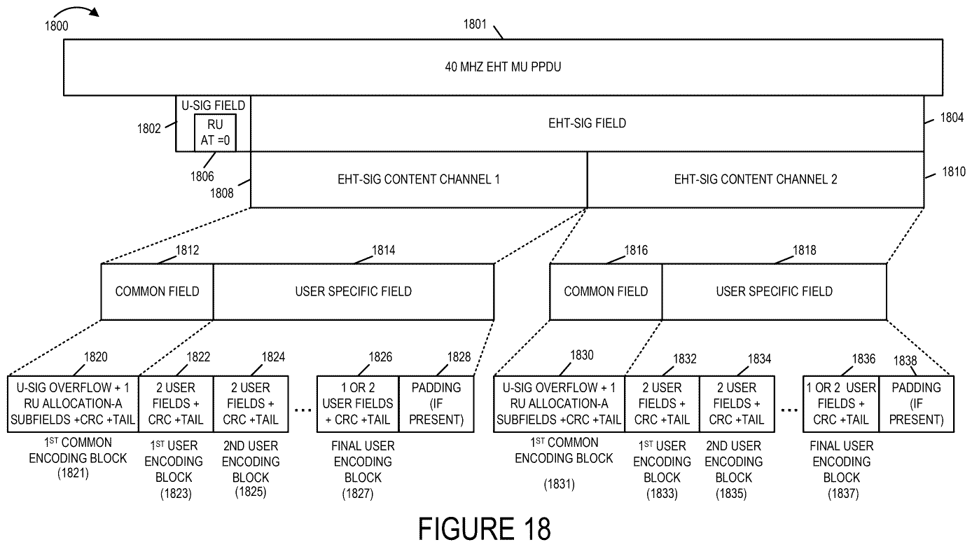

In accordance with a feature of some embodiments of the present invention, one of the disregard bits of Disregard field 1312 is redefined to be the new RU allocation type. For example, B20 in U-SIG 1301, is redefined to be RU allocation type. FIG. 14 is a drawing 1400 illustrating a novel U-SIG field 1401, in accordance with the present invention, which includes bit B20 as the new RU allocation type (RU AT) subfield 1411. The U-SIG field 1401 includes a version subfield 1402, a bandwidth subfield 1404, an uplink/downlink (UL/DL) subfield 1406, a basic service set (BSS) color subfield 1408, a Transmission Opportunity (TXOP) subfield 1410, a RU allocation type (RU AT) subfield 1411, a disregard field 1412, and a V field 1414. Row 1416 identifies bit designations for each of the subfields. The U-SIG field 1401 carries information necessary to interpret EHT PPDUs. Existing Table 36-28 of Reference [1] explains the subfields (1402, 1404, 1406, 1408, 1410) in U-SIG 1401. For the RU Allocation type (RU AT) subfield 1411, a value of 0 indicates joint RU allocation, while a value of 1 indicates individual RU allocation. In U-SIG 1401, the bits B21-B24 are functioned as Disregard bits. The location of this bit is exemplary, and any unused bit in U-SIG can be used for this purpose.

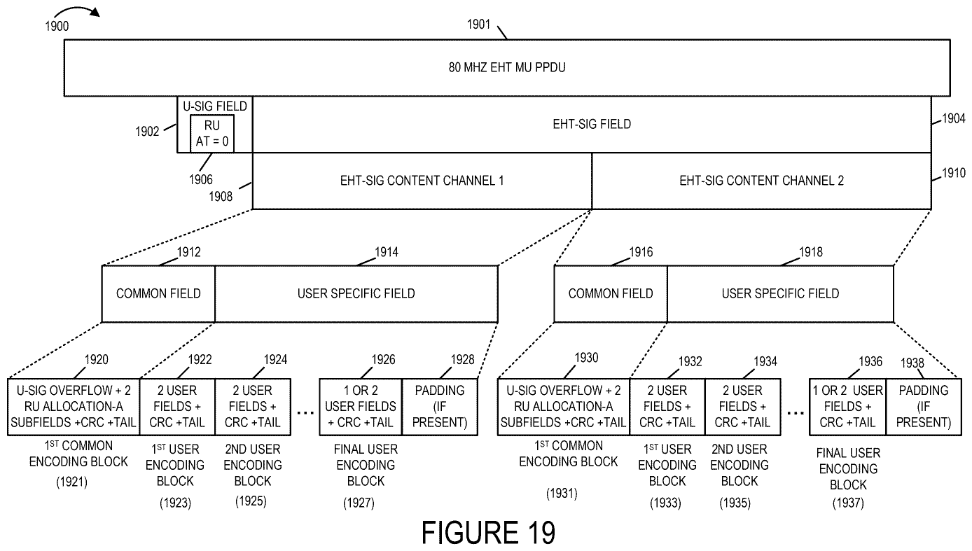

In a second approach, the new RU allocation type subfield is added into a Common Field of a SIG, e.g., a common field of EHT-SIG. FIG. 15 is a drawing 1500 illustrating an existing EHT-SIG field 1501 which includes a common field 1502. The common field 1502 of EHT-SIG 1501 contains the U-SIF overflow and also information regarding the resource unit allocation. Row 1504 identifies bit designations within the common field 1502. Existing Table 36-33 of Reference [1] explains the subfields in common field of EHT-SIG. In the common field, bits B0-B12 are U-SIG overflow bits, which are being used, and bits B13-B16 are functioned as Disregard 1508. In accordance with a feature of some embodiments of the present invention, one of the disregard bits is redefined to be the new RU allocation type. For example, B13 in EHT-SIG, is redefined to be RU allocation type.

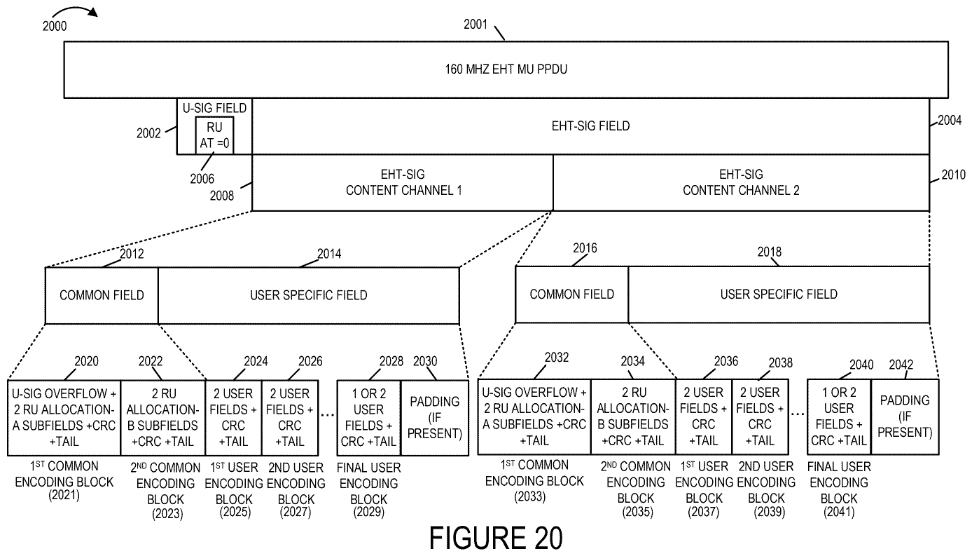

FIG. 16 is a drawing 1600 illustrating a novel EHT-SIG field 1601, in accordance with the present invention, which includes bit B13 as the new RU allocation type (RU AT) subfield 1607. Novel EHT-SIG field 1601 includes a common field 1602. The common field 1602 of EHT-SIG 1601 contains the U-SIF overflow and RU allocation type information. Row 1604 identifies bit designations within the common field 1602. In the common field, bits B0-B12 are U-SIG overflow bits 1606, which are being used, bit B13 is the RU allocation type subfield, and bits B14-B16 are functioned as Disregard 1608. For the RU Allocation type (RU AT) subfield 1607, a value of 0 indicates joint RU allocation, while a value of 1 indicates individual RU allocation. Use of the RU AT bit in the common field of SIG field is exemplary, and it should be appreciated that any unused bit can be allocated/used for this purpose. If the RU allocation type indicates joint RU allocation, then the common field of EHT-SIG 1601 includes RU allocation subfield(s). However, if the RU allocation type indicates individual RU allocation, then the common field does not include any RU allocation subfields.

The individual RU allocation signaling, in some embodiments of the present invention, is implemented as follows. For individual RU allocation, the existing joint RU allocation in the common field of EHT-SIG (B17−B16+9N: RU-allocation-A and B27+9N−B26+9N+9M: RU-allocation-B, where N and M depend on BW) is not necessary anymore and will be removed. Instead, individual. per-STA RU allocations are included in the User-specific field of EHT-SIG (or UHR-SIG or other future amendment′ signal field). Similarly, other features discussed in the present application can be applied to UHR-SIG and any future amendments as well and the concepts are not limited to EHT-SIG or UHR-SIG.

The User Specific field of EHT-SIG content channel consists of a variable number of user fields depending upon the number of multiplexed STAs in the PPDU. The detailed description of the User field subfields are available in Table 36-40 and 36-41 of Reference [1] for non-MU MIMO and MU-MIMO allocation respectively. Based on the proposed individual RU allocation, per-STA allocation will be included in each user field for UHR or other future amendments.

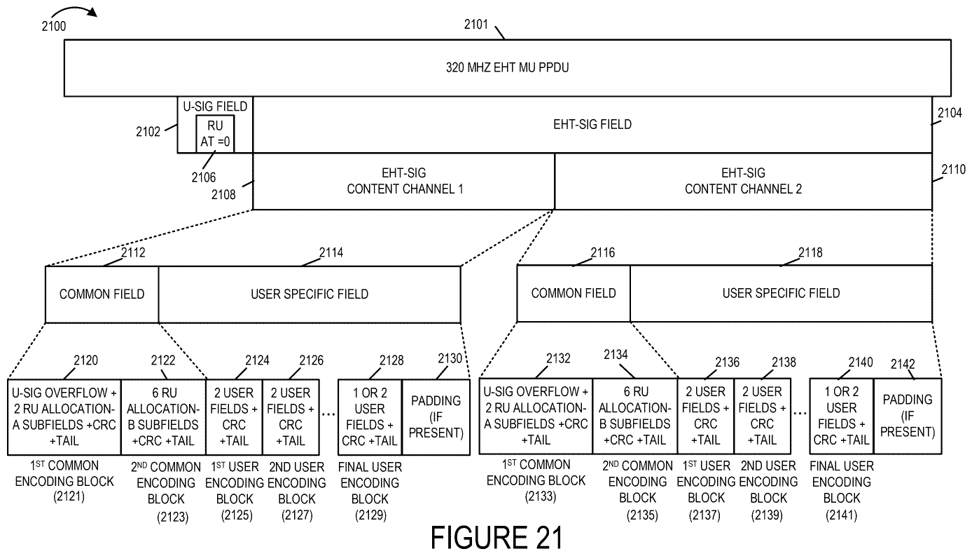

FIG. 17 is a drawing 1700 which includes an exemplary 20 MHz EHT MU PPDU 1701, for the joint RU allocation type, in accordance with an exemplary embodiment. In this example, the RU allocation type subfield, is included in the U-SIG field; however, in other embodiments, the RU allocation type subfield is alternatively included in a common field of the EHT-SIG field. 20 MHz EHT MU PPDU 1701 includes U-SIG field 1702 and EHT-SIG field 1704. U-SIG Field 1702 includes RU allocation type subfield 1706, which includes value=0, indicating joint RU allocation type.

EHT-SIG field 1704 includes EHT-SIG content channel 1708. EHT-SIG content channel 1708 includes a common field 1710 and user specific field 1712. Common field 1714 includes 1st common encoding block 1715, which includes information 1714 including U-SIG overflow+1 RU Allocation-A subfield+CRC+Tail. User specific field 1712 includes one or more encoding blocks (1st user encoding block 1717, 2nd user encoding block 1719, . . . , final user encoding block 1721) and padding 1724, if present. The number of user encoding blocks is dependent upon the number of user fields. If there are only one or two user fields, then final user encoding block 1721 is included. 1st user encoding block 1717 includes information 1716, which includes 2 user fields+CRC+Tail. 2nd user encoding block 1719 includes information 1718, which includes 2 user fields+CRC+Tail. Final user encoding block 1721 includes information 1720, which includes 1 or 2 user fields+CRC+Tail.

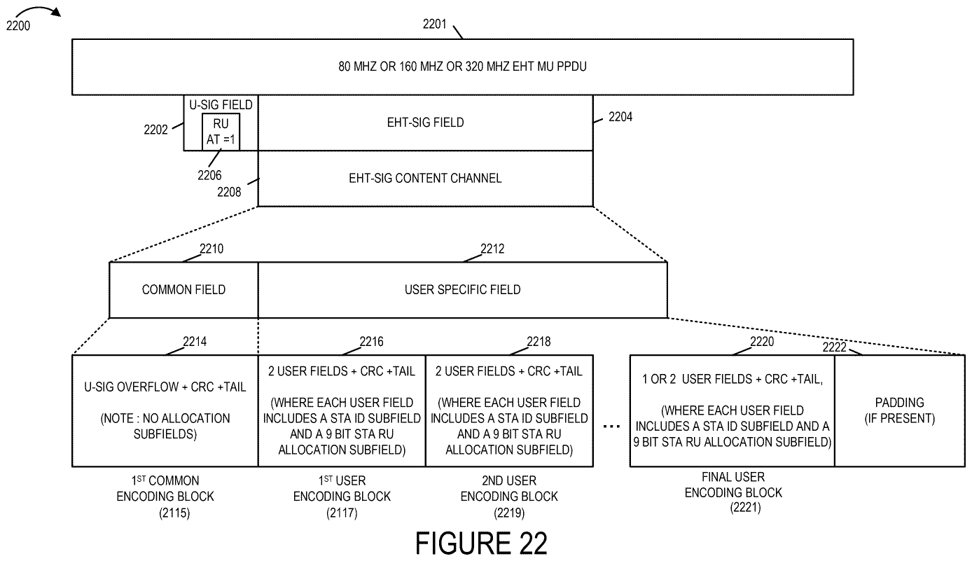

FIG. 18 is a drawing 1800 which includes an exemplary 40 MHz EHT MU PPDU 1801, for the joint RU allocation type, in accordance with an exemplary embodiment. In this example, the RU allocation type subfield, is included in the U-SIG field; however, in other embodiments, the RU allocation type subfield is alternatively included in a common field of the EHT-SIG field. 40 MHz EHT MU PPDU 1801 includes U-SIG field 1802 and EHT-SIG field 1804. U-SIG Field 1802 includes RU allocation type subfield 1806, which includes value=0, indicating joint RU allocation type.

EHT-SIG field 1804 includes EHT-SIG content channel 1 1808 and EHT-SIG content channel 2 1810. EHT-SIG content channel 1 1808 includes a common field 1812 and user specific field 1814. Common field 1812 includes 1st common encoding block 1821, which includes information 1820 including U-SIG overflow+1 RU Allocation-A subfield+CRC+Tail. User specific field 1814 includes one or more encoding blocks (1st user encoding block 1823, 2nd user encoding block 1825, . . . , final user encoding block 1827) and padding 1828, if present. The number of user encoding blocks is dependent upon the number of user fields. If there are only one or two user fields, then final user encoding block 1827 is included. 1st user encoding block 1823 includes information 1822, which includes 2 user fields+CRC+Tail. 2nd user encoding block 1825 includes information 1824, which includes 2 user fields+CRC+Tail. Final user encoding block 1827 includes information 1826, which includes 1 or 2 user fields+CRC+Tail.

EHT-SIG content channel 2 1810 includes a common field 1816 and user specific field 1818. Common field 1816 includes 1st common encoding block 1831, which includes information 1830 including U-SIG overflow+1 RU Allocation-A subfield+CRC+Tail. User specific field 1818 includes one or more encoding blocks (1st user encoding block 1833, 2nd user encoding block 1835, . . . , final user encoding block 1837) and padding 1838, if present. The number of user encoding blocks is dependent upon the number of user fields. If there are only one or two user fields, then final user encoding block 1837 is included. 1st user encoding block 1833 includes information 1832, which includes 2 user fields+CRC+Tail. 2nd user encoding block 1833 includes information 1832, which includes 2 user fields+CRC+Tail. Final user encoding block 1837 includes information 1836, which includes 1 or 2 user fields+CRC+Tail.

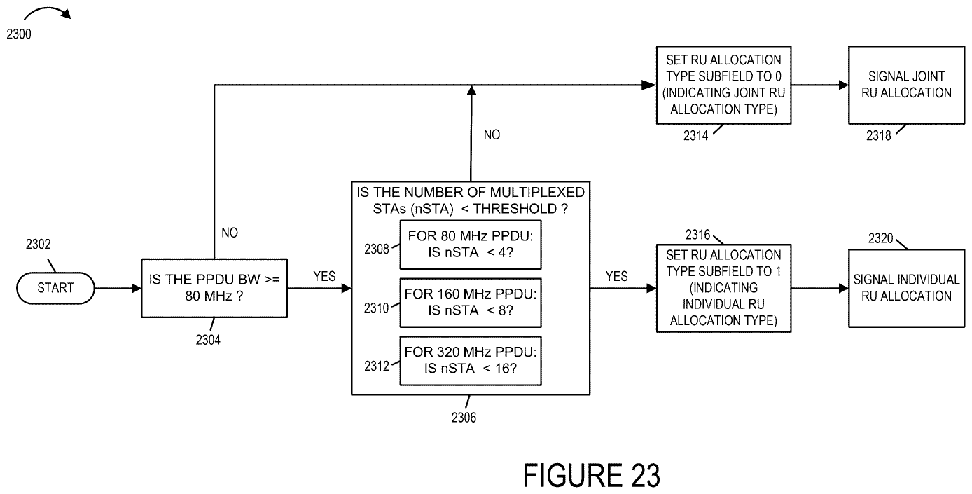

FIG. 19 is a drawing 1900 which includes an exemplary 80 MHz EHT MU PPDU 1901, for the joint RU allocation type, in accordance with an exemplary embodiment. In this example, the RU allocation type subfield, is included in the U-SIG field; however, in other embodiments, the RU allocation type subfield is alternatively included in a common field of the EHT-SIG field. 80 MHz EHT MU PPDU 1901 includes U-SIG field 1902 and EHT-SIG field 1904. U-SIG Field 1902 includes RU allocation type subfield 1906, which includes value=0, indicating joint RU allocation type.

EHT-SIG field 1904 includes EHT-SIG content channel 1 1908 and EHT-SIG content channel 2 1910. EHT-SIG content channel 1 1908 includes a common field 1912 and user specific field 1914. Common field 1912 includes 1st common encoding block 1921, which includes information 1920 including U-SIG overflow+2 RU Allocation-A subfields+CRC+Tail. User specific field 1914 includes one or more encoding blocks (1st user encoding block 1923, 2nd user encoding block 1925, . . . , final user encoding block 1927) and padding 1928, if present. The number of user encoding blocks is dependent upon the number of user fields. If there are only one or two user fields, then final user encoding block 1927 is included. 1st user encoding block 1923 includes information 1922, which includes 2 user fields+CRC+Tail. 2nd user encoding block 1925 includes information 1924, which includes 2 user fields+CRC+Tail. Final user encoding block 1927 includes information 1926, which includes 1 or 2 user fields+CRC+Tail.

EHT-SIG content channel 2 1910 includes a common field 1916 and user specific field 1918. Common field 1916 includes 1st common encoding block 1931, which includes information 1930 including U-SIG overflow+2 RU Allocation-A subfields+CRC+Tail. User specific field 1918 includes one or more encoding blocks (1st user encoding block 1933, 2nd user encoding block 1935, . . . , final user encoding block 1937) and padding 1938, if present. The number of user encoding blocks is dependent upon the number of user fields. If there are only one or two user fields, then final user encoding block 1937 is included. 1st user encoding block 1933 includes information 1932, which includes 2 user fields+CRC+Tail. 2nd user encoding block 1933 includes information 1932, which includes 2 user fields+CRC+Tail. Final user encoding block 1937 includes information 1936, which includes 1 or 2 user fields+CRC+Tail.

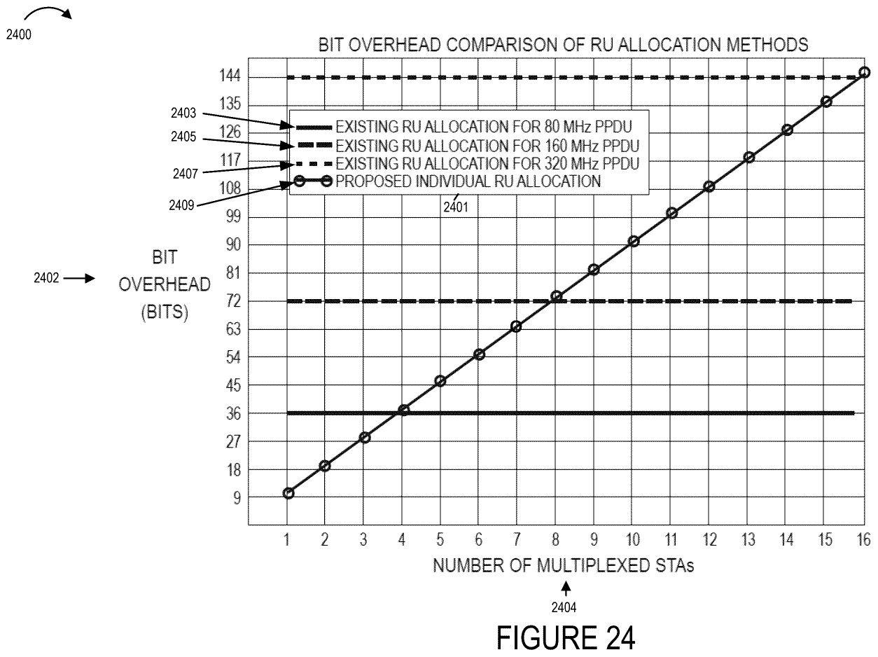

FIG. 20 is a drawing 2000 which includes an exemplary 160 MHz EHT MU PPDU 2001, for the joint RU allocation type, in accordance with an exemplary embodiment. In this example, the RU allocation type subfield, is included in the U-SIG field; however, in other embodiments, the RU allocation type subfield is alternatively included in a common field of the EHT-SIG field. 160 MHz EHT MU PPDU 2001 includes U-SIG field 2002 and EHT-SIG field 2004. U-SIG Field 2002 includes RU allocation type subfield 2006, which includes value=0, indicating joint RU allocation type.

EHT-SIG field 2004 includes EHT-SIG content channel 1 2008 and EHT-SIG content channel 2 2010. EHT-SIG content channel 1 2008 includes a common field 2012 and user specific field 2014. Common field 2012 includes 1st common encoding block 2021, which includes information 2020 including U-SIG overflow+2 RU Allocation-A subfields+CRC+Tail, and 2nd common encoding block 2023, which includes information 2021 including 2 RU Allocation-B subfields+CRC+Tail. User specific field 2014 includes one or more encoding blocks (1st user encoding block 2025, 2nd user encoding block 2027, . . . , final user encoding block 2029) and padding 2030, if present. The number of user encoding blocks is dependent upon the number of user fields. If there are only one or two user fields, then final user encoding block 2029 is included. 1st user encoding block 2025 includes information 2024, which includes 2 user fields+CRC+Tail. 2nd user encoding block 2027 includes information 2026, which includes 2 user fields+CRC+Tail. Final user encoding block 2029 includes information 2028, which includes 1 or 2 user fields+CRC+Tail.

EHT-SIG content channel 2 2010 includes a common field 2016 and user specific field 2018. Common field 2016 includes 1st common encoding block 2033, which includes information 2032 including U-SIG overflow+2 RU Allocation-A subfields+CRC+Tail, and 2nd common encoding block 2035, which includes information 2034 including 2 RU Allocation-B subfields+CRC+Tail. User specific field 2018 includes one or more encoding blocks (1st user encoding block 2037, 2nd user encoding block 2039, . . . , final user encoding block 2041) and padding 2042, if present. The number of user encoding blocks is dependent upon the number of user fields. If there are only one or two user fields, then final user encoding block 2041 is included. 1st user encoding block 2037 includes information 2036, which includes 2 user fields+CRC+Tail. 2nd user encoding block 2039 includes information 2038, which includes 2 user fields+CRC+Tail. Final user encoding block 2041 includes information 2040, which includes 1 or 2 user fields+CRC+Tail.

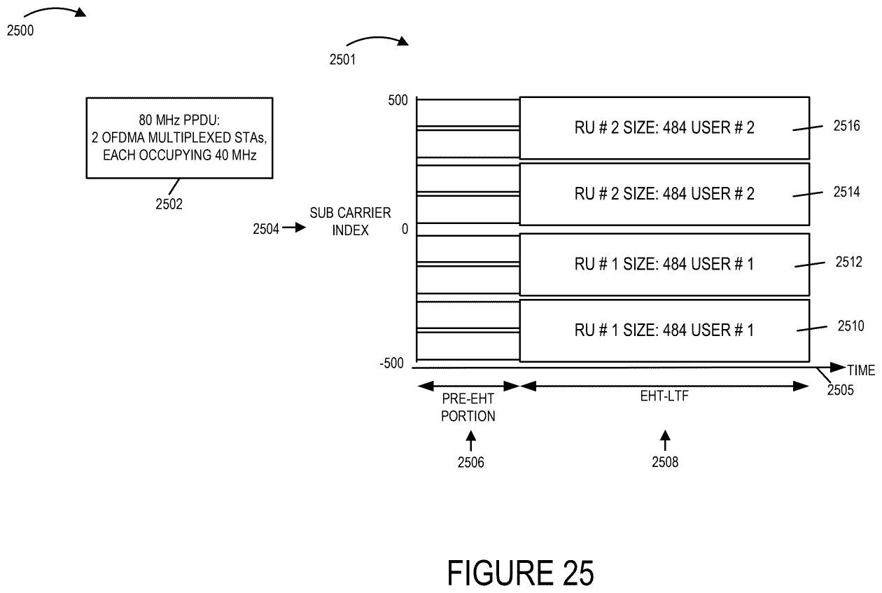

FIG. 21 is a drawing 2100 which includes an exemplary 320 MHz EHT MU PPDU 2101, for the joint RU allocation type, in accordance with an exemplary embodiment. In this example, the RU allocation type subfield, is included in the U-SIG field; however, in other embodiments, the RU allocation type subfield is alternatively included in a common field of the EHT-SIG field. 320 MHz EHT MU PPDU 2101 includes U-SIG field 2102 and EHT-SIG field 2104. U-SIG Field 2102 includes RU allocation type subfield 2106, which includes value=0, indicating joint RU allocation type.

EHT-SIG field 2104 includes EHT-SIG content channel 1 2108 and EHT-SIG content channel 2 2110. EHT-SIG content channel 1 2108 includes a common field 2112 and user specific field 2114. Common field 2112 includes 1st common encoding block 2121, which includes information 2120 including U-SIG overflow+2 RU Allocation-A subfields+CRC+Tail, and 2nd common encoding block 2123, which includes information 2121 including 6 RU Allocation-B subfields+CRC+Tail. User specific field 2114 includes one or more encoding blocks (1st user encoding block 2125, 2nd user encoding block 2127, . . . , final user encoding block 2129) and padding 2130, if present. The number of user encoding blocks is dependent upon the number of user fields. If there are only one or two user fields, then final user encoding block 2129 is included. 1st user encoding block 2125 includes information 2124, which includes 2 user fields+CRC+Tail. 2nd user encoding block 2127 includes information 2126, which includes 2 user fields+CRC+Tail. Final user encoding block 2129 includes information 2128, which includes 1 or 2 user fields+CRC+Tail.

EHT-SIG content channel 2 2110 includes a common field 2116 and user specific field 2118. Common field 2116 includes 1st common encoding block 2133, which includes information 2132 including U-SIG overflow+2 RU Allocation-A subfields+CRC+Tail, and 2nd common encoding block 2135, which includes information 2134 including 6 RU Allocation-B subfields+CRC+Tail. User specific field 2018 includes one or more encoding blocks (1st user encoding block 2137, 2nd user encoding block 2139, . . . , final user encoding block 2141) and padding 2142, if present. The number of user encoding blocks is dependent upon the number of user fields. If there are only one or two user fields, then final user encoding block 2139 is included. 1st user encoding block 2137 includes information 2136, which includes 2 user fields+CRC+Tail. 2nd user encoding block 2139 includes information 2138, which includes 2 user fields+CRC+Tail. Final user encoding block 2241 includes information 2140, which includes 1 or 2 user fields+CRC+Tail.

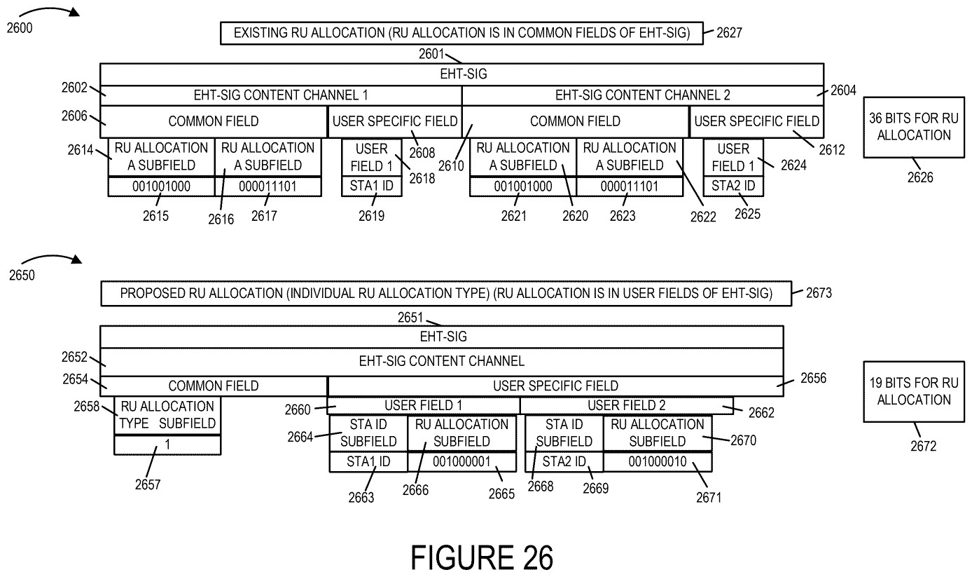

FIG. 22 is a drawing 2200 which includes an exemplary 80 MHz or 160 MHz or 320 MHz EHT MU PPDU 2201, for the individual RU allocation type, in accordance with an exemplary embodiment. In this example, the RU allocation type subfield, is included in the U-SIG field; however, in other embodiments, the RU allocation type subfield is alternatively included in a common field of the EHT-SIG field.

80 MHz or 160 MHz or 320 MHz EHT MU PPDU 2201 includes U-SIG field 2202 and EHT-SIG field 2204. U-SIG Field 2202 includes RU allocation type subfield 2206, which includes value=1, indicating individual RU allocation type.

EHT-SIG field 2204 includes EHT-SIG content channel 2208. EHT-SIG content channel 2208 includes a common field 2210 and user specific field 2212. Common field 2214 includes 1st common encoding block 2215, which includes information 2214 including U-SIG overflow+CRC+Tail. Note: No allocation subfields are included in the common field 2210. User specific field 2212 includes one or more encoding blocks (1st user encoding block 2217, 2nd user encoding block 2219, . . . , final user encoding block 2219) and padding 2222, if present. The number of user encoding blocks is dependent upon the number of user fields. If there are only one or two user fields, then final user encoding block 2221 is included. 1st user encoding block 2217 includes information 2216, which includes 2 user fields+CRC+Tail, where each user field includes a STA ID subfield and a 9 bit STA RU allocation subfield. 2nd user encoding block 2219 includes information 2218, which includes 2 user fields+CRC+Tail, where each user field includes a STA ID subfield and a 9 bit STA RU allocation subfield. Final user encoding block 2221 includes information 2220, which includes 1 or 2 user fields+CRC+Tail, where each user field includes a STA ID subfield and a 9 bit STA RU allocation subfield.

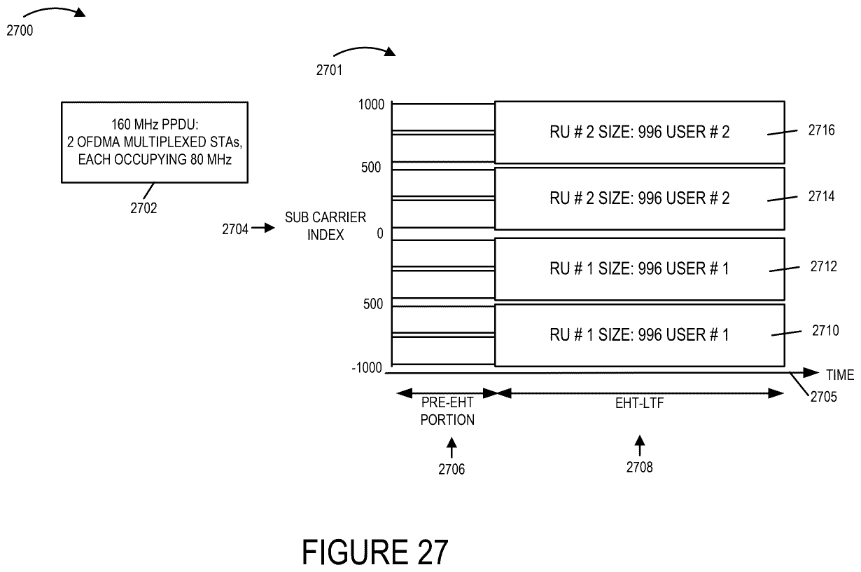

FIG. 23 is a drawing of a flowchart 2300 used to illustrate access point (AP) operation with regard to determination of a RU allocation type subfield value and RU allocation signaling to STAs, e.g., for a MU-PPDU, in accordance with the present invention. Operation starts in step 2302 in which the AP is powered on and initialized. Operation proceeds from start step 2302 to step 2304, in which the AP determines if the PPDU BW is greater than or equal to 80 MHz. If the determination of step 2304 is that the PPDU BW is not greater than or equal to 80 MHz, then operation proceeds to step 2314, in which the AP sets the RU allocation type subfield to 0, indicating that joint type allocation is being used for communicating the RU allocations of the MU-PPDU. However, if the determination of step 2304 is that the PPDU BW is greater than or equal to 80 MHz, then operation proceeds from step 2304 to step 2306.

In step 2306, the AP determines the allocation type as a function of both the number of multiplexed STAs (nSTA) and the PPDU BW. In step 2306, the AP determines if the number of multiplexed STA (nSTA) is less than a threshold, where different thresholds are used for different bandwidths.

If the BW=80 MHz, then AP performs sub-step 2308, in which the AP compares the number of multiplexed STA (nSTA) to the first threshold value of 4, and determines if nSTA is less than 4. If the PPDU BW is 80 MHz, and the number of multiplexed STAs is less than 4, then operation proceeds from sub-step 2308 of step 2306 to step 2316, in which the AP sets the RU allocation type subfield to 1, indicating that individual type allocation is being used for communicating the RU allocation of the MU-PPDU; however, if the PPDU BW is 80 MHz, and the number of multiplexed STAs is not less than 4, then operation proceeds from sub-step 2308 of step 2306 to step 2314, in which the AP sets the RU allocation type subfield to 0, indicating that joint type allocation is being used for communicating the RU allocation of the MU-PPDU.

If the BW=160 MHz, then AP performs sub-step 2310, in which the AP compares the number of multiplexed STA (nSTA) to the second threshold value of 8 and determines if nSTA is less than 8. If the PPDU BW is 160 MHz, and the number of multiplexed STAs is less than 8, then operation proceeds from sub-step 2310 of step 2306 to step 2316, in which the AP sets the RU allocation type subfield to 1, indicating that individual type allocation is being used for communicating the RU allocation of the MU-PPDU; however, if the PPDU BW is 160 MHz, and the number of multiplexed STAs is not less than 8, then operation proceeds from sub-step 2310 of step 2306 to step 2314, in which the AP sets the RU allocation type subfield to 0, indicating that joint type allocation is being used for communicating the RU allocation of the MU-PPDU.

If the BW=320 MHz, then AP performs sub-step 2312, in which the AP compares the number of multiplexed STA (nSTA) to the third threshold value of 16 and determines if nSTA is less than 16. If the PPDU BW is 160 MHz, and the number of multiplexed STAs is less than 16, then operation proceeds from sub-step 2312 of step 2306 to step 2316, in which the AP sets the RU allocation type subfield to 1, indicating that individual type allocation is being used for communicating the RU allocation of the MU-PPDU; however, if the PPDU BW is 160 MHz, and the number of multiplexed STAs is not less than 16, then operation proceeds from sub-step 2312 of step 2306 to step 2314, in which the AP sets the RU allocation type subfield to 0, indicating that joint type allocation is being used for communicating the RU allocation of the MU-PPDU.

Operation proceeds from step 2314 to step 2318, in which the AP signals RU joint allocation, as previously described. Operation proceeds from step 2316 to step 2320, in which the AP signal individual RU allocation as previously described.

The information used in flowchart 2300 can be, and sometimes is, obtained as follows. The AP determines the BW for the DL MU-PPDU and notifies the STAs in the U-SIG field bits B3-B5. The number of STAs to be served, e.g., the number of multiplexed STA which are to be allocated RUs of the DL MU-PPDU, is determined by the AP. The AP will set the RU allocation type subfield and the other corresponding RU allocation fields.

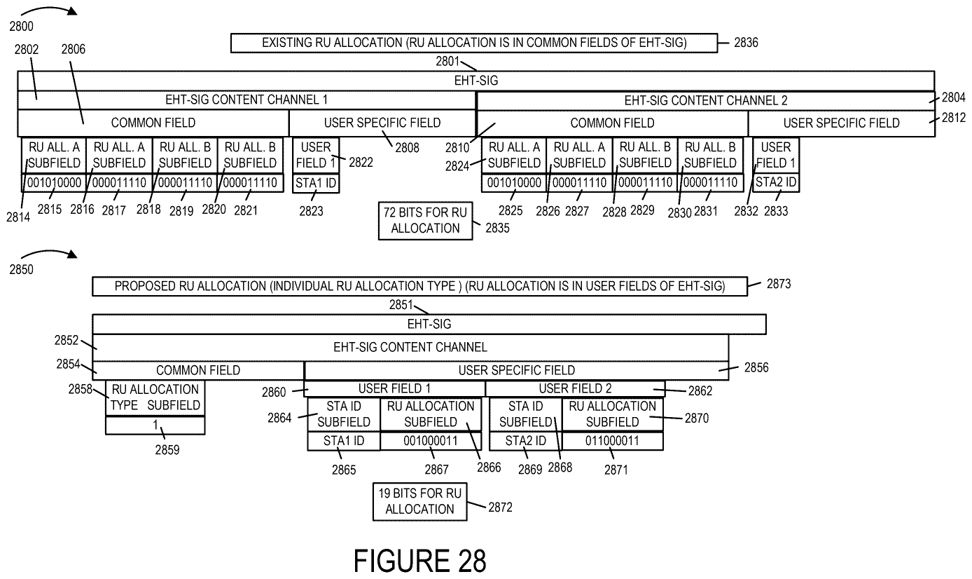

FIG. 24 is a drawing of a plot 2400, which illustrates Bit overhead comparisons of alternative RU allocation type communication methods for different size BW PPDUs. Vertical axis 2402 represents Bit overhead (Bits). Horizontal axis 2404 represents number of multiplexed STAs. Legend 2401 indicates that dashed line 2403 represents existing RU allocation for 80 MHz PPDUs; large size dashed line 2405 represents existing RU allocation for 160 MHz PPDUs; small size dashed line 2407 represents existing RU allocation for 320 MHz PPDUs; and solid line with circles represents a proposed individual RU allocation, in accordance with the present invention.

For the 80 MHz PPDU, when the number of STAs is 1, 2, or 3, the individual RU allocation approach uses less overhead bits to communicate the RU allocations; however, when the number of STAs is 4 or larger, then the existing approach uses less bits to communicate the RU allocations.

For the 160 MHz PPDU, when the number of STAs is 1, 2, 3, 4, 5, 6 or 7 the individual RU allocation approach uses less overhead bits to communicate the RU allocations; however, when the number of STAs is 8 or larger, then the existing approach uses less bits to communicate the RU allocations.

For the 320 MHz PPDU, when the number of STAs is 1, 2, 3, 4, 5, 6, 7, 8, 9, 10, 11, 12, 13, 14 or 15 the individual RU allocation approach uses less overhead bits to communicate the RU allocations; however, when the number of STAs is 16, then the existing approach uses less bits to communicate the RU allocations.

As an example, consider a scenario, where an AP wants to serve 4 STAs in an OFDMA scheme using a 320 MHz MU PPDU. Based on the current specification (using a joint type allocation approach to signal the RU allocations to the STAs but without the RU allocation type field), it requires 144 bits for the RU signaling. However, based on the hybrid solution, in accordance with the present invention, the RU signaling would be via individual (per STA) type allocation signaling and would only require 37 bits (1 bit to indicate the RU allocation type (individual type allocation)+36 bits to communicate the allocated RUs (9 bits for each of the 4 STAs). The results indicated a 75% reduction in the bit overhead signaling for this particular example.

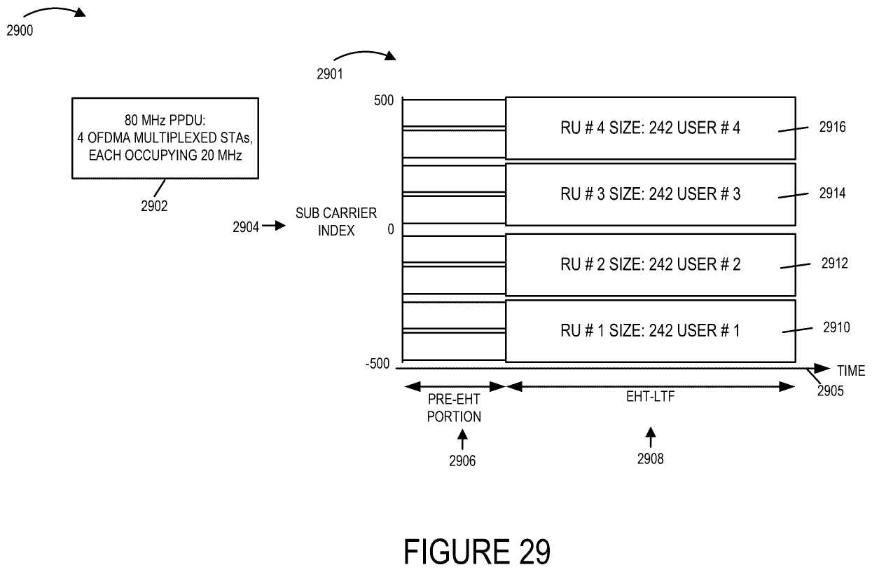

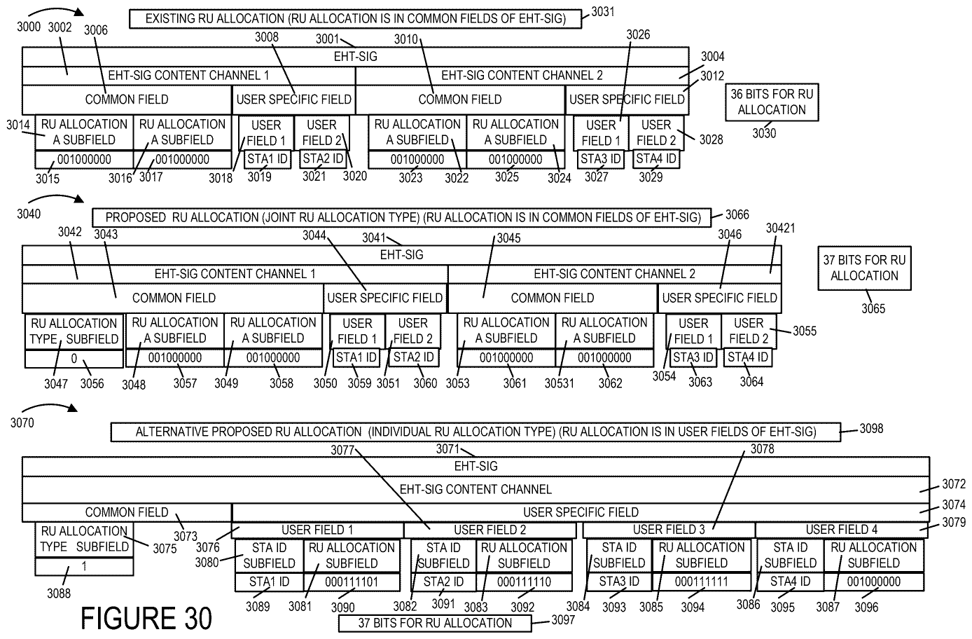

A first detailed example, for a scenario in which individual allocation is more efficient, will now be described, with respect to FIG. 25 and FIG. 26. Consider the scenario of: a 80 MHz PPDU to be allocated to 2 OFDMA multiplexed STAs, with each STA occupying 40 MHz, as indicated by information box 2502 of FIG. 25. Drawing 2501 of FIG. 25 illustrates a plot of subcarrier index on the vertical axis 2504 vs time on the horizontal axis 2505. The time includes a pre-EHT portion 2506 and an EHT-LTF portion 2508. In this example: R#1 2510, with a size of 484 subcarriers (tones) is allocated to user #1, R#1 2512, with a size of 484 subcarriers (tones) is allocated to user #1; R#2 2510, with a size of 484 subcarriers (tones) is allocated to user #2, R#2 2516, with a size of 484 subcarriers (tones) is allocated to user #2.

With the existing RU allocation method, the RU allocation in the common field of EHT-SIG is set to: 001001000, 000011101, 001001000, 0000111101. This approach uses 36 bits to communicate the RU allocation.

Drawing 2600 of FIG. 26 illustrates the existing RU allocation approach, where the RU allocation subfields are in the common fields of the EHT-SIG, as indicated by title box 2627. EHT-SIG 2601 includes two EHT-SIG content channels (EHT-SIG content channel 1 2602 and EHT-SIG content channel 2 2604).

EHT-SIG content channel 1 2602 includes common field 2606 and user specific field 2608. Common field 2606 includes two RU Allocation-A subfields (RU Allocation A subfield 2614, RU allocation A subfield 2616). RU allocation A subfield 2614 carries the 9-bit pattern=001001000, as indicated by information 2615. RU allocation A subfield 2616 carries the 9-bit pattern=000011101, as indicated by information 2617. User specific field 2612 includes user field 1 2618, which includes STA1 ID 2619 in a STA ID subfield.

EHT-SIG content channel 2 2604 includes common field 2610 and user specific field 2612. Common field 2610 includes two RU Allocation-A subfields (RU Allocation A subfield 2620, RU allocation A subfield 2622). RU allocation A subfield 2620 carries the 9-bit pattern=001001000, as indicated by information 2621. RU allocation A subfield 2622 carries the 9-bit pattern=000011101, as indicated by information 2623. User specific field 2612 includes user field 1 2624, which includes STA2 ID 2625 in a STA ID subfield.

The 4 9-Bit RU allocation A subfields (2614, 2616, 2620, 2622) carry a total of 36 bits for RU allocation, as indicated by information block 2626.

With the approach, in accordance with the present invention, a single bit, set to value=1 (communicated in an RU allocation type field) is used to signal individual RU allocation, and 2 per-STA RU allocation are signaled: 001000001 for STA 1, 001000010 for STA 2. This approach uses 19 bits to communicate the allocation.

Drawing 2650 of FIG. 26 illustrates the proposed RU allocation approach, using the individual RU allocation type, where the RU allocation subfields are in user fields of the EHT-SIG, as indicated by title box 2673. EHT-SIG 2651 includes EHT-SIG content channel 2652.

EHT-SIG content channel 2652 includes common field 2654 and user specific field 2656. Common field 2654 includes an RU allocation type subfield 2658, e.g., a single bit field, with a value set to 1, as indicated by box 2657, which indicates individual RU allocation type. Alternatively, the RU type allocation field, indicating individual RU allocation type, may be included and communicated in the U-SIG.

User specific field 2656 includes two user fields (user field 1 2660 and user field 2 2662). User field 1 2660 includes: i) STA ID subfield 2664, which conveys STA 1 ID 2663, and ii) RU allocation subfield 2666, which conveys 9 bit pattern=001000001, as indicated by information 2665. User field 2 2662 includes: i) STA ID subfield 2668, which conveys STA2 ID 2669, and ii) RU allocation subfield 2670, which conveys 9 bit pattern=001000010, as indicated by information 2671.

One bit is used for conveying the RU allocation type, e.g., in the RU allocation type subfield 2658 of the common field 2654 or alternatively in an RU allocation type subfield in U-SIG. In addition, the 9-Bit per-STA RU allocation subfields 2666, 2670, included as part of the user specific field 2656, use 18 bits for RU allocation. Thus, this approach of individual RU allocation, for this example, uses a total of 19 bits for RU allocation, as indicated by information block 2672.

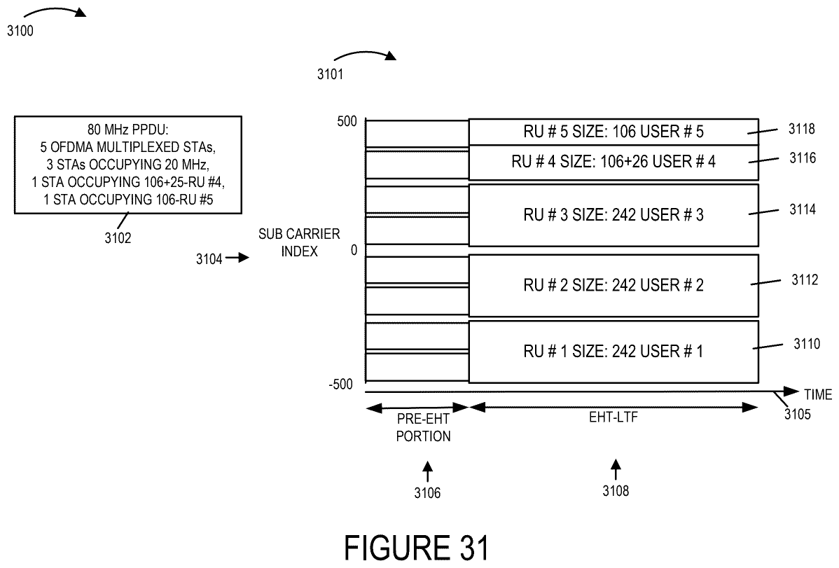

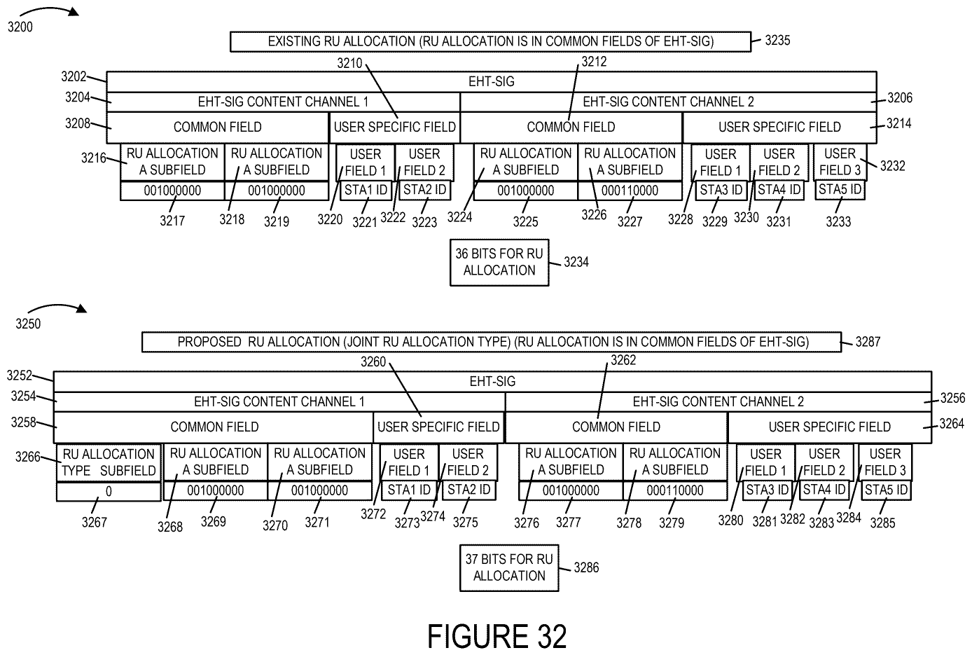

A second detailed example, for a scenario in which individual allocation is more efficient, will now be described, with respect to FIG. 27 and FIG. 28. Consider the scenario of: a 160 MHz PPDU to be allocated to 2 OFDMA multiplexed STAs, with each STA occupying 80 MHz, as indicated by information box 2702 of drawing 2700 of FIG. 27. Drawing 2701 of FIG. 27 illustrates a plot of subcarrier index on the vertical axis 2704 vs time on the horizontal axis 2705. The time includes a pre-EHT portion 2706 and an EHT-LTF portion 2708. In this example: R#1 2710, with a size of 996 subcarriers (tones) is allocated to user #1, R#1 2712, with a size of 996 subcarriers (tones) is allocated to user #1; R#2 2714, with a size of 996 subcarriers (tones) is allocated to user #2, R#2 2716, with a size of 996 subcarriers (tones) is allocated to user #2.

With the existing RU allocation method, the RU allocation in the common field of EHT-SIG is set to: 001001000, 000011110, 000011110, 000011110, 001010000, 000011110, 000011110, 000011110, 00001110. This approach uses 72 bits to communicate the RU allocation.

Drawing 2800 of FIG. 28 illustrates the existing RU allocation approach, where the RU allocation subfields are in the common fields of the EHT-SIG, as indicated by title box 2836. EHT-SIG 2801 includes two EHT-SIG content channels (EHT-SIG content channel 1 2802 and EHT-SIG content channel 2 2804).

EHT-SIG content channel 1 2802 includes common field 2806 and user specific field 2808. Common field 2806 includes two RU Allocation-A subfields (RU Allocation A subfield 2814, RU Allocation A subfield 2716) and two RU Allocation-B subfields (RU Allocation B subfield 2818, RU Allocation-B subfield 2820). RU allocation A subfield 2614 carries the 9-bit pattern=001010000, as indicated by information 2815. RU allocation A subfield 2816 carries the 9-bit pattern=000011110, as indicated by information 2817. RU allocation B subfield 2818 carries the 9-bit pattern=000011110, as indicated by information 2819. RU allocation B subfield 2820 carries the 9-bit pattern=000011110, as indicated by information 2821. User specific field 2808 includes user field 1 2822, which includes STA1 ID 2823 in a STA ID subfield.

EHT-SIG content channel 2 2804 includes common field 2810 and user specific field 2812. Common field 2810 includes two RU Allocation-A subfields (RU Allocation A subfield 2824, RU Allocation A subfield 2826) and two RU Allocation-B subfields (RU Allocation B subfield 2828, RU Allocation-B subfield 2830). RU allocation A subfield 2624 carries the 9-bit pattern=001010000, as indicated by information 2825. RU allocation A subfield 2826 carries the 9-bit pattern=000011110, as indicated by information 2827. RU allocation B subfield 2828 carries the 9-bit pattern=000011110, as indicated by information 2829. RU allocation B subfield 2830 carries the 9-bit pattern=000011110, as indicated by information 2831. User specific field 2812 includes user field 1 2832, which includes STA2 ID 2833 in a STA ID subfield.

The eight 9-Bit RU allocation subfields (RU allocation-A subfield 2814, RU allocation-A subfield 2816, RU allocation-B subfield 2818, RU allocation-B subfield 2820, RU allocation-A subfield 2824, RU allocation-A subfield 2826, RU allocation-B subfield 2628, RU allocation-B subfield 2630) carry a total of 72 bits for RU allocation, as indicated by information block 2835.

With the approach, in accordance with the present invention, a single bit, set to value=1 (communicated in an RU allocation type field) is used to signal individual RU allocation, and 2 per-STA RU allocation are signaled: 001000011 for STA 1, 011000011 for STA 2. This approach uses 19 bits to communicate the allocation.

Drawing 2850 of FIG. 28 illustrates the proposed RU allocation approach, using the individual RU allocation type, where the RU allocation subfields are in user fields of the EHT-SIG, as indicated by title box 2873. EHT-SIG 2851 includes EHT-SIG content channel 2852.

EHT-SIG content channel 2852 includes common field 2854 and user specific field 2856. Common field 2854 includes an RU allocation type subfield 2858, e.g., a single bit field, with a value set to 1, as indicated by box 2859, which indicates individual RU allocation type. Alternatively, the RU type allocation field, indicating individual RU allocation type, may be included and communicated in the U-SIG.

User specific field 2856 includes two user fields (user field 1 2860 and user field 2 2862). User field 1 2860 includes: i) STA ID subfield 2864, which conveys STA 1 ID 2865, and ii) RU allocation subfield 2866, which conveys 9 bit pattern=001000011, as indicated by information 2867. User field 2 2862 includes: i) STA ID subfield 2868, which conveys STA2 ID 2869, and ii) RU allocation subfield 2870, which conveys 9 bit pattern=011000011, as indicated by information 2871.

One bit is used for conveying the RU allocation type, e.g., in the RU allocation type subfield 2858 of the common field 2854 or alternatively in an RU allocation type subfield in U-SIG. In addition, the 9-Bit per-STA RU allocation subfields 2866, 2870, included as part of the user specific field 2856, use 18 bits for RU allocation. Thus, this approach of individual RU allocation, for this example, uses a total of 19 bits for RU allocation, as indicated by information block 2872.

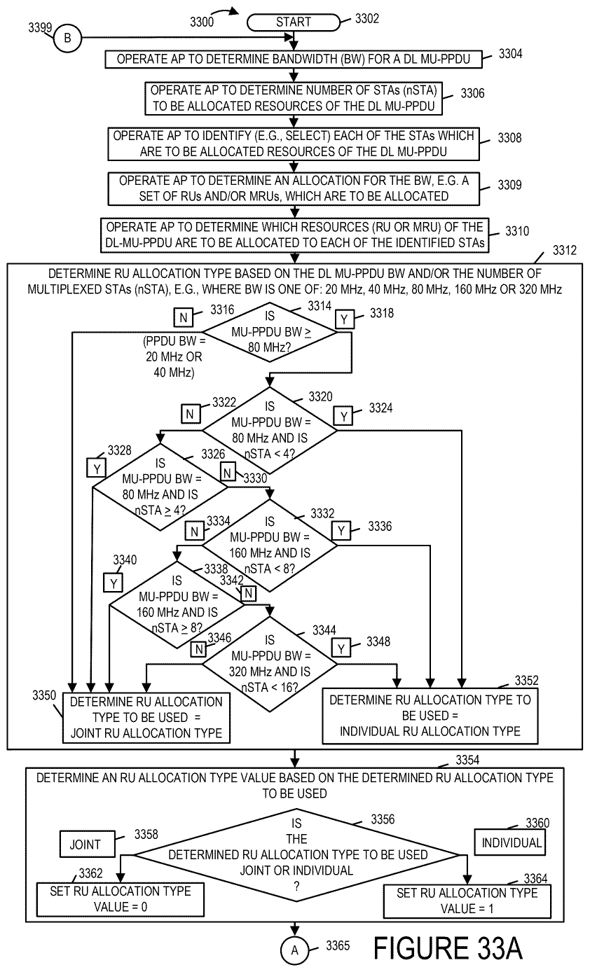

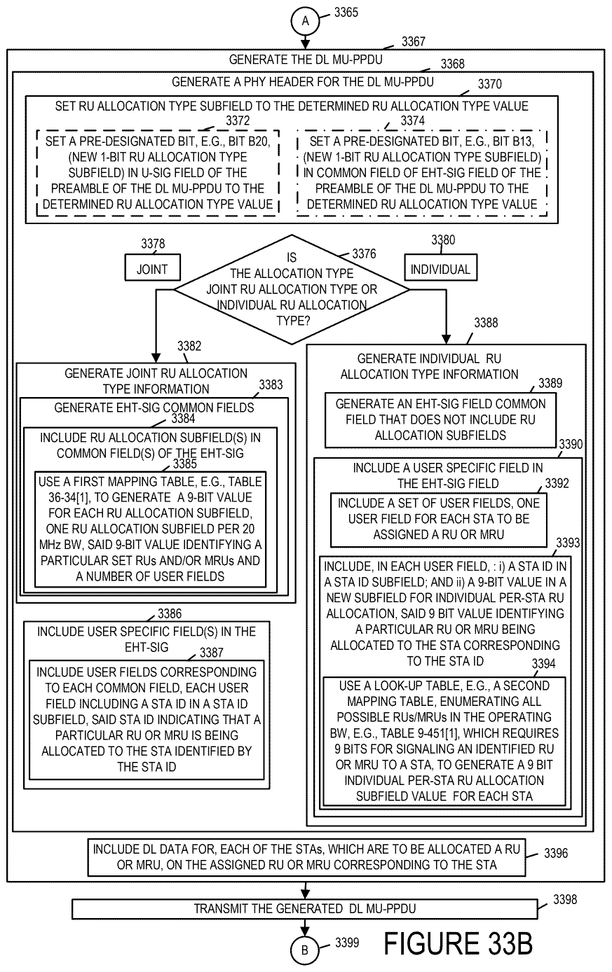

FIG. 29 and FIG. 30 illustrate an example in which both individual or joint allocation, with regard to RU allocation, can be equivalently applied. In the hybrid solution, in accordance with the present invention, AP can choose either, while in the existing solution only Joint allocation is possible. Consider the scenario of: a 80 MHz PPDU to be allocated to 4 OFDMA multiplexed STAs, with each STA occupying 20 MHz, as indicated by information box 2902 of drawing 2900 of FIG. 29. Drawing 2901 of FIG. 29 illustrates a plot of subcarrier index on the vertical axis 2904 vs time on the horizontal axis 2905. The time includes a pre-EHT portion 2906 and an EHT-LTF portion 2908. In this example: R#1 2910, with a size of 242 subcarriers (tones) is allocated to user #1, R#2 2912, with a size of 242 subcarriers (tones) is allocated to user #2; R#3 2914, with a size of 242 subcarriers (tones) is allocated to user #3, and R#4 2916 with a size of 242 subcarriers (tones) is allocated to user #4.

With the existing RU allocation method, the RU allocation in the common field of EHT-SIG is set to: 001000000, 001000000, 001000000, 001000000. This approach uses 36 bits to communicate the RU allocation.

Drawing 3000 of FIG. 30 illustrates the existing RU allocation approach, where the RU allocation subfields are in the common fields of the EHT-SIG, as indicated by title box 3031. EHT-SIG 3001 includes two EHT-SIG content channels (EHT-SIG content channel 1 3002 and EHT-SIG content channel 2 3004).

EHT-SIG content channel 1 3002 includes common field 3006 and user specific field 3008. Common field 3006 includes two RU Allocation-A subfields (RU Allocation A subfield 3014, RU allocation A subfield 3016). RU allocation A subfield 3014 carries the 9-bit pattern=001000000, as indicated by information 3015. RU allocation A subfield 3016 carries the 9-bit pattern=001000000, as indicated by information 3017. User specific field 3008 includes user field 1 3018 and user field 2 3020. User field 1 3018 includes STA1 ID 3019 in a STA ID subfield. User field 2 3020 includes STA2 ID 3021 in a STA ID subfield.

EHT-SIG content channel 2 3004 includes common field 3010 and user specific field 3012. Common field 3010 includes two RU Allocation-A subfields (RU Allocation A subfield 3022, RU allocation A subfield 3024). RU allocation A subfield 3022 carries the 9-bit pattern=001000000, as indicated by information 3023. RU allocation A subfield 3024 carries the 9-bit pattern=001000000, as indicated by information 3025. User specific field 30112 includes user field 1 3026 and user field 2 3028. User field 1 3026 includes STA3 ID 3027 in a STA ID subfield. User field 2 3028 includes STA4 ID 3029 in a STA ID subfield.

The 4 9-Bit RU allocation A subfields (3014, 3016, 3022, 3024) carry a total of 36 bits for RU allocation, as indicated by information block 3030.

With an approach, in accordance with some embodiments of the present invention, a single bit, set to value=0 (communicated in an RU allocation type field) is used to signal joint RU allocation, and the joint RU allocation is signaled: 001000000, 001000000, 001000000, 001000000. This approach uses 37 bits total to communicate the allocation. The flowchart of FIG. 23 will choose this approach since the PPDU BW=80 MHz and nSTA=4.

Drawing 3040 of FIG. 30 illustrates the proposed RU allocation approach, using the joint RU allocation type, where the RU allocation subfields are in the common fields of the EHT-SIG, as indicated by title box 3066. EHT-SIG 3041 includes two EHT-SIG content channels (EHT-SIG content channel 1 3042 and EHT-SIG content channel 2 30421).

EHT-SIG content channel 1 3042 includes common field 3043 and user specific field 3044. Common field 3042 includes a RU allocation type subfield 3047 and two RU Allocation-A subfields (RU Allocation A subfield 3048, RU allocation A subfield 3049).

RU allocation type subfield 3047, e.g., a single bit field, with a value set to 0, as indicated by box 3056, which indicates joint RU allocation type. Alternatively, the RU type allocation field, indicating joint RU allocation type, may be included and communicated in the U-SIG.

RU allocation A subfield 3047 carries the 9-bit pattern=001000000, as indicated by information 3057. RU allocation A subfield 3049 carries the 9-bit pattern=001000000, as indicated by information 3058. User specific field 3044 includes user field 1 3050 and user field 2 3051. User field 1 3050 includes STA1 ID 3059 in a STA ID subfield. User field 2 3051 includes STA2 ID 3060 in a STA ID subfield.

EHT-SIG content channel 2 30421 includes common field 3045 and user specific field 3046. Common field 3045 includes two RU Allocation-A subfields (RU Allocation A subfield 3053, RU allocation A subfield 30531). RU allocation A subfield 3053 carries the 9-bit pattern=001000000, as indicated by information 3061. RU allocation A subfield 30531 carries the 9-bit pattern=001000000, as indicated by information 3062. User specific field 3054 includes user field 1 3054 and user field 2 3055. User field 1 3055 includes STA3 ID 3063 in a STA ID subfield. User field 2 3055 includes STA4 ID 3064 in a STA ID subfield.

One bit is used for conveying the RU allocation type, e.g., in the RU allocation type subfield 3047 of the common field 3043 or alternatively in an RU allocation type subfield in U-SIG. In addition, the four 9-Bit RU allocation A subfields (3048, 3049, 3053, 30531) use a total of 36 bits for RU allocation. Thus, this approach, in accordance with some embodiments of the present invention, uses a total of 37 bits for RU allocation, as indicated by information block 3065.

With an approach, in accordance with some embodiments of the present invention, a single bit, set to value=1 (communicated in an RU allocation type field) is used to signal individual RU allocation, and 4 per-STA RU allocation are signaled: 000111101 for STA 1, 000111110 for STA 2, 000111111 for STA 3, 001000000 for STA 4. This approach uses 37 bits total to communicate the allocation.

Drawing 3070 of FIG. 30 illustrates the proposed RU allocation approach, using the individual RU allocation type, where the RU allocation subfields are in user fields of the EHT-SIG, as indicated by title box 3098. EHT-SIG 3071 includes EHT-SIG content channel 3072.

EHT-SIG content channel 3072 includes common field 3073 and user specific field 3074. Common field 3073 includes an RU allocation type subfield 3075, e.g., a single bit field, with a value set to 1, as indicated by box 3088, which indicates individual RU allocation type. Alternatively, the RU type allocation field, indicating individual RU allocation type, may be included and communicated in the U-SIG.

User specific field 3074 includes four user fields (user field 1 3076, user field 2 3077, user field 3 3078, and user field 4 3079). User field 1 3076 includes: i) STA ID subfield 3080, which conveys STA1 ID 3089, and ii) RU allocation subfield 3081, which conveys 9-bit pattern=000111101, as indicated by information 3090. User field 2 3077 includes: i) STA ID subfield 3082, which conveys STA2 ID 3091, and ii) RU allocation subfield 3083, which conveys 9-bit pattern=000111110, as indicated by information 3092. User field 3 3078 includes: i) STA ID subfield 3084, which conveys STA3 ID 3093, and ii) RU allocation subfield 3085, which conveys 9-bit pattern=000111111, as indicated by information 3094. User field 4 3079 includes: i) STA ID subfield 3086, which conveys STA4 ID 3095, and ii) RU allocation subfield 3087, which conveys 9-bit pattern=001000000, as indicated by information 3096.

One bit is used for conveying the RU allocation type, e.g., in the RU allocation type subfield 3075 of the common field 3073 or alternatively in an RU allocation type subfield in U-SIG. In addition, the 9-Bit per-STA RU allocation subfields 3082, 3083, 3084. 3085 included as part of the user specific field 3074, use 36 bits for RU allocation. Thus, this approach of joint RU allocation, for this example, uses a total of 37 bits for RU allocation, as indicated by information block 3097.

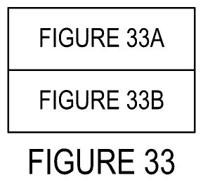

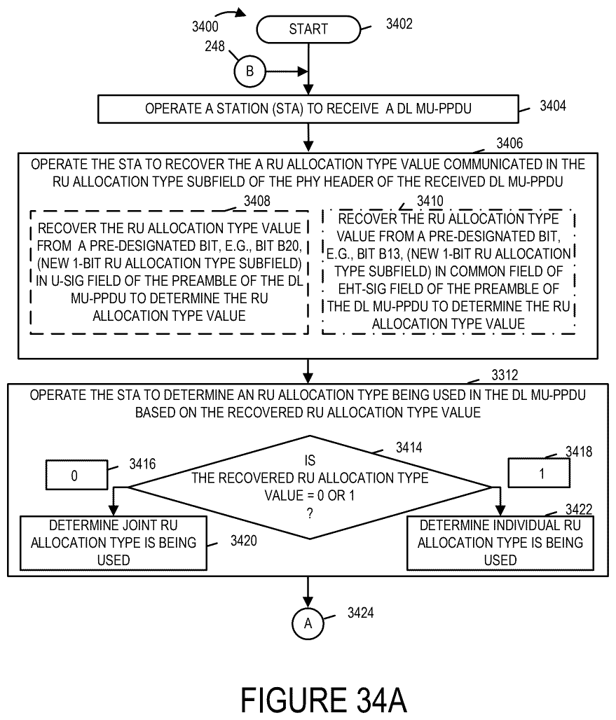

FIG. 31 and FIG. 32 illustrate an example, in accordance with the present invention, in which the AP, implementing the hybrid solution, will choose joint allocation. Consider the scenario of: a 80 MHz PPDU to be allocated to 5 OFDMA multiplexed STAs, with 3 STAs occupying 20 MHz each, 1 STA occupying 106+25 RU#4 and 1 STA occupying 106 R#5, as indicated by information box 3102 of drawing 3100 of FIG. 31. Drawing 3101 of FIG. 31 illustrates a plot of subcarrier index on the vertical axis 3104 vs time on the horizontal axis 3105. Time includes a pre-EHT portion 3106 and an EHT-LTF portion 3108. In this example: R#1 3110, with a size of 242 subcarriers (tones) is allocated to user #1, R#2 3112, with a size of 242 subcarriers (tones) is allocated to user #2; R#3 3112, with a size of 242 subcarriers (tones) is allocated to user #3, R#4 2916 with a size of 106+26 subcarriers (tones) is allocated to user #4, and R#5 3118, with a size of 106 subcarriers (tones) is allocated to user #5.

With the existing RU allocation method, the RU allocation in the common field of EHT-SIG is set to: 001000000, 001000000, 001000000, 000110000. This approach uses 36 bits to communicate the RU allocation.

Drawing 3200 of FIG. 32 illustrates the existing RU allocation approach, where the RU allocation subfields are in the common fields of the EHT-SIG, as indicated by title box 3235. EHT-SIG 3202 includes two EHT-SIG content channels (EHT-SIG content channel 1 3204 and EHT-SIG content channel 2 3206).

EHT-SIG content channel 1 3204 includes common field 3208 and user specific field 3210. Common field 3208 includes two RU Allocation-A subfields (RU Allocation A subfield 3216, RU allocation A subfield 3218). RU allocation A subfield 3216 carries the 9-bit pattern=001000000, as indicated by information 3217. RU allocation A subfield 3218 carries the 9-bit pattern=001000000, as indicated by information 3219. User specific field 3210 includes user field 1 3220 and user field 2 3222. User field 1 3220 includes STA1 ID 3221 in a STA ID subfield. User field 2 3322 includes STA2 ID 3223 in a STA ID subfield.

EHT-SIG content channel 2 3206 includes common field 3212 and user specific field 3214. Common field 3212 includes two RU Allocation-A subfields (RU Allocation A subfield 3224, RU allocation A subfield 3226). RU allocation A subfield 3224 carries the 9-bit pattern=001000000, as indicated by information 3225. RU allocation A subfield 3226 carries the 9-bit pattern=001000000, as indicated by information 3227. User specific field 3214 includes user field 1 3228, user field 2 3230, and user field 3 3232. User field 1 3228 includes STA3 ID 3229 in a STA ID subfield. User field 2 3230 includes STA4 ID 3231 in a STA ID subfield. User field 3 3232 includes STA5 ID 3233 in a STA ID subfield.

The 5 9-Bit RU allocation A subfields (3216, 3218, 3224, 3226) carry a total of 36 bits for RU allocation, as indicated by information block 3234.

With an approach, in accordance with the present invention, a single bit, set to value=1 (communicated in an RU allocation type field) is used to signal joint RU allocation, and the joint RU allocation is signaled: 001000000, 001000000, 001000000, 000110000. This approach uses 37 bits total to communicate the allocation.

Drawing 3250 of FIG. 32 illustrates the proposed RU allocation approach, using the joint RU allocation type, where the RU allocation subfields are in the common fields of the EHT-SIG, as indicated by title box 3287. EHT-SIG 3252 includes two EHT-SIG content channels (EHT-SIG content channel 1 3254 and EHT-SIG content channel 2 3256).

EHT-SIG content channel 1 3254 includes common field 3258 and user specific field 3260. Common field 3258 includes a RU allocation type subfield 3266 and two RU Allocation-A subfields (RU Allocation A subfield 3268, RU allocation A subfield 3270).

RU allocation type subfield 3266, e.g., a single bit field, with a value set to 0, as indicated by box 3267, which indicates joint RU allocation type. Alternatively, the RU type allocation field, indicating joint RU allocation type, may be included and communicated in the U-SIG.

RU allocation A subfield 3268 carries the 9-bit pattern=001000000, as indicated by information 3269. RU allocation A subfield 3270 carries the 9-bit pattern=001000000, as indicated by information 3271. User specific field 3260 includes user field 1 3272 and user field 2 3274. User field 1 3272 includes STA1 ID 3273 in a STA ID subfield. User field 2 3274 includes STA2 ID 3275 in a STA ID subfield.

EHT-SIG content channel 2 3256 includes common field 3262 and user specific field 3264. Common field 3262 includes two RU Allocation-A subfields (RU Allocation A subfield 3276, RU allocation A subfield 3278). RU allocation A subfield 3276 carries the 9-bit pattern=001000000, as indicated by information 3225. RU allocation A subfield 3226 carries the 9-bit pattern=001000000, as indicated by information 3277. User specific field 3264 includes user field 1 3280, user field 2 3282, and user field 3 3284. User field 1 3280 includes STA3 ID 3281 in a STA ID subfield. User field 2 3282 includes STA4 ID 3283 in a STA ID subfield. User field 3 3284 includes STA5 ID 3285 in a STA ID subfield.

One bit is used for conveying the RU allocation type, e.g., in the RU allocation type subfield 3266 of the common field 3258 or alternatively in an RU allocation type subfield in U-SIG. In addition, the four 9-Bit RU allocation A subfields (3268, 3270, 3276, 3278) use a total of 36 bits for RU allocation. Thus, this approach, in accordance with some embodiments of the present invention, uses a total of 37 bits for RU allocation, as indicated by information block 3268.

Note that for the scenarios where joint RU allocation is chosen, the method, in accordance with present invention suffers for 1-bit extra overhead compared to the existing approach, due to the inclusion of the new RU allocation type subfield. However, on average over all possible scenarios, the gain achieved, by using the hybrid allocation type approach, which includes the individual RU allocation type, is significant over the existing approach which only uses joint RU allocation.

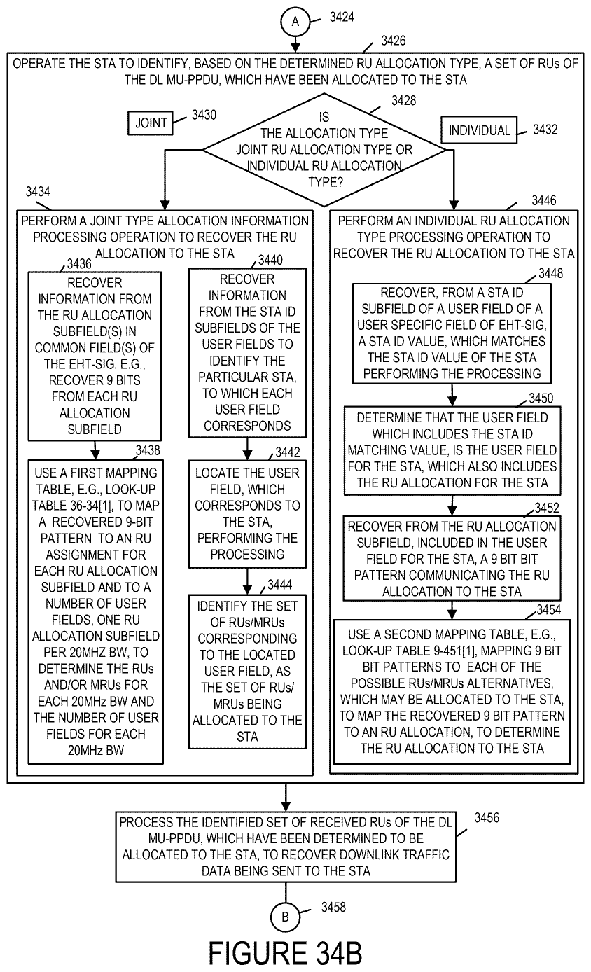

FIG. 33, comprising the combination of FIG. 33A and FIG. 33B, is a flowchart 3300 of an exemplary method of operating an access point (AP) in accordance with an exemplary embodiment. Operation starts in step 3302, in which the AP is powered on and initialized. Operation proceeds from start step 3302 to step 3304. In step 3304 the AP determines the bandwidth for a DL MU-PPDU. In some embodiments, the selected bandwidth (BW) is one of: 20 MHz BW, 40 MHz BW, 80 MHz BW, 160 MHz BW, or 320 MHz BW. Operation proceeds from step 3306 to step 3308, in which the AP identifies, e.g., selects, each of the stations (STAs) which are to be allocated resources of the DL MU-PPDU. Operation proceeds from step 3308 to step 3309. In step 3309 the AP determines an allocation for the BW, e.g., determines a set of RUs and/or MRUs corresponding to the BW, which are to be allocated. Operation proceeds from step 3309 to step 3310. In step 3310, the AP determines which resources (RU(s) and/or MRU(s)) of the DL MU-PPDU are to be allocated to each of the identified STAs. Operation proceeds from step 3310 to step 3312.

In step 3312 the AP determines the RU allocation type based on the DL MU-PPDU BW and/or the number of multiplexed STAs (nSTA), e.g., where BW is one of: 20 MHz, 40 MHz, 160 MHz or 320 MHz. Step 3312 includes steps 3314, 3320, 3326, 2232, 3338, 3344, 3350 and 3352. In step 3314 the AP determines if the MU-PPDU BW is greater than or equal to 80 MHz. If the determination of step 3314 is that the MU-PPDU BW is greater than or equal to 80 MHz, as indicated by Y 3318, then operation proceeds from step 3314 to step 3320. However, if the determination of step 3314 is that the MU-PPDU BW is not greater than or equal to 80 MHz (e.g., MU=PPDU BW=20 MHz or 40 40 MHz), as indicated by N 3316, then operation proceeds from step 3314 to step 3350, in which the AP determines that the RU allocation type to be used is the joint RU allocation type.

Returning to step 3320, in step 3320 the AP determines if the MU-PPDU BW=80 MHz and nSTA is less than 4. If the determination of step 3320 is that the MU-PPDU BW=80 MHz and nSTA is less than 4, as indicated by Y 3324, then operation proceeds from step 3320 to step 3352, in which the AP determines that the RU allocation type to be used is the individual RU allocation type. However, if the determination of step 3320 is the condition of: MU-PPDU BW=80 MHz and nSTA<4, is not satisfied, as indicated by N 3222, then operation proceeds from step 3320 to step 3326.

In step 3326 the AP determines if the MU-PPDU BW=80 MHz and nSTA is greater than or equal to 4. If the determination of step 3326 is that MU-PPDU BW=80 MHz and nSTA is greater than or equal to 4, as indicated by Y 3328, then operation proceeds from step 3326 to step 3350, in which the AP determines that the RU allocation type to be used is the joint RU allocation type. However, if the determination of step 3326 is that the condition of: MU-PPDU BW=80 MHz and nSTA is greater than or equal to 4, is not satisfied, as indicated by N 3330, then operation proceeds from step 3326 to step 3332.

In step 3332 the AP determines if the MU-PPDU BW=160 MHz and nSTA is less than 8. If the determination of step 3332 is that the MU-PPDU BW=160 MHz and nSTA is less than 8, as indicated by Y 3336, then operation proceeds from step 3332 to step 3352, in which the AP determines that the RU allocation type to be used is the individual RU allocation type. However, if the determination of step 3332 is that the condition of: MU-PPDU BW=160 MHz and nSTA<8, is not satisfied, as indicated by N 3334, then operation proceeds from step 3332 to step 3338.

In step 3338 the AP determines if the MU-PPDU BW=160 MHz and nSTA is greater than or equal to 8. If the determination of step 3338 is that MU-PPDU BW=160 MHz and nSTA is greater than or equal to 8, as indicated by Y 3340, then operation proceeds from step 3338 to step 3350, in which the AP determines that the RU allocation type to be used is the joint RU allocation type. However, if the determination of step 3338 is that the condition of: MU-PPDU BW=160 MHz and nSTA is greater than or equal to 8, is not satisfied, as indicated by N 3342, then operation proceeds from step 3338 to step 3344.

In step 3344 the AP determines if the MU-PPDU BW=320 MHz and nSTA is less than 16. If the determination of step 3344 is that the MU-PPDU BW=320 MHz and nSTA is less than 16, as indicated by Y 3348, then operation proceeds from step 3344 to step 3352, in which the AP determines that the RU allocation type to be used is the individual RU allocation type. However, if the determination of step 3344 is that the condition of: MU-PPDU BW=320 MHz and nSTA<16, is not satisfied, as indicated by N 3346, then operation proceeds from step 3344 to step 3350, in which the AP determines that the RU allocation type to be used is the joint RU allocation type.

Operation proceeds from step 3312 to step 3354, in which the AP determines an RU allocation type value based on the determined RU allocation type to be used. Step 3354 includes steps 3356, 3362 and 3364. In step 3356 the AP checks as to whether the determined RU allocation type to be used is joint RU allocation type or individual allocation type. If the determined RU allocation type to be used is the joint RU allocation type, as indicated by joint 3358, then operation proceeds from step 3356 to step 3362, in which the AP sets the RU allocation type value to 0. However, if the determined RU allocation type to be used is the individual RU allocation type, as indicated by individual 3360, then operation proceeds from step 3356 to step 3364, in which the AP sets the RU allocation type value to 1. Operation proceeds from step 3354, via connecting node A 3365 to step 3367.

In step 3367 the AP generates the DL MU-PPDU. Step 3367 includes step 3368 and step 3396. In step 3367 the AP generates a PHY header for the DL MU-PPDU. Step 3368 includes step 3370, 3376, 3382 and 3388.

In step 3370, the AP sets the RU allocation type subfield to the determined RU allocation type value. Step 3370 includes one of step 3372 or step 3374, e.g., depending upon the implementation. In step 3372, the AP sets a pre-designated bit, e.g., bit B20, (new 1-bit RU allocation type subfield) in U-SIG field of the preamble of the DL MU-PPDU to the determined RU allocation type value. In step 3374, the AP sets a pre-designated bit, e.g., bit B13, (new 1-bit RU allocation type subfield) in common field of EHT-SIG field of the preamble of the DL MU-PPDU to the determined RU allocation type value.

In step 3376, the AP determines whether the allocation type, for the DL MU-PPDU, is joint RU allocation type or individual allocation type. If the determination of step 3376 is that the allocation type is the joint RU allocation type, as indicated by joint 3378, then operation proceeds from step 3376 to step 3382. However, if the determination of step 3376 is that the allocation type is the individual RU allocation type, as indicated by individual 3380, then operation proceeds from step 3376 to step 3388.

In step 3382, the AP generates joint RU allocation type information. Step 3382 includes step 3383 and step 3386. In step 3383 the AP generates EHT-SIG common field(s). Step 3383 includes step 3384, in which the AP includes RU allocation subfield(s) in common field(s) of the EHT-SIG. Step 3384 includes step 3385, in which the AP uses a first mapping table, e.g., table 36-34 of Reference [1] to generate, a 9-bit value for each RU allocation subfield, one RU allocation subfield (RU allocation-A subfield or RU allocation-B subfield) per 20 MHz bandwidth, said 9-bit value identifying a particular set of RUs and/or MRUs an a number of user fields.

In step 3386 the AP includes user specific field(s) in the EHT-SIG. Step 3386 includes step 3387, in which the AP includes user field(s) corresponding to each common field, each user field including a STA ID in a STA ID subfield, said STA ID indicating that a particular RU or MRU is being allocated to the STA identified by the STA ID.

Returning to step 3338, in step 3338 the AP generates individual RU allocation type information. Step 3388 includes step 3889 and step 3890. In step 3389 the AP generates a EHT0SIG common field that does not include RU allocation subfields. In step 3390 the AP includes a user specific field in the EHT-SIG field. Step 3390 includes step 3392 and step 3393. In step 3392 the AP includes a set of user fields, one user field for each STA to be assigned a RU or MRU. In step 3393, the AP includes, in each user field,: i) a STA ID in a STA ID subfield; and ii) a 9-bit value in a new subfield for individual per-STA RU allocation, said 9-bit value identifying a particular RU or MRU being allocated to the STA corresponding to the STA ID. Step 3393 includes step 3394, in which the AP uses a look-up table, e.g., a second mapping table, enumerating all possible RUs/MRUs in the operating BW, e.g., table 9-46l of Reference [1], which requires 9 bits for signaling an identified RU or MRU to a STA, to generate a 9 bit individual per-STA RU allocation subfield value for each STA.

In step 3396 the AP includes DL data, for each of the STAs, which are to be allocated a RU or MRU, on the assigned RU or MRU corresponding to the STA. Operation proceeds from step 3367 to step 3398, in which the AP transmits the generated DL MU-PPDU. Operation proceeds from step 3398, via connecting node B 3399, to step 3304.

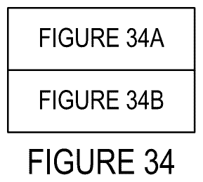

FIG. 34, comprising the combination of FIG. 34A and FIG. 34B, is a flowchart 3400, of an exemplary method of operating a station (STA) in accordance with an exemplary embodiment. Operation of the exemplary method starts in step 3402, in which the STA is powered on and initialized. Operation proceeds from start step 3402 to step 3404, in which the STA is operated to receive a DL MU-PPDU. Operation proceeds from step 3404 to step 3406.

In step 3406 the STA is operated to recover a RU allocation type value communicated in the RU allocation type subfield of the PHY header of the received DL MU-PPDU. Step 3406 includes step 3408 or step 3410, e.g., depending upon the implementation. In step 3408, the AP recovers the RU allocation type value from a pre-designated bit, e.g., bit B20, (new 1 bit RU allocation type subfield) in U-SIG field of the preamble of the DL MU-PPDU to determine the RU allocation type value. In step 3410, the AP recovers the RU allocation type value from a pre-designated bit, e.g., bit B13, (new 1 bit RU allocation type subfield) in common field of EHT-SIG field of the preamble of the DL MU-PPDU to determine the RU allocation type value. Operation proceeds from stpe 3406 to step 3312.

In step 3312 the STA determines an RU allocation type being used in the DL MU-PPDU based on the recovered RU allocation type value. Step 3312 includes step 3414, 3420 and 3422. In step 3414, the STA determines if the recovered RU allocation type value is 0 or 1. If the determination of step 3414 is that the recovered RU allocation type value is 0, as indicated by “0” 3416, then operation proceeds from step 3414 to step 3420, in which the STA determines that the joint RU allocation type is being used in the DL MU-PPDU. However, if the determination of step 3414 is that the recovered RU allocation type value is 1, as indicated by “1” 3418, then operation proceeds from step 3414 to step 3422, in which the STA determines that the individual RU allocation type is being used in the DL MU-PPDU.

Operation proceeds from step 3312, via connecting node A 3424 to step 3426. In step 3426, the STA is operated to identify, based on the determined RU allocation type, a set of RUs of the DL MU-PPDU, which have been allocated to the STA. Step 3426 includes step 3428, 3434 and 3446.

In step 3428 the STA determines whether the RU allocation type is the joint RU allocation type or the individual RU allocation type. If the determination of step 3428 is that the RU allocation type is joint RU allocation type, as indicated by “joint” 3430, then operation proceeds from step 3428 to step 3434, in which the STA performs a joint RU allocation information processing operation to recover the RU allocation to the STA. However, if the determination of step 3428 is that the RU allocation type is individual RU allocation type, as indicated by “individual” 3432, then operation proceeds from step 3428 to step 3446, in which the STA performs an individual RU allocation information processing operation to recover the RU allocation to the STA.

Returning to step 3434, in step 3434 the STA performs a joint type allocation information processing operation to receive the RU allocation to the STA. Step 3434 includes steps 3436, 3438, 3440, 3442, and 3444. In step 3436 the STA recovers information from the RU allocation subfield(s) in common field(s) of the EHT-SIG, e.g., the AP recovers 9 bits from each RU allocation subfield, which may be a RU allocation-A subfield or a RU allocation-B subfield. Operation proceeds from step 3436 to step 3438. In step 3438 the AP uses a first mapping table, e.g., look-up table 36-34 of Reference [1], to map a recovered 9-bit pattern to an RU assignment for each RU allocation subfield and to a number of user fields, one allocation subfield per 20 MHz BW, to determine the RUs and/or MRUs for each 20 MHz BW and the number of user fields for each 20 MHz BW.

In step 3440 the STA recovers information from the STA ID subfields of the user fields to identify the particular STA to which each user field corresponds. Operation proceeds from step 3440 to step 3442, in which the STA locates the user field, which corresponds the STA performing the processing. Operation proceeds from step 3442 to step 3444, in which the STA identifies the set of RUs/MRUs corresponding to the located user field, as the set of RUs/MRUs being allocated to the STA.

Returning to step 3446, in step 3446, the STA performs an individual RU allocation type processing operation to recover the RU allocation to the STA. Step 3446 includes steps 3448, 3450, 3452 and 3454. In step 3448 the STA recovers, from a STA ID field of a user specific field of EHT-SIG, a STA ID value, which matches the STA ID value of the STA performing the processing. Operation proceeds from step 3448 to step 3450, in which the STA determines that the user field which includes the STA ID matching value, is the user field for the STA, which also includes the RU allocation for the STA. Operation proceeds from step 3450 to step 3452. In step 3452 the STA recovers, from the RU allocation subfield, included in the user field for the STA, a 9 bit pattern communicating the RU allocation to the STA. Operation proceeds from step 3452 to step 3454, in which the STA uses a second mapping table, e.g., look-up table 9-46l of Reference [1], mapping 9 bit patterns to each of the possible RUs/MRUS alternatives, which may be allocated to the STA, to map the recovered 9 bit pattern to a particular RU allocation, to determine the RU allocation to the STA.

Operation proceeds from step 3426 to step 3456, in which the STA processes the identified set of received RUS of the DL MU-PPDU, which have been determined to be allocated to the STA, to recover the downlink traffic data being sent to the STA. Operation proceeds from step 3456, via connecting node B 3458 to step 3404.

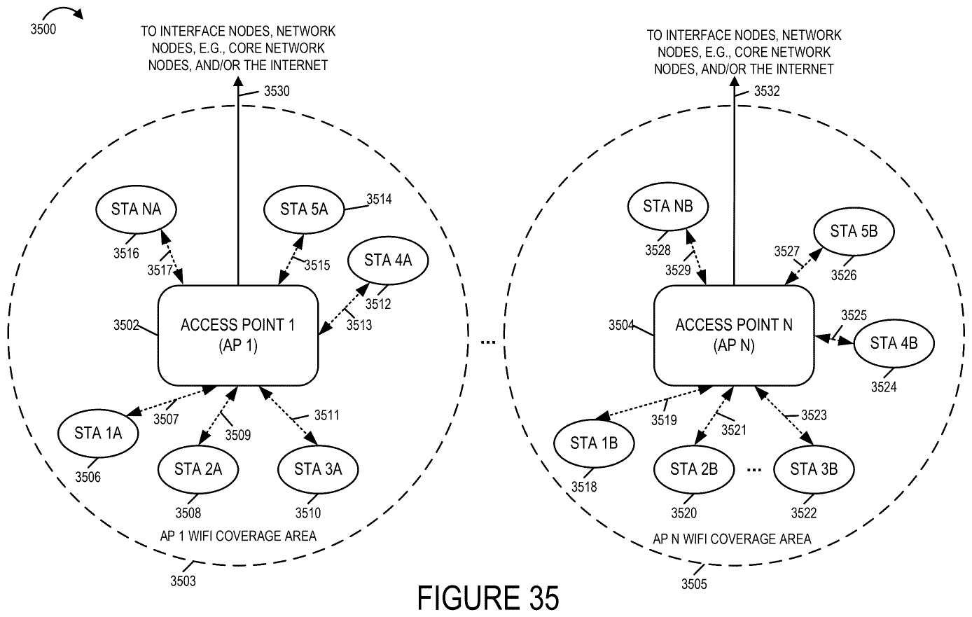

FIG. 35 is a drawing of an exemplary communications system 3500 in accordance with an exemplary embodiment. Exemplary communications system 3500 supports a hybrid approach to RU allocation signaling for DL MU-PPDU, in which the type of RU allocation used for a DL MU-PPDU is a function of bandwidth (BW) of the MU-PPDU and the number of STA to be allocated resources in the MU-PPDU. In various embodiments, in accordance with a feature of the present invention, the DL MU-PPDU includes a novel RU allocation type subfield, e.g., a 1 bit field, which conveys a value indication whether joint type RU allocation or individual type RU allocation is being used. Different mapping tables are used for the different types of RU allocation. When joint type RU allocation is used, the RU allocation subfield(s), e.g. RU allocation-A subfield(s) and RU allocation-B subfield(s) are included in a common field(s), e.g., of an EHT-SIG field of the DL MU-PPDU, and there is one 9-bit RU allocation subfield for each 20 MHz BW portion. When individual type RU allocation is used, there are per-STA RU allocation subfields included in the user specific field, e.g., of an EHT-SIG field of the DL MU-PPDU, one 9-bit RU allocation field for each STA, which is being allocated resources in the DL MU-PPDU. This hybrid approach reduces the overhead for signaling RU, from the existing approach, when the number of STAs is low (e.g., below 4, 8, or 16) for 80 MHz, 160 MHz and 320 MHz MU-PPDUs, respectively.

Exemplary communications system 3500 includes a plurality of access points (AP 1 3502, . . . , AP N 3504) and a plurality of stations (STA 1A 3506, STA 2A 3508, STA 3A 3510, STA 4A 3512, STA 5A 3514, . . . , STA NA 3516, STA 1B 3518, STA 2B 3520, STA 3B 3522, STA 4B 3524, STA 5B 3526, . . . , STA NB 3529), coupled together as shown. In some embodiments, at least some of the STAs are mobile devices, which may move throughout system 300 and may be coupled to different APs at different times. Each AP has a corresponding WiFi coverage area. In some embodiments, WiFi coverage areas for some of the APs may overlap. AP 1 3502 has a corresponding WiFi coverage area 3503. AP N 3504 has a corresponding WiFi coverage area 3505.

AP 1 3502 is coupled to interface nodes, network nodes, e.g., core network nodes, other APs, and/or the Internet via communications link 3530, e.g., a wire or fiber optic communications link. AP N 3504 is coupled to interface nodes, network nodes, e.g., core network nodes, other APs, and/or the Internet via communications link 3530, e.g., a wire or fiber optic communications link.

AP 1 3502 is coupled to STAs (STA 1A 3506, STA 2A 3508, STA 3A 3510, STA 4A 3512, STA 5A 3514, . . . , STA NA 3516) via wireless communications link (3507, 3509, 3511, 3513, 3515, . . . , 3517), respectively. AP N 3504 is coupled to STAs (STA 1B 3518, STA 2B 3520, STA 3B 3522, STA 4B 3524, STA 5A 3526, . . . , STA NA 3528) via wireless communications link (3519, 3521, 3523, 3525, 3527, . . . , 3529), respectively.

The APs (AP 1 3502, AP 2 3504) and STAs (STA 1A 3506, STA 2A 3508, STA 3A 3510, STA 4A 3512, STA 5A 3514, . . . , STA NA 3516, STA 1B 3518, STA 2B 3520, STA 3B 3522, STA 4B 3524, STA 5B 3526, . . . , STA NB 3529) support and implement methods in accordance with the present invention. For example, the APs (AP 1 3502, AP 2 3504) support and implement the method of flowchart 2300 of FIG. 23 and/or the method of flowchart 3300 of FIG. 33; and the STAs (STA 1A 3506, STA 2A 3508, STA 3A 3510, STA 4A 3512, STA 5A 3514, . . . , STA NA 3516, STA 1B 3518, STA 2B 3520, STA 3B 3522, STA 4B 3524, STA 5B 3526, . . . , STA NB 3529) support and implement the method of flowchart 3400 of FIG. 34.

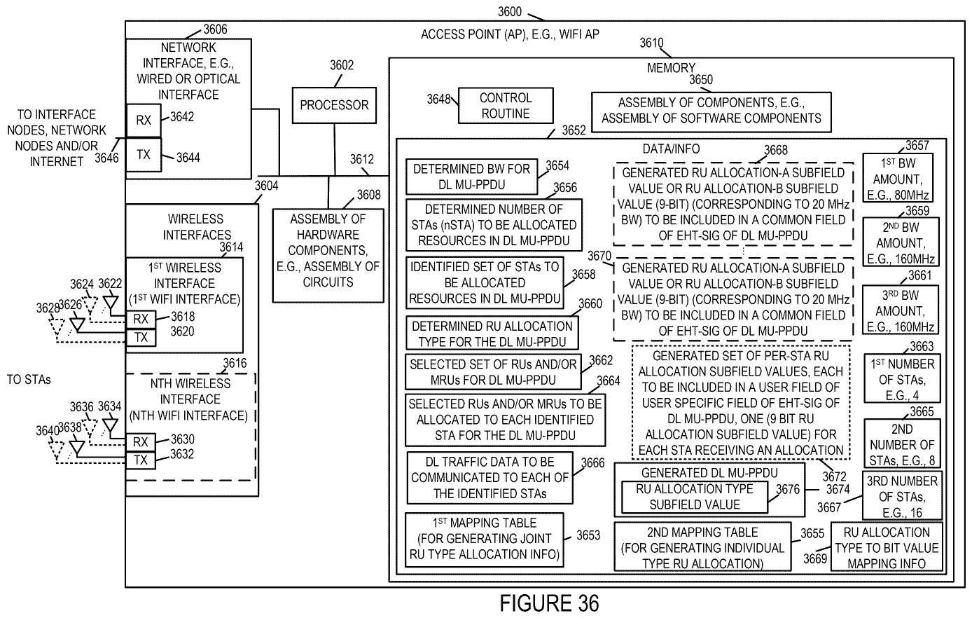

FIG. 36 is a drawing of an exemplary access point (AP) 3600, e.g., a WiFi AP, in accordance with an exemplary embodiment. Exemplary access point 3600 is, e.g., AP 1 3502 or AP N 3504 of system 3500 of FIG. 35, an AP implementing steps of the exemplary method of flowchart 2300 of FIG. 23, an AP implementing steps of the exemplary method of flowchart 3300 of FIG. 33. Exemplary access point (AP) 3600 includes a processor 3602, e.g., a CPU, wireless interfaces 3604, network interface 3606, assembly of hardware components 3608, e.g., an assembly of circuits, and memory 3610 coupled together via bus 3612, over which the various elements may interchange data and information.

Wireless interfaces 3604 includes one or more wireless interfaces (1st wireless interface 3614 which is a 1ST WiFi interface, . . . , Nth wireless interface 3616 which is an Nth wireless interface). Different wireless interfaces included in wireless interfaces 3604 may correspond to different frequency bands, different communications protocols and/or different communications technologies. 1st wireless interface 3614 includes wireless receiver 3618 and wireless transmitter 3620. Wireless receiver 3618 is coupled to one or more antennas or antennas elements (3622, . . . , 3624) via which the access point 3600 receives wireless signals from stations (STAs). Wireless transmitter 3620 is coupled to one or more antennas or antennas elements (3626, . . . , 3628) via which the access point 3600 transmits wireless signals to STAs. Nth wireless interface 3616 includes wireless receiver 3630 and wireless transmitter 3632. Wireless receiver 3630 is coupled to one or more antennas or antennas elements (3634, . . . , 3636) via which access point 3600 receives wireless signals from STAs. Wireless transmitter 3632 is coupled to one or more antennas or antennas elements (3638, . . . , 3640) via which the access point 3600 transmits wireless signals to STAs. Exemplary wireless signals transmitted by access point 3600 include, e.g., a DL MU-PPDU including a RU allocation type subfield value indicating joint RU allocation type and further including RU allocation subfields (RU allocation A and/or RU allocation-B subfields in a common field, e.g., of an EHT-SIG, and a DL MU-PPDU including a RU allocation type subfield value indicating individual RU allocation type and including one or more per-STA RU allocation sub-fields in the user specific field, e.g., of an EHT-SIG.

Network interface 3606, e.g., a wired or optical interface, includes receiver 3642, transmitter 3644 and connector 3646 coupled together. Network interface 3606 couples the access point 3600 to interface nodes, network nodes, e.g. core network nodes, other APs, and/or to the Internet.

Memory 3610 includes control routine 3648, assembly of components 3650, e.g., an assembly of software components, and data/information 3652. Control routine 3648 includes instructions which when executed by processor 3602 control the access point 3600 to implement basic operational functions, e.g., read memory, write to memory, control an interface, load a program, subroutine, or app, etc. Assembly of components 3650, e.g., an assembly of software components, e.g., routines, subroutines, applications, etc., includes, e.g., code, e.g., machine executable instructions, which when executed by processor 3602, controls the AP 3600 to implement steps of a method, e.g., steps of the method of flowchart 2300 of FIG. 23, and/or steps of the method of flowchart 3300 of FIG. 33.

Data/information 3652 includes 1st mapping table 3653 (for generating joint RU type allocation information), 2nd mapping table 3655 (for generating individual type RU allocation information), a first BW amount 3657, e.g., 80 MHz, a 2nd BW amount 3659, e.g., 160 MHz, a 3rd BW amount 3661, e.g., 320 MHz, a 1st number of STAs 3663, e.g., 4, a 2nd number of STAs 3665, e.g., 8, a 3rd number of STAs 3667, e.g., 16, and RU allocation type to bit value mapping information 3669, e.g., information indicating that the value 0 indicates joint type RU allocation and the value 1 indicates individual type RU allocation or alternatively information indicating that the value 1 indicates joint type RU allocation and the value 0 indicates individual type RU allocation.

Data/information 3652 further includes a determined BW for a DL MU-PPDU 3654, a determined number of STAs (nSTA) to be allocated resources in the DL MU-PPDU 3656, an identified set of STAs to be allocated resources in DL MU-PPDU 3658, a determined RU allocation type for the DL MU-PPDU 3660, a selected set of RUs and/or MRUs for the DL MU-PPDU 3662, selected RUs and MRUs to be allocated to each identified STA for the DL MU-PPDU 3664, and DL traffic data to be communicated to each of the identified STAs using allocated resources of the DL MU-PPDU 3666.

If the type of RU allocation to be used for the DL MU-PPDU is joint type RU allocation, then data/information 3652 includes a set of one or more RU allocation subfield values (3668, . . . , 3670), one per 20 MHz BW portion. Generated RU allocation subfield value 3668 is a generated RU allocation-A subfield value or a RU allocation-B subfield value, which is a 9-bit value, corresponding to a 20 MHz BW, and which is to be included in a common field of EHT-SIG of the DL MU-PPDU. Generated RU allocation subfield value 3670 is a generated RU allocation-A subfield value or a RU allocation-B subfield value, which is a 9-bit value, corresponding to another 20 MHz BW, and which is to be included in a common field of EHT-SIG of the DL MU-PPDU. If the type of RU allocation to be used for the DL MU-PPDU is individual type RU allocation, then data/information 3652 includes generated set 3672 of per-STA RU allocation subfield values, each value to be included in a different user field of the user specific field of EHT-SIG of the DL MU-PPDU, one 9-bit RU allocation subfield value being included for each STA which is receiving an allocation in the DL MU-PPDU.

Data/information 3652 further includes a generated DL MU-PPDU 3674, which includes an RU allocation subfield value 3676, and further includes RU allocation subfields (3668, . . . 3670) or set of per-STA RU allocation subfields 3672, depending upon the type of RU allocation indicated by information 3676. The generated DL MU-PPDU 3674 further includes the DL traffic data 3666 in the appropriate RUs and/or MRUs, in accordance with the allocations.

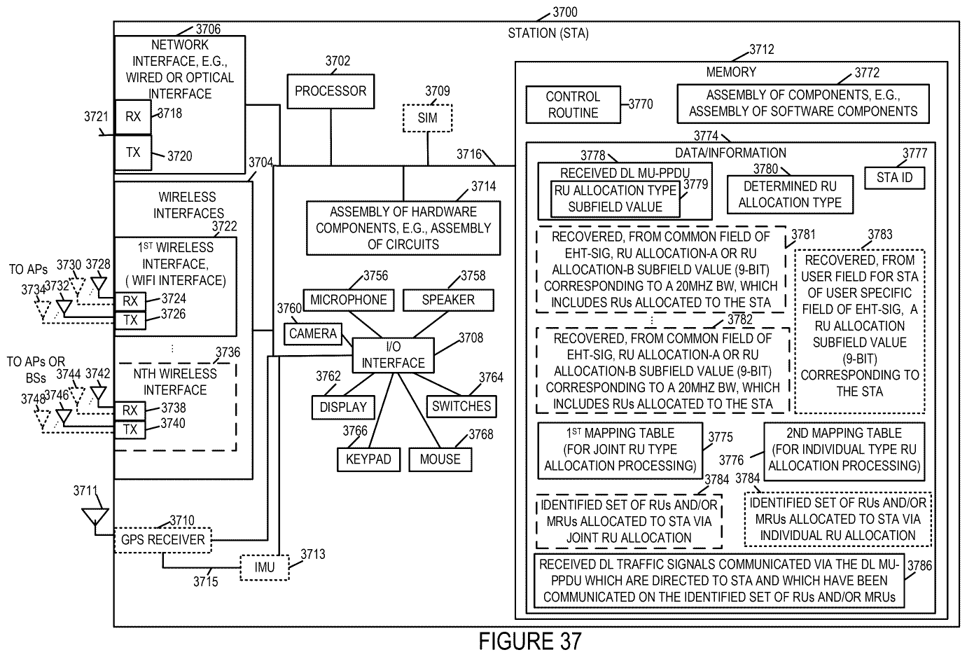

FIG. 37 is a drawing of an exemplary station (STA) 3700, e.g., a client device STA, in accordance with an exemplary embodiment. STA 3700 is, e.g., any of the STAs (3506, 3508, 3510, 3512, 3514, . . . , 3516, 3518, 3520, 3522, 3524, 3528, . . . , 3528) of system 3500 of FIG. 35, and/or a STA implementing steps of the flowchart 3400 of FIG. 34.

Exemplary STA 3700 includes a processor 3702, e.g., a CPU, wireless interfaces 3704, a network interface 3706, an I/O interface 3708, a subscriber identity module (SIM) card 3709, a GPS receiver 3710, an inertial measurement unit (IMU) 3713 which includes gyroscopes and accelerometers, e.g., an IMU on a chip, memory 3712, and an assembly of hardware components 3714, e.g., an assembly of circuits, coupled together via a bus 3716 over which the various elements may interchange data and information.

Wireless interfaces 3704 includes one or more wireless interfaces (1st wireless interface 3722 which is a WiFi wireless interface, . . . , Nth wireless interface 1336, e.g., a WiFi wireless interface, a cellular wireless interface or another type of wireless interface). In some embodiments, wireless interfaces 3704 includes more than one WiFi wireless interfaces. Different wireless interfaces included in wireless interfaces 3704 may correspond to different frequency bands, different communications protocols and/or different communications technologies. 1st wireless interface 3722 includes wireless receiver 3724 and wireless transmitter 3726. Wireless receiver 3724 is coupled to one or more antennas or antennas elements (3728, . . . , 3730) via which the STA 3700 receives wireless signals from access points. Wireless transmitter 3726 is coupled to one or more antennas or antennas elements (3732, . . . , 3734) via which the STA 3700 transmits wireless signals to access points. Nth wireless interface 3736 includes wireless receiver 3738 and wireless transmitter 3740. Wireless receiver 3738 is coupled to one or more antennas or antennas elements (3742, . . . , 3744) via which the STA 3700 receives wireless signals from access points. Wireless transmitter 3740 is coupled to one or more antennas or antennas elements (3746, . . . , 3748) via which the STA 3700 transmits wireless signals to access points. In some embodiments one or more of the same antennas or antenna elements are used by a wireless receiver and a wireless transmitter. Exemplary wireless signals received by STA 3700 include e.g., a DL MU-PPDU including a RU allocation type subfield value indicating joint RU allocation type and further including RU allocation subfields (RU allocation A and/or RU allocation-B subfields in a common field, e.g., of an EHT-SIG, and a DL MU-PPDU including a RU allocation type subfield value indicating individual RU allocation type and including one or more per-STA RU allocation sub-fields in the user specific field, e.g., of an EHT-SIG.

Network interface 3706, e.g., a wired or optical interface, includes receiver 3718, transmitter 3722 and connector 3721 coupled together. Network interface 3706 allows the STA 3700 to be coupled to network nodes and/or the Internet, via a wireline interface connection, when available.

GPS receiver 3710 is coupled to GPS antenna 3710 via which the STA 3700 receives GPS signals from satellites. IMU 3713 is coupled to GPS receiver 3710 via connection 3715. The GPS receiver 3710 determines time, position, and velocity information based on the received GPS signals. In some embodiments, the GPS receiver 3710 and/or the processor 3702 uses IMU 3713 measurement information in addition to the received GPS signals to determine time, position, velocity information, and/or other navigation information. For example, the GPS receiver 3713 and/or processor 3702 uses the IMU information to aid determination of STA location, when GPS reception is unavailable or of low quality. The SIM card 3709, GPS receiver 3710 and IMU 3713 are optional elements which may or may not be included in STA 3700.

STA 3700 further includes a plurality of I/O devices (microphone 3756, speaker 3758, camera 3760, display 3762, e.g. a touch screen display, switches 3764, keypad 3766 and mouse 3768) coupled to I/O interface 3708, via which the various I/O devices may interface with other elements within STA 3700.

Memory 3712 includes control routine 3770, assembly of components 3772, e.g., an assembly of software components, and data/information 3744. Control routine 3770 includes instructions which when executed by processor 3702 control the STA 3700 to implement basic operational functions, e.g., read memory, write to memory, control an interface, load a program, subroutine, or app, etc. Assembly of components 3772, e.g., an assembly of software components, e.g., routines, subroutines, applications, etc., includes, e.g., code, e.g., machine executable instructions, which when executed by processor 3702, controls the STA 3700 to implement steps of a method, e.g., steps of a method of flowchart 3400 of FIG. 34.

Data/information 3734 includes 1st mapping table 3775 (used for joint RU type allocation processing) , 2nd mapping table 3776 (used for individual type RU allocation processing), a STA ID 3777 used to identify STA 3700, a received DL MU-PPDU 3778 including a RU allocation type subfield value 3779, and a determined RU allocation type 3780.

If the type of RU allocation is joint type RU allocation, then data/information 3774 includes a set of one or more recovered RU allocation subfield values (recovered 9-bit RU allocation subfield value 3781, . . . , recovered 9-bit RU allocation subfield value 3782), one value per 20 MHz of BW. Recovered 9-bit RU allocation value 3781, which was recovered from a common field of EHT-SIG, is a RU allocation-A or RU allocation-B subfield value, which corresponds to a 20 MHz BW portion, which includes RUs allocated to STA 3700. Recovered 9-bit RU allocation value 3782, which was recovered from a common field of EHT-SIG, is a RU allocation-A or RU allocation-B subfield value, which corresponds to a 20 MHz BW portion, which includes RUs allocated to STA 3700.

If the type of RU allocation is individual type RU allocation, then data/information 3774 includes a 9 bit RU allocation subfield value 3783, which was recovered from the user field, which corresponds to STA 3700 (e.g., based on matching STA ID in a STA ID subfield with stored STA ID 3777), of the user specific field of EHT-SIG field of the DL MU-PPDU.

If the type of RU allocation is joint type RU allocation, then data/information 3774 includes an identified set 3774 of RUs and/or MRUs allocated to the STA 3700 via joint RU allocation, said identification being performed using 1st mapping table 3775. If the type of RU allocation is individual type RU allocation, then data/information 3774 includes an identified set 3784 of RUs and/or MRUs allocated to the STA 3700 via individual RU allocation, said identification being performed using 2nd mapping table 3776.

Data/information 3774 further includes received DL traffic communicated via the DL-MU PPDU, which is directed to STA 3700, and which have been communicated on the identified set of RUs and/or MRUs 3786.

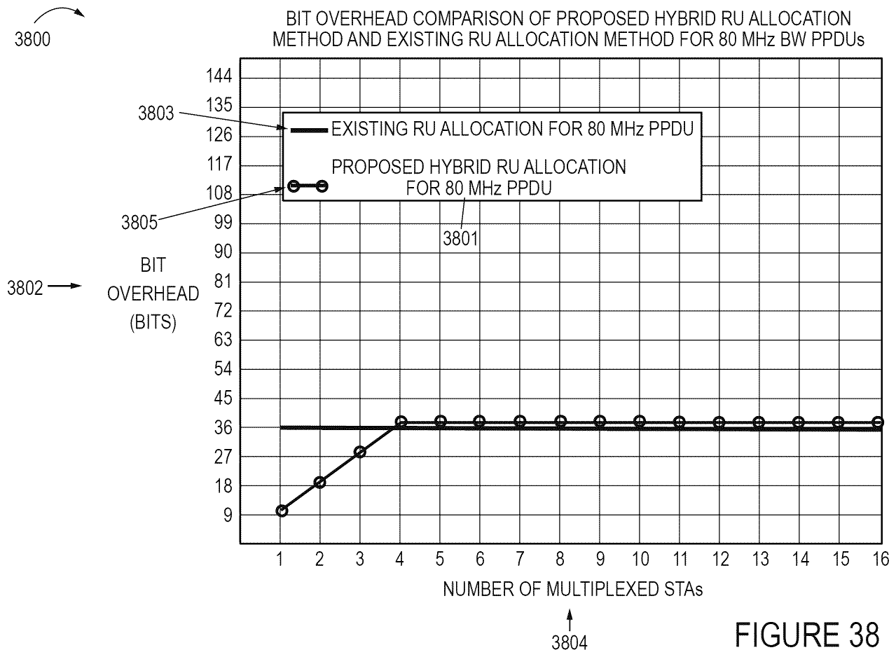

FIG. 38 is drawing of a plot 3800, which illustrates a bit overhead comparison of the proposed hybrid RU allocation communication method to the existing RU allocation communication method for 80 MHz BW PPDUs. Vertical axis 3802 represents Bit overhead (number of bits). Horizontal axis 3804 represents the number of multiplexed STAs. Legend 3801 indicates that solid line 3803 represents the existing RU allocation communication method for 80 MHz PPDUs; and solid line with circles 3805 represents the proposed hybrid RU allocation communication method in accordance with the present invention.

For 80 MHz BW PPDUs, the existing RU allocation approach uses 36 bits, irrespective whether the number of STAs is 1, 2, 3, 4, 5, 6, 7, 8, 9, 10, 11, 12, 13, 14, 15 or 16.

For 80 MHz BW PPDUs, the hybrid allocation approach, in accordance with an exemplary embodiment of the present invention, uses the individual RU allocation type, when the number of STAs is 1, 2, or 3; and uses the joint RU allocation type, when the number of STAs is 4, 5, 6, 7, 8, 9, 10, 11, 12, 13, 14, 15, or 16. For 80 MHz BW PPDUs, the hybrid allocation approach, in accordance with another exemplary embodiment of the present invention, uses the individual RU allocation type, when the number of STAs is 1, 2, 3 or 4; and uses the joint RU allocation type, when the number of STAs is 5, 6, 7, 8, 9, 10, 11, 12, 13, 14, 15, or 16.The hybrid allocation approach, for 80 MHz BW PPDUs, uses (10, 19, 28) bits when the number of STAs is (1, 2, 3), respectively. The hybrid allocation approach, for 80 MHz BW PPDUs, uses 37 bits when the number of STAs is 4, 5, 6, 7, 8, 9, 10, 11, 12, 13, 14, 15, or 16.

For the 80 MHz PPDU, when the number of STAs is 1, 2, or 3, the new hybrid RU allocation approach, in accordance with the present invention, uses less overhead bits to communicate the RU allocations than the existing approach; however, when the number of STAs is 4 or larger, then the existing approach uses less bits to communicate the RU allocations than the new hybrid RU allocation approach.

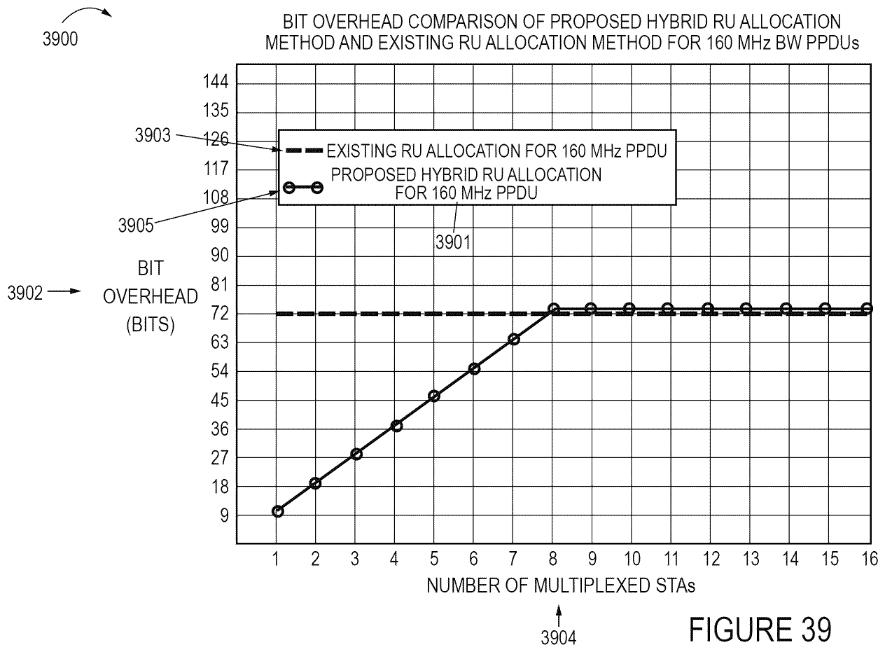

FIG. 39 is drawing of a plot 3900, which illustrates a bit overhead comparison of the proposed hybrid RU allocation communication method to the existing RU allocation communication method for 160 MHz BW PPDUs.

Vertical axis 3902 represents Bit overhead (number of bits). Horizontal axis 3904 represents the number of multiplexed STAs. Legend 3901 indicates that dashed line 3903 represents the existing RU allocation communication method for 160 MHz PPDUs; and solid line with circles 3905 represents the proposed hybrid RU allocation communication method in accordance with the present invention.

For 160 MHz BW PPDUs, the existing RU allocation approach uses 72 bits, irrespective whether the number of STAs is 1, 2, 3, 4, 5, 6, 7, 8, 9, 10, 11, 12, 13, 14, 15 or 16.

For 160 MHz BW PPDUs, the hybrid allocation approach, in accordance with an exemplary embodiment of the present invention, uses the individual RU allocation type, when the number of STAs is 1, 2, 3, 4, 5, 6 or 7; and uses the joint RU allocation type, when the number of STAs is 8, 9, 10, 11, 12, 13, 14, 15, or 16. For 160 MHz BW PPDUs, the hybrid allocation approach, in accordance with another exemplary embodiment of the present invention, uses the individual RU allocation type, when the number of STAs is 1, 2, 3, 4, 5, 6, 7, or 8; and uses the joint RU allocation type, when the number of STAs is 9, 10, 11, 12, 13, 14, 15, or 16. The hybrid allocation approach, for 160 MHz BW PPDUs, uses (10, 19, 28, 37, 46, 55, 64) bits when the number of STAs is (1, 2, 3, 4, 5, 6, 7), respectively. The hybrid allocation approach, for 160 MHz BW PPDUs, uses 73 bits when the number of STAs is 8, 9, 10, 11, 12, 13, 14, 15, or 16.

For the 160 MHz PPDU, when the number of STAs is 1, 2, 3, 4, 5, 6, or 7, the new hybrid RU allocation approach, in accordance with the present invention, uses less overhead bits to communicate the RU allocations than the existing RU allocation approach; however, when the number of STAs is 8 or larger, then the existing approach uses less bits to communicate the RU allocations than the new hybrid allocation approach.

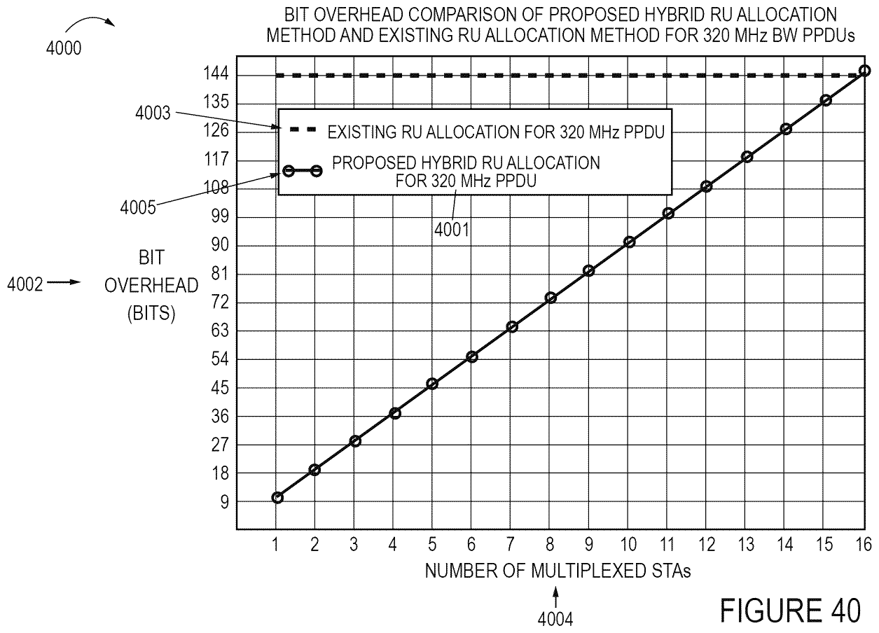

FIG. 40 is drawing of a plot 4000, which illustrates a bit overhead comparison of the proposed hybrid RU allocation communication method to the existing RU allocation communication method for 320 MHz BW PPDUs.

Horizontal axis 4002 represents Bit overhead (number of bits). Horizontal axis 4004 represents the number of multiplexed STAs. Legend 4001 indicates that dashed line 4003 represents the existing RU allocation communication method for 160 MHz PPDUs; and solid line with circles 4005 represents the proposed hybrid RU allocation communication method in accordance with the present invention.

For 320 MHz BW PPDUs, the existing RU allocation approach uses 144 bits, irrespective whether the number of STAs is 1, 2, 3, 4, 5, 6, 7, 8, 9, 10, 11, 12, 13, 14, 15 or 16.

For 320 MHz BW PPDUs, the hybrid allocation approach, in accordance with an exemplary embodiment of the present invention, uses the individual RU allocation type, when the number of STAs is 1, 2, 3, 4, 5, 6, 7, 8, 9, 10, 11, 12, 13, 14 or 15; and uses the joint RU allocation type, when the number of STAs is 16. For 320 MHz BW PPDUs, the hybrid allocation approach, in accordance with another exemplary embodiment of the present invention, uses the individual RU allocation type, when the number of STAs is 1, 2, 3, 4, 5, 6, 7, 8, 9, 10, 11, 12, 13, 14, 15 or 16; The hybrid allocation approach, for 160 MHz BW PPDUs, uses (10, 19, 28, 37, 46, 55, 64, 73, 82, 91, 100, 109, 118, 127, 136) bits when the number of STAs is (1, 2, 3, 4, 5, 6, 7, 8, 9, 10, 11, 12, 13, 14, 15), respectively. The hybrid allocation approach, for 160 MHz BW PPDUs, uses 145 bits when the number of STAs is 16.

For the 320 MHz PPDU, when the number of STAs is 1, 2, 3, 4, 5, 6, 7, 8, 9, 10, 11, 12, 13, or 14 the new hybrid RU allocation approach, in accordance with the present invention, uses less overhead bits to communicate the RU allocations than the existing RU allocation approach; however, when the number of STAs is 16, then the existing approach uses less bits to communicate the RU allocations than the new hybrid RU allocation approach.

Various aspects and/or features of some embodiments of the present invention are further described below. Individual RU allocation in DL MU PPDUs is implemented and used, e.g., in various versions and/or amended versions of IEE 802.11, e.g., an amended IEEE 802.11be and/or in other future versions/amendments. A hybrid solution, in accordance with some exemplary embodiments, takes into account the PPDU BW and/or the number of multiplexed STAs. In various embodiments, a new subfield, e.g. allocation type subfield, is implemented and used to enable/signal both the individual and joint allocation. In some embodiments, the new subfield, e.g., allocation type subfield, is included as part of U-SIG or part of common field of a version dependent SIG field, e.g., EHT-SIG, UHR-SIG, or another future signal field. When the new subfield, e.g., RU allocation type subfield, is set to a first value, e.g., 0, indicating joint type RU allocation, joint RU allocation is signaled, e.g., in the common field(s), e.g., of the EHT-SIG or UHR-SIG; however, when the new subfield, e.g., RU allocation type subfield, is set to a second value, e.g., 1, indicating individual type RU allocation, then individual RU allocation is signaled per-STA in the user specific field. Per-STA RU allocation in DL MU PPDU can be, and in some embodiments is, signaled by a look up table, enumerating all possible RUs/MRUs in the operating BW. As an example, of such a table, existing look-up table in EHT amendment, Table 9-46l of Reference [1] can be, and in some embodiments is, re-used, which requires 9 bits for signaling to each STA. As a result of using the hybrid solution, the bit overhead can be reduced by up to 80%, depending on the scenario. The reduced bit overhead can be translated into saving frequency resources and/or time resources. The newly available frequency/time resources can be used for other purposes in future amendments of 802.11. The other purposes are including but not limited to repetition of existing fields for reliability, and introduction of additional subfields for an optimized detection/decoding performance.

### 1st Numbered List of Exemplary Method Embodiments

Method Embodiment 1. A method of operating an access point (AP), the method comprising: determining (3304), at the AP, a bandwidth to be used for a first physical layer protocol data unit (PPDU), said determined bandwidth being the bandwidth of the first PPDU; determining (3306), at the AP, a number of stations (STAs) allowed to use resources of the first PPDU; determining (3312) a resource unit (RU) allocation type for the first PPDU based on at least one of: i) the bandwidth of the first PPDU and ii) the number of stations allowed to use resources of the first PPDU; and transmitting (3398) the first PPDU, said first PPDU including an allocation type subfield with a bit indicating the determined RU allocation type of the first PPDU.
Method Embodiment 1A. The method of Method Embodiment 1, wherein determining (3312) a resource unit (RU) allocation type for the first PPDU based on at least one of: i) the bandwidth of the first PPDU and ii) the number of stations allowed to use resources of the first PPDU, includes determining (N output 3316 of step 3314) the RU allocation type based on the BW when the BW is below a first bandwidth (BW) amount (e.g., 80 MHz), said determining including determining (3350) to use a joint RU allocation type when the bandwidth of the first PPDU is below said first BW amount.
Method Embodiment 1B. The method of Method Embodiment 1, wherein determining (3312) a resource unit (RU) allocation type for the first PPDU based on at least one of: i) the bandwidth of the first PPDU and ii) the number of stations allowed to use resources of the first PPDU, includes determining (Y output 3318 of step 3314) the RU allocation type based on both the BW and the number of STAs to which RU are being allocated when the BW is equal to or greater than a first bandwidth (BW) amount (e.g., 80 MHz).
Method Embodiment 1C. The method of Method Embodiment 1, wherein determining (3312) a resource unit (RU) allocation type for the first PPDU based on at least one of: i) the bandwidth of the first PPDU and ii) the number of stations allowed to use resources of the first PPDU, includes: determining (3352) to use an individual RU allocation type when (Y output 3324 of step 3320) the PPDU BW is equal to a first BW amount (e.g., 80 MHz) and the number of STAs to which RUs are being allocated is less than a first number of STAs (e.g., 4).
Method Embodiment 1C1. The method of Method Embodiment 1, wherein determining (3312) a resource unit (RU) allocation type for the first PPDU based on at least one of: i) the bandwidth of the first PPDU and ii) the number of stations allowed to use resources of the first PPDU, includes: determining (3350) to use a joint RU allocation type when (Y output 3328 of step 3326) the PPDU BW is equal to a first BW amount (e.g., 80 MHz) and the number of STAs to which RUs are being allocated is greater than or equal to a first number of STAs (e.g., 4).
Method Embodiment 1E. The method of Method Embodiment 1, wherein determining (3312) a resource unit (RU) allocation type for the first PPDU based on at least one of: i) the bandwidth of the first PPDU and ii) the number of stations allowed to use resources of the first PPDU, includes: determining (3352) to use an individual RU allocation type when (Y output 3336 of step 3332) the PPDU BW is equal to a second BW amount (e.g., 160 MHz) and the number of STAs to which RUs are being allocated is less than a second number of STAs (e.g., 8).
Method Embodiment 1E1. The method of Method Embodiment 1, wherein determining (3312) a resource unit (RU) allocation type for the first PPDU based on at least one of: i) the bandwidth of the first PPDU and ii) the number of stations allowed to use resources of the first PPDU, includes: determining (3350) to use a joint RU allocation type when (Y output 3340 of step 3338) the PPDU BW is equal to a second BW amount (e.g., 160 MHz) and the number of STAs to which RUs are being allocated is greater than or equal to a second number of STAs (e.g., 8).
Method Embodiment 1F. The method of Method Embodiment 1, wherein determining (3312) a resource unit (RU) allocation type for the first PPDU based on at least one of: i) the bandwidth of the first PPDU and ii) the number of stations allowed to use resources of the first PPDU, includes: determining (3352) to use an individual RU allocation type when (Y output 3348 of step 3344) the PPDU BW is equal to a third BW amount (e.g., 320 MHz) and the number of STAs to which RUs are being allocated is less than a third number of STAs (e.g., 16).
Method Embodiment 1F1. The method of Method Embodiment 1, wherein determining (3312) a resource unit (RU) allocation type for the first PPDU based on at least one of: i) the bandwidth of the first PPDU and ii) the number of stations allowed to use resources of the first PPDU, includes: determining (3350) to use a joint RU allocation type when (N output 3346 of step 3344) the PPDU BW is equal to a third BW amount (e.g., 320 MHz) and the number of STAs to which RUs are being allocated is not less than a third number of STAs (e.g., 16).
Method Embodiment 2. The method of Method Embodiment 1, wherein the resource allocation type is one of a joint RU allocation type (e.g., as indicated by RU allocation type subfield value being set to 0) or an individual (per STA) RU allocation type (e.g., as indicated by setting the RU allocation type subfield value being set to 1).
Method Embodiment 3. The method of Method Embodiment 2, wherein the determined RU allocation type is the individual RU allocation type, and wherein the method further includes: generating (3367) said first PPDU, said first PPDU including an allocation type bit (e.g., of an allocation type subfield) set to a value (e.g., 1) indicating an individual type RU allocation and including individual per STA RU allocations.
Method Embodiment 3A1. The method of Method Embodiment 3, wherein generating an individual per STA RU allocation includes generating a 9-bit RU allocation field value, to be included in a RU allocation subfield included in a user specific field in the EHT-SIG field.
Method Embodiment 3A2. The method of Method Embodiment 3A1, wherein said 9-bit RU allocation field value, to be included in a RU allocation subfield included in a user specific field in the EHT-SIG field is generated based on a second mapping table (e.g., table 9-46l of Reference [1]).
Method Embodiment 3A3. The method of Method Embodiment 3A2, wherein the second mapping table enumerates possible RUs/MRUs alternatives, which may be allocated to an individual STA.
Method Embodiment 3A. The method of Method Embodiment 2, wherein the determined RU allocation type is the individual RU allocation type, and wherein the method further includes: generating said first PPDU, said first PPDU including an allocation type bit (e.g., of an allocation type subfield) set to a value (e.g., 0) indicating an individual type RU allocation and including individual per STA RU allocations.
Method Embodiment 4. The method of Method Embodiment 3, wherein the individual per STA RU allocations include allocations for multiple different individual STAs.
Method Embodiment 5. The method of Method Embodiment 4, wherein individual per-STA RU allocations are included in the User-specific field of EHT-SIG (or UHR-SIG for a UHR PPDU or another signal field for another type of PPDU), with individual allocations being indicated for each STA which is allocated resources of the first PPDU.
Method Embodiment 5A. The method of Method Embodiment 5, wherein RU allocation subfields (RU allocation-A subfields and/or RU allocation-B subfields) are not included in the common field of EHT-SIG, when individual type RU allocation is being used to communicate PPDU resource allocation information.
Method Embodiment 5B. The method of Method Embodiment 5, wherein RU allocation subfields (RU allocation-A subfields and/or RU allocation-B subfields) are included in the common field of EHT-SIG, when the joint type RU allocation is being used to communicate PPDU resource allocation information.
Method Embodiment 5B1. The method of Method Embodiment 5B, wherein a 9-bit value for a RU allocation subfield (RU allocation-A subfields or RU allocation-B subfields) is generated based on a first mapping table (e.g., table 36-34 of Reference [1]).
Method Embodiment 5B2. The method of Method Embodiment 5, wherein there is one RU allocation subfield, included in common field, per 20 MHz BW.
Method Embodiment 5C. The method of Method Embodiment 5B, wherein 9-bit values for RU allocation subfields (RU allocation-A subfields and/or RU allocation-B subfields) which are included in the common field of EHT-SIG, are generated
Method Embodiment 6. The method of Method Embodiment 2, wherein the determined RU allocation type is the joint RU allocation type, and wherein the method further includes: generating (3367) said first DL MU-PPDU including an allocation type bit (e.g., in an allocation type subfield) set to a value (e.g., 0) indicating a joint type RU allocation.
Method Embodiment 6A. The method of Method Embodiment 2, wherein the determined RU allocation type is the joint RU allocation type, and wherein the method further includes: generating said first DL MU-PPDU including an allocation type bit (e.g., in an allocation type subfield) set to a value (e.g., 1).
Method Embodiment 8. The method of Method Embodiment 1, wherein the first PPDU is a downlink (DL) multiuser (MU) PPDU.
Method Embodiment 8A. The method of Method Embodiment 8, wherein the DL MU-PPDU is an EHT MU PPDU.
Method Embodiment 8B. The method of Method Embodiment 8, wherein the DL MU-PPDU is an UHR MU PPDU.
Method Embodiment 9. The method of Method Embodiment 8, wherein the number of RU allocation subfield bits used to communicate the RU allocation for a DL MU-PPDU, using joint type allocation, is a function of the BW irrespective of the number of STAs receiving an allocation; and wherein the number of RU allocation subfield bits used to communicate the RU allocation for a DL MU-PPDU, using individual type allocation, is a function of the number of STAs receiving the allocation irrespective of the BW.
Method Embodiment 9A. The method of Method Embodiment 9, wherein the RU allocation subfield bits used to communicate the RU allocation for a DL MU-PPDU, using joint type allocation, are included in RU allocation-A or RU allocation-B subfields in one or more common fields of EHT-SIG; and wherein the RU allocation subfield bits used to communicate the RU allocation for a DL MU-PPDU, using individual type allocation, are included in per-STA RU allocation subfields in one or more user fields of user specific field of EHT-SIG.

### 1st Numbered List of Exemplary Apparatus Embodiments

Apparatus Embodiment 1. An access point (AP) (3502 or 3600) comprising: a wireless transmitter (3620); and a processor (3602) configured to: determine (3304), at the AP, a bandwidth to be used for a first physical layer protocol data unit (PPDU), said determined bandwidth being the bandwidth of the first PPDU; determine (3306), at the AP, a number of stations (STAs) allowed to use resources of the first PPDU; determine (3312) a resource unit (RU) allocation type for the first PPDU based on at least one of: i) the bandwidth of the first PPDU and ii) the number of stations allowed to use resources of the first PPDU; and operate the AP to transmit (3398), via the wireless transmitter (3620), the first PPDU, said first PPDU including an allocation type subfield with a bit indicating the determined RU allocation type of the first PPDU.
Apparatus Embodiment 1A. The AP of Apparatus Embodiment 1, wherein said processor (3602) is configured to: determine (N output 3316 of step 3314) the RU allocation type based on the BW when the BW is below a first bandwidth (BW) amount (e.g., 80 MHz), said determining including determining (3350) to use a joint RU allocation type when the bandwidth of the first PPDU is below said first BW amount, as part of being configured to determine (3312) a resource unit (RU) allocation type for the first PPDU based on at least one of: i) the bandwidth of the first PPDU and ii) the number of stations allowed to use resources of the first PPDU.
Apparatus Embodiment 1B. The AP of Apparatus Embodiment 1, wherein said processor (3602) is configured to: determine (Y output 3318 of step 3314) the RU allocation type based on both the BW and the number of STAs to which RU are being allocated when the BW is equal to or greater than a first bandwidth (BW) amount (e.g., 80 MHz), as part of being configured to determine (3312) a resource unit (RU) allocation type for the first PPDU based on at least one of: i) the bandwidth of the first PPDU and ii) the number of stations allowed to use resources of the first PPDU.
Apparatus Embodiment 1C. The AP of Apparatus Embodiment 1, wherein said processor (3602) is configured to: determine (3352) to use an individual RU allocation type when (Y output 3324 of step 3320) the PPDU BW is equal to a first BW amount (e.g., 80 MHz) and the number of STAs to which RUs are being allocated is less than a first number of STAs (e.g., 4), as part of being configured to determine (3312) a resource unit (RU) allocation type for the first PPDU based on at least one of: i) the bandwidth of the first PPDU and ii) the number of stations allowed to use resources of the first PPDU.
Apparatus Embodiment 1C1. The AP of Apparatus Embodiment 1, wherein said processor is configured to: determine (3350) to use a joint RU allocation type when (Y output 3328 of step 3326) the PPDU BW is equal to a first BW amount (e.g., 80 MHz) and the number of STAs to which RUs are being allocated is greater than or equal to a first number of STAs (e.g., 4), as part of being configured to determine (3312) a resource unit (RU) allocation type for the first PPDU based on at least one of: i) the bandwidth of the first PPDU and ii) the number of stations allowed to use resources of the first PPDU.
Apparatus Embodiment 1E. The AP of Apparatus Embodiment 1, wherein said processor (3602) is configured to: determine (3352) to use an individual RU allocation type when (Y output 3336 of step 3332) the PPDU BW is equal to a second BW amount (e.g., 160 MHz) and the number of STAs to which RUs are being allocated is less than a second number of STAs (e.g., 8), as part of being configured to determine (3312) a resource unit (RU) allocation type for the first PPDU based on at least one of: i) the bandwidth of the first PPDU and ii) the number of stations allowed to use resources of the first PPDU.
Apparatus Embodiment 1E1. The AP of Apparatus Embodiment 1, wherein said processor (3602) is configured to: determine (3350) to use a joint RU allocation type when (Y output 3340 of step 3338) the PPDU BW is equal to a second BW amount (e.g., 160 MHz) and the number of STAs to which RUs are being allocated is greater than or equal to a second number of STAs (e.g., 8), as part of being configured to determine (3312) a resource unit (RU) allocation type for the first PPDU based on at least one of: i) the bandwidth of the first PPDU and ii) the number of stations allowed to use resources of the first PPDU.
Apparatus Embodiment 1F. The AP of Apparatus Embodiment 1, wherein said processor (3602) is configured to: determine (3352) to use an individual RU allocation type when (Y output 3348 of step 3344) the PPDU BW is equal to a third BW amount (e.g., 320 MHz) and the number of STAs to which RUs are being allocated is less than a third number of STAs (e.g., 16), as part of being configured to determine (3312) a resource unit (RU) allocation type for the first PPDU based on at least one of: i) the bandwidth of the first PPDU and ii) the number of stations allowed to use resources of the first PPDU.
Apparatus Embodiment 1F1. The AP of Apparatus Embodiment 1, wherein said processor (3602) is configured to: determine (3350) to use a joint RU allocation type when (N output 3346 of step 3344) the PPDU BW is equal to a third BW amount (e.g., 320 MHz) and the number of STAs to which RUs are being allocated is not less than a third number of STAs (e.g., 16), as part of being configured to determine (3312) a resource unit (RU) allocation type for the first PPDU based on at least one of: i) the bandwidth of the first PPDU and ii) the number of stations allowed to use resources of the first PPDU.
Apparatus Embodiment 2. The AP of Apparatus Embodiment 1, wherein the resource allocation type is one of a joint RU allocation type (e.g., as indicated by RU allocation type subfield value being set to 0) or an individual (per STA) RU allocation type (e.g., as indicated by setting the RU allocation type subfield value being set to 1).
Apparatus Embodiment 3. The AP of Apparatus Embodiment 2, wherein said processor (3602) is further configured to: generate: (3367) said first PPDU, said first PPDU including an allocation type bit (e.g., of an allocation type subfield) set to a value (e.g., 1) indicating an individual type RU allocation and including individual per STA RU allocations, when the determined RU allocation type is the individual RU allocation type.
Apparatus Embodiment 3A1. The AP of Apparatus Embodiment 3, wherein said processor (3602) is configured to: generate an individual per STA RU allocation, wherein generating an individual per STA RU allocation includes generating a 9-bit RU allocation field value, to be included in a RU allocation subfield included in a user specific field in the EHT-SIG field.
Apparatus Embodiment 3A2. The AP of Apparatus Embodiment 3A1, wherein said processor (3602) is configured to generate said 9-bit RU allocation field value, to be included in a RU allocation subfield included in a user specific field in the EHT-SIG field, based on a second mapping table (e.g., table 9-46l of Reference [1]).
Apparatus Embodiment 3A3. The AP of Apparatus Embodiment 3A2, wherein the second mapping table enumerates possible RUs/MRUs alternatives, which may be allocated to an individual STA.
Apparatus Embodiment 3A. The AP of Apparatus Embodiment 2, wherein said processor (3602) is configured to operate the AP to: generate said first PPDU, said first PPDU including an allocation type bit (e.g., of an allocation type subfield) set to a value (e.g., 0) indicating an individual type RU allocation and including individual per STA RU allocations, when the determined RU allocation type is the individual RU allocation type.
Apparatus Embodiment 4. The AP of Apparatus Embodiment 3, wherein the individual per STA RU allocations include allocations for multiple different individual STAs.
Apparatus Embodiment 5. The AP of Apparatus Embodiment 4, wherein said processor (3602) is configured to include individual per-STA RU allocations in the User-specific field of EHT-SIG (or UHR-SIG for a UHR PPDU or another signal field for another type of PPDU), with individual allocations being indicated for each STA which is allocated resources of the first PPDU.
Apparatus Embodiment 5A. The AP of Apparatus Embodiment 5, wherein RU allocation subfields (RU allocation-A subfields and/or RU allocation-B subfields) are not included in the common field of EHT-SIG, when individual type RU allocation is being used to communicate PPDU resource allocation information.
Apparatus Embodiment 5B. The AP of Apparatus Embodiment 5, wherein said processor (3602) is configured to: include RU allocation subfields (RU allocation-A subfields and/or RU allocation-B subfields) in the common field of EHT-SIG, when the joint type RU allocation is being used to communicate PPDU resource allocation information.
Apparatus Embodiment 5B1. The AP of Apparatus Embodiment 5B, wherein said processor (3602) is configured to: generate a 9-bit value for a RU allocation subfield (RU allocation-A subfields or RU allocation-B subfields) based on a first mapping table (e.g., table 36-34 of Reference [1]).
Apparatus Embodiment 5B2. The AP of Apparatus Embodiment 5, wherein there is one RU allocation subfield, included in common field, per 20 MHz BW.
Apparatus Embodiment 5C. The AP of Apparatus Embodiment 5B, wherein said processor (3602) is configured to generate 9-bit values for RU allocation subfields (RU allocation-A subfields and/or RU allocation-B subfields) which are included in the common field of EHT-SIG.
Apparatus Embodiment 6. The AP of Apparatus Embodiment 2, wherein the processor (3602) is configured to operate the AP to generate (3367) said first DL MU-PPDU including an allocation type bit (e.g., in an allocation type subfield) set to a value (e.g., 0), when the determined RU allocation type is the joint RU allocation type.
Apparatus Embodiment 6A. The AP of Apparatus Embodiment 2, wherein said processor (3602) is configured to operate the AP to: generate said first DL MU-PPDU including an allocation type bit (e.g., in an allocation type subfield) set to a value (e.g., 1), when the determined RU allocation type is the joint RU allocation type.
Apparatus Embodiment 8. The AP of Apparatus Embodiment 1, wherein the first PPDU is a downlink (DL) multi-user (MU) PPDU.
Apparatus Embodiment 8A. The AP of Apparatus Embodiment 8, wherein the DL MU-PPDU is an EHT MU PPDU.
Apparatus Embodiment 8B. The AP of Apparatus Embodiment 8, wherein the DL MU-PPDU is an UHR MU PPDU.
Apparatus Embodiment 9. The AP of Apparatus Embodiment 8, wherein the number of RU allocation subfield bits used to communicate the RU allocation for a DL MU-PPDU, using joint type allocation, is a function of the BW irrespective of the number of STAs receiving an allocation; and wherein the number of RU allocation subfield bits used to communicate the RU allocation for a DL MU-PPDU, using individual type allocation, is a function of the number of STAs receiving the allocation irrespective of the BW.
Apparatus Embodiment 9A. The AP of Apparatus Embodiment 9, wherein the processor (3602) is configured to: include, in RU allocation-A or RU allocation-B subfields in one or more common fields of EHT-SIG, the RU allocation subfield bits used to communicate the RU allocation for a DL MU-PPDU, when using joint type allocation; and include, in per-STA RU allocation subfields in one or more user fields of user specific field of EHT-SIG, the RU allocation subfield bits used to communicate the RU allocation for a DL MU-PPDU, when using individual type allocation.

### 2nd Numbered List of Exemplary Method Embodiments

Method Embodiment 1. A method of operating a first station (STA), the method comprising: receiving (3404) a DL MU-PPDU; recovering (3406) a RU allocation type value communicated in an RU allocation type subfield of a PHY header of the received DL MU-PPDU; determining (3312) an RU allocation type being used in the DL MU-PPDU based on the recovered RU allocation type value; and identifying (3426), based on the determined RU allocation type, set of RUs of the DL MU-PPDU which have been allocated to the first STA.
Method Embodiment 2. The method of Method Embodiment 1, wherein determining (3312) an RU allocation type being used in the DL MU-PPDU based on the recovered RU allocation type value includes: determining from the RU allocation type value if RU allocation type is a joint RU allocation type (3420) or an individual RU allocation type (3422).
Method Embodiment 3. The method of Method Embodiment 2, wherein identifying (3426), based on the determined RU allocation type, a set of RUs of the DL MU-PPDU which have been allocated to the first STA includes using (3438) a first RU allocation bit pattern to RU allocation table (e.g., look-up table 36-34 of reference 1) when the determined RU allocation type is a joint RU allocation type and using (3454) a second RU allocation bit pattern to RU allocation table (e.g., table 9-46l of reference [1]) when the RU allocation type is determined to be an individual RU allocation type.
Method Embodiment 4. The method of Method Embodiment 2, wherein determining (3312) an RU allocation type being used in the DL MU-PPDU includes determining (3420) that the allocation type being used is a joint RU allocation type; and wherein identifying (3426), based on the determined RU allocation type, a set of RUs of the DL MU-PPDU which have been allocated to the first STA includes: performing (3434) a joint type allocation information processing operation to recover the RU allocation to the first STA.
Method Embodiment 4A. The method of Method Embodiment 4, wherein performing (3434) a joint type allocation processing operation to recover the RU allocation to the first STA includes: recovering (3436) information from RU allocation subfields in common fields of the EHT-SIG field.
Method Embodiment 4B. The method of Method Embodiment 4A, wherein performing (3434) a joint type allocation processing operation to recover the RU allocation to the first STA further includes: using (3438) a first mapping table (e.g., look-up table 36-34 of Reference [1]) to map a recovered 9-bit pattern to an RU assignment for each RU allocation subfield and to a number of user fields to determine RUs or MRUs for each 20 MHz BW (bandwidth) part to which the recovered information relates and a number of user fields for each 20 MHz BW part to which the recovered information relates.
Method Embodiment 4C. The method of Method Embodiment 4A, wherein performing (3434) a joint type allocation processing operation to recover the RU allocation to the first STA includes: recovering (3440) information from STA ID subfields of user fields included RU allocation information indicating the STA to which each RU allocation made in the joint allocation corresponds.
Method Embodiment 4D. The method of Method Embodiment 4C, wherein performing (3434) a joint type allocation processing operation to recover the RU allocation to the STA includes: identifying (3442) (e.g., locating) at least one user field corresponding to first STA; and identifying (3444): i) a set of RUs, ii) a set of MRUs or iii) a set of RUs and MRUs corresponding to the identified user field corresponding to the first STA, said identified set of RUs, MRUs or RUs and MRUs being resources allocated to the first STA.
Method Embodiment 5. The method of Method Embodiment 2, wherein determining (3312) an RU allocation type being used in the DL MU-PPDU includes determining (3422) that the allocation type being used is an individual allocation type; and wherein identifying (3426), based on the determined RU allocation type, a set of RUs of the DL MU-PPDU which have been allocated to the first STA includes: performing (3446) an individual RU type allocation information processing operation to recover the RU allocation to the first STA.
Method Embodiment 6. The method of Method Embodiment 5, wherein performing (3446) an individual RU type allocation information processing operation to recover the RU allocation to the first STA includes: recovering (3452) a bit patten (e.g., a 9-bit pattern) in a user specific field (e.g., of a EHT-SIG field) corresponding to the first STA; and using (3454) a second mapping table (e.g., table 9-46l of reference 1) to map the recovered bit pattern to RUs to thereby determine the RU allocation to the first STA.
Method Embodiment 7. The method of Method Embodiment 3, further comprising: recovering (3456) from the identified set of RUs of the received DL MU-PPDU allocated to the STA downlink traffic data directed to the first STA.

### 2nd Numbered List of Exemplary Apparatus Embodiments

Apparatus Embodiment 1. A first station (STA) (3507 or 3700), comprising: a wireless receiver (3724); and a processor (3702) configured to: operate the STA to receive (3404) a DL MU-PPDU; operate the STA to recover (3406) a RU allocation type value communicated in an RU allocation type subfield of a PHY header of the received DL MU-PPDU; determine (3312) an RU allocation type being used in the DL MU-PPDU based on the recovered RU allocation type value; and identify (3426), based on the determined RU allocation type, a set of RUs of the DL MU-PPDU which have been allocated to the first STA.
Apparatus Embodiment 2. The first STA of Apparatus Embodiment 1, wherein said processor (3702) is configured to: determine from the RU allocation type value if RU allocation type is a joint RU allocation type (3420) or an individual RU allocation type (3422), as part of being configured to determine (3312) an RU allocation type being used in the DL MU-PPDU based on the recovered RU allocation type value.
Apparatus Embodiment 3. The first STA of Apparatus Embodiment 2, wherein said processor (3702) is configured to: use (3438) a first RU allocation bit pattern to RU allocation table (e.g., look-up table 36-34 of reference 1) when the determined RU allocation type is a joint RU allocation type; and use (3454) a second RU allocation bit pattern to RU allocation table (e.g., table 9-46l of reference 1] when the RU allocation type is determined to be an individual RU allocation type, as part of being configured to identify (3426), based on the determined RU allocation type, a set of RUs of the DL MU-PPDU which have been allocated to the first STA.
Apparatus Embodiment 4. The method of Apparatus Embodiment 2, wherein said processor (3702) is configured to: perform (3434) a joint type allocation information processing operation to recover the RU allocation to the first STA, as part of being configured to identify (3426), based on the determined RU allocation type, a set of RUs of the DL MU-PPDU which have been allocated to the first STA, in response to said processor (3702) determining (3420) that the allocation type being used is a joint RU allocation type, as part of being configured to determine (3312) an RU allocation type being used in the DL MU-PPDU.
Apparatus Embodiment 4A. The first STA of Apparatus Embodiment 4, wherein said processor (3702) is configured to operate the STA to: recover (3436) information from RU allocation subfields in common fields of the EHT-SIG field, as part of being configured to perform (3434) a joint type allocation processing operation to recover the RU allocation to the first STA.
Apparatus Embodiment 4B. The first STA of Apparatus Embodiment 4A, wherein said processor (3702) is configured to: use (3438) a first mapping table (e.g., look-up table 36-34 of Reference [1]) to map a recovered 9-bit pattern to an RU assignment for each RU allocation subfield and to a number of user fields to determine RUs or MRUs for each 20 MHz BW (bandwidth) part to which the recovered information relates and a number of user fields for each 20 MHz BW part to which the recovered information relates, as part of being configured to perform (3434) a joint type allocation processing operation to recover the RU allocation to the first STA.
Apparatus Embodiment 4C. The first STA of Apparatus Embodiment 4A, wherein said processor (3702) is configured to: recover (3440) information from STA ID subfields of user fields included RU allocation information indicating the STA to which each RU allocation made in the joint allocation corresponds, as part of being configured to perform (3434) a joint type allocation processing operation to recover the RU allocation to the first STA.
Apparatus Embodiment 4D. The first of Apparatus Embodiment 4C, wherein said processor (3702) is configured to: identify (3442) (e.g., locate) at least one user field corresponding to first STA; and identify (3444): i) a set of RUs, ii) a set of MRUs or iii) a set of RUs and MRUs corresponding to the identified user field corresponding to the first STA, said identified set of RUs, MRUs or RUs and MRUs being resources allocated to the first STA, as part of being configured to perform (3434) a joint type allocation processing operation to recover the RU allocation to the first STA.
Apparatus Embodiment 5. The first STA of Apparatus Embodiment 2, wherein said processor (3702) is configured to: perform (3446) an individual RU type allocation information processing operation to recover the RU allocation to the first STA, as part of being configured to identify (3426), based on the determined RU allocation type, a set of RUs of the DL MU-PPDU which have been allocated to the first STA, in response to said processor (3702) determining (3422) that the allocation type being used is an individual allocation type, as part of said processor determining (3312) an RU allocation type being used in the DL MU-PPDU.
Apparatus Embodiment 6. The first STA of Apparatus Embodiment 5, wherein said processor (3702) is configured to: recover (3452) a bit patten (e.g., a 9-bit pattern) in a user specific field (e.g., of a EHT-SIG field) corresponding to the first STA; and use (3454) a second mapping table (e.g., table 9-46l of reference [1]) to map the recovered bit pattern to RUs to thereby determine the RU allocation to the first STA, as part of being configured to perform (3446) an individual RU type allocation information processing operation to recover the RU allocation to the first STA includes:
Apparatus Embodiment 7. The first STA of Apparatus Embodiment 3, wherein said processor (3702) is further configured to: recover (3456) from the identified set of RUs of the received DL MU-PPDU allocated to the STA downlink traffic data directed to the first STA.

The techniques of various embodiments may be implemented using software, hardware and/or a combination of software and hardware. Various embodiments are directed to apparatus, e.g., access points (AP), e.g., WiFi APs supporting 802.11be and/or future versions, stations (STAs), e.g., WiFi STAs supporting 802.11be and/or future versions, user equipment devices, wireless devices, mobile devices, smartphones, subscriber devices, desktop computers, printers, IPTV, laptops, tablets, network edge devices, Access Points, wireless routers, switches, WLAN controllers, orchestration servers, orchestrators, Gateways, AAA servers, servers, nodes and/or elements. Various embodiments are also directed to methods, e.g., method of controlling and/or operating access points (AP), e.g., WiFi APs, supporting 802.11be and/or future versions, stations (STAs), e.g., WiFi STAs, supporting 802.11be and/or future versions, user equipment devices, wireless devices, mobile devices, smartphones, subscriber devices, desktop computers, printers, IPTV, laptops, tablets, network edge devices, Access Points, wireless routers, switches, WLAN controllers, orchestration servers, orchestrators, Gateways, AAA servers, servers, nodes and/or elements. Various embodiments are also directed to machine, e.g., computer, readable medium, e.g., ROM, RAM, CDs, hard discs, etc., which include machine readable instructions for controlling a machine to implement one or more steps of a method. The computer readable medium is, e.g., non-transitory computer readable medium.

It is understood that the specific order or hierarchy of steps in the processes and methods disclosed is an example of exemplary approaches. Based upon design preferences, it is understood that the specific order or hierarchy of steps in the processes and methods may be rearranged while remaining within the scope of the present disclosure. The accompanying method claims present elements of the various steps in a sample order and are not meant to be limited to the specific order or hierarchy presented. In some embodiments, one or more processors are used to carry out one or more steps of each of the described methods.

In various embodiments each of the steps or elements of a method are implemented using one or more processors. In some embodiments, each of elements or steps are implemented using hardware circuitry.

In some embodiments a buffer is implemented in the form of a queue. Thus, the terms buffers and queues are sometimes used to refer to the same thing.

In various embodiments devices, e.g., access points (AP), e.g., WiFi APs, supporting 802.11be and/or future versions, stations (STAs), e.g., WiFi STAs, supporting 802.11be and/or future versions, user equipment devices, wireless devices, mobile devices, smartphones, subscriber devices, desktop computers, printers, IPTV, laptops, tablets, network edge devices, Access Points, wireless routers, switches, WLAN controllers, orchestration servers, orchestrators, Gateways, AAA servers, servers, nodes and/or elements described herein are implemented using one or more components to perform the steps corresponding to one or more methods, for example, provisioning APs, STAs, user equipment devices, provisioning AP devices, provisioning AAA servers, provisioning orchestration servers, generating messages, message reception, message transmission, signal processing, sending, comparing, determining and/or transmission steps. Thus, in some embodiments various features are implemented using components or, in some embodiments, logic such as for example logic circuits. Such components may be implemented using software, hardware or a combination of software and hardware. Many of the above described methods or method steps can be implemented using machine executable instructions, such as software, included in a machine readable medium such as a memory device, e.g., RAM, floppy disk, etc. to control a machine, e.g., general purpose computer with or without additional hardware, to implement all or portions of the above described methods, e.g., in one or more devices, servers, nodes and/or elements. Accordingly, among other things, various embodiments are directed to a machine-readable medium, e.g., a non-transitory computer readable medium, including machine executable instructions for causing a machine, e.g., processor and associated hardware, to perform one or more of the steps of the above-described method(s). Some embodiments are directed to a device, e.g., a controller, including a processor configured to implement one, multiple or all of the steps of one or more methods of the invention.

In some embodiments, the processor or processors, e.g., CPUs, of one or more devices, e.g., access points (AP), e.g., WiFi APs, supporting 802.11be and/or future versions, stations (STAs), e.g., WiFi STAs, supporting 802.11be and/or future versions, user equipment devices, wireless devices, mobile devices, smartphones, subscriber devices, desktop computers, printers, IPTV, laptops, tablets, network edge devices, Access Points, wireless routers, switches, WLAN controllers, orchestration servers, orchestrators, Gateways, AAA servers, servers, nodes and/or elements, are configured to perform the steps of the methods described as being performed by the user equipment devices, wireless devices, mobile devices, smartphones, subscriber devices, desktop computers, printers, IPTV, laptops, tablets, network edge devices, Access Points, wireless routers, switches, WLAN controllers, orchestration servers, orchestrators, Gateways, AAA servers, servers, nodes and/or elements. The configuration of the processor may be achieved by using one or more components, e.g., software components, to control processor configuration and/or by including hardware in the processor, e.g., hardware components, to perform the recited steps and/or control processor configuration. Accordingly, some but not all embodiments are directed to a device, e.g., access point (AP), e.g., WiFi AP, supporting 802.11be and/or future versions, station (STA), e.g., WiFi STA, supporting 802.11be and/or future versions, user equipment devices, wireless devices, mobile devices, smartphones, subscriber devices, desktop computers, printers, IPTV, laptops, tablets, network edge devices, Access Points, wireless routers, switches, WLAN controllers, orchestration servers, orchestrators, Gateways, AAA servers, servers, nodes and/or elements, with a processor which includes a component corresponding to each of the steps of the various described methods performed by the device in which the processor is included. In some but not all embodiments a device, e.g., access points (AP), e.g., WiFi AP, supporting 802.11be and/or future versions, stations (STA), e.g., WiFi STA, supporting 802.11be and/or future versions, user equipment devices, wireless devices, mobile devices, smartphones, subscriber devices, desktop computers, printers, IPTV, laptops, tablets, network edge devices, Access Points, wireless routers, switches, WLAN controllers, orchestration servers, orchestrators, Gateways, AAA servers, servers, nodes and/or elements, includes a controller corresponding to each of the steps of the various described methods performed by the device in which the processor is included. The components may be implemented using software and/or hardware.

Some embodiments are directed to a computer program product comprising a computer-readable medium, e.g., a non-transitory computer-readable medium, comprising code for causing a computer, or multiple computers, to implement various functions, steps, acts and/or operations, e.g., one or more steps described above. Depending on the embodiment, the computer program product can, and sometimes does, include different code for each step to be performed. Thus, the computer program product may, and sometimes does, include code for each individual step of a method, e.g., a method of controlling a device, e.g., an access point (AP), e.g., WiFi AP, supporting 802.11be and/or future versions, a stations (STA), e.g., a WiFi STA, supporting 802.11be and/or future versions, user equipment devices, wireless devices, mobile devices, smartphones, subscriber devices, desktop computers, printers, IPTV, laptops, tablets, network edge devices, Access Points, wireless routers, switches, WLAN controllers, orchestration servers, orchestrators, Gateways, AAA servers, servers, nodes and/or elements. The code may be in the form of machine, e.g., computer, executable instructions stored on a computer-readable medium, e.g., a non-transitory computer-readable medium, such as a RAM (Random Access Memory), ROM (Read Only Memory) or other type of storage device. In addition to being directed to a computer program product, some embodiments are directed to a processor configured to implement one or more of the various functions, steps, acts and/or operations of one or more methods described above. Accordingly, some embodiments are directed to a processor, e.g., CPU, configured to implement some or all of the steps of the methods described herein. The processor may be for use in, e.g., a communications device such an access points (AP), e.g., a WiFi AP, supporting 802.11be and/or future versions, a station (STA), e.g., WiFi STA, supporting 802.11be and/or future versions, a user equipment device, wireless device, mobile device, smartphone, subscriber device, desktop computer, printer, IPTV, laptop, tablets, network edge device, Access Point, wireless router, switch, WLAN controller, orchestration server, orchestrator, Gateway, AAA server, server, node and/or element or other device described in the present application.

Numerous additional variations on the methods and apparatus of the various embodiments described above will be apparent to those skilled in the art in view of the above description. Such variations are to be considered within the scope. Numerous additional embodiments, within the scope of the present invention, will be apparent to those of ordinary skill in the art in view of the above description and the claims which follow. Such variations are to be considered within the scope of the invention.

What is claimed is:

1. A method of operating an access point (AP), the method comprising:
determining, at the AP, a bandwidth to be used for a first physical layer protocol data unit (PPDU), said determined bandwidth being the bandwidth of the first PPDU;
determining, at the AP, a number of stations (STAs) allowed to use resources of the first PPDU;
determining a resource unit (RU) allocation type for the first PPDU based on at least one of: i) the bandwidth of the first PPDU and ii) the number of stations allowed to use resources of the first PPDU; and
transmitting the first PPDU, said first PPDU including an allocation type subfield with a bit indicating the determined RU allocation type of the first PPDU.

2. The method of claim 1, wherein the resource allocation type is one of a joint RU allocation type or an individual (per STA) RU allocation type.

3. The method of claim 2, wherein the determined RU allocation type is the individual RU allocation type, and wherein the method further includes:
generating said first PPDU, said first PPDU including an allocation type bit set to a value indicating an individual type RU allocation and including individual per STA RU allocations.

4. The method of claim 3, wherein the individual per STA RU allocations include allocations for multiple different individual STAs.

5. The method of claim 4, wherein individual per-STA RU allocations are included in the User-specific field of EHT-SIG, with individual allocations being indicated for each STA which is allocated resources of the first PPDU.

6. The method of claim 2, wherein the determined RU allocation type is the joint RU allocation type, and wherein the method further includes:
generating said first DL MU-PPDU including an allocation type bit set to a value indicating a joint type RU allocation.

7. The method of claim 1, wherein the first PPDU is a downlink (DL) multiuser (MU) PPDU.

8. The method of claim 7, wherein the DL MU PPDU is one of an EHT MU PPDU or a UHR MU PPDU.

9. The method of claim 8, wherein the number of RU allocation subfield bits used to communicate the RU allocation for a DL MU-PPDU, using joint type allocation, is a function of the BW irrespective of the number of STAs receiving an allocation; and
wherein the number of RU allocation subfield bits used to communicate the RU allocation for a DL MU-PPDU, using individual type allocation, is a function of the number of STAs receiving the allocation irrespective of the BW.

10. The method of claim 9, wherein the RU allocation subfield bits used to communicate the RU allocation for a DL MU-PPDU, using joint type allocation, are included in RU allocation-A or RU allocation-B subfields in one or more common fields of EHT-SIG; and
wherein the RU allocation subfield bits used to communicate the RU allocation for a DL MU-PPDU, using individual type allocation, are included in per-STA RU allocation subfields in one or more user fields of user specific field of EHT-SIG.

11. An access point (AP) comprising:
a wireless transmitter; and
a processor configured to:
determine, at the AP, a bandwidth to be used for a first physical layer protocol data unit (PPDU), said determined bandwidth being the bandwidth of the first PPDU;
determine, at the AP, a number of stations (STAs) allowed to use resources of the first PPDU;
determine a resource unit (RU) allocation type for the first PPDU based on at least one of: i) the bandwidth of the first PPDU and ii) the number of stations allowed to use resources of the first PPDU; and
operate the AP to transmit, via the wireless transmitter, the first PPDU, said first PPDU including an allocation type subfield with a bit indicating the determined RU allocation type of the first PPDU.

12. The AP of claim 11, wherein the resource allocation type is one of a joint RU allocation type or an individual (per STA) RU allocation type.

13. The AP of claim 12, wherein said processor is further configured to:
generate said first PPDU, said first PPDU including an allocation type bit set to a value indicating an individual type RU allocation and including individual per STA RU allocations, when the determined RU allocation type is the individual RU allocation type.

14. The AP of claim 13, wherein the individual per STA RU allocations include allocations for multiple different individual STAs.

15. The AP of claim 14, wherein said processor is configured to include individual per-STA RU allocations in the User-specific field of EHT-SIG, with individual allocations being indicated for each STA which is allocated resources of the first PPDU.

16. A method of operating a first station (STA), the method comprising:
receiving a DL MU-PPDU;
recovering a RU allocation type value communicated in an RU allocation type subfield of a PHY header of the received DL MU-PPDU;
determining an RU allocation type being used in the DL MU-PPDU based on the recovered RU allocation type value; and
identifying, based on the determined RU allocation type, set of RUs of the DL MU-PPDU which have been allocated to the first STA.

17. The method of claim 16, wherein determining an RU allocation type being used in the DL MU-PPDU based on the recovered RU allocation type value includes:
determining from the RU allocation type value if RU allocation type is a joint RU allocation type or an individual RU allocation type.

18. The method of claim 17,
wherein identifying, based on the determined RU allocation type, a set of RUs of the DL MU-PPDU which have been allocated to the first STA includes using a first RU allocation bit pattern to RU allocation table when the determined RU allocation type is a joint RU allocation type and using a second RU allocation bit pattern to RU allocation table when the RU allocation type is determined to be an individual RU allocation type.

19. The method of claim 17,
wherein determining an RU allocation type being used in the DL MU-PPDU includes determining that the allocation type being used is a joint RU allocation type; and
wherein identifying, based on the determined RU allocation type, a set of RUs of the DL MU-PPDU which have been allocated to the first STA includes:
performing a joint type allocation information processing operation to recover the RU allocation to the first STA.

20. The method of claim 17,
wherein determining an RU allocation type being used in the DL MU-PPDU includes determining that the allocation type being used is an individual allocation type; and
wherein identifying, based on the determined RU allocation type, a set of RUs of the DL MU-PPDU which have been allocated to the first STA includes:
performing an individual RU type allocation information processing operation to recover the RU allocation to the first STA.

21. The method of claim 20, wherein performing an individual RU type allocation information processing operation to recover the RU allocation to the first STA includes:
recovering a bit patten in a user specific field corresponding to the first STA; and
using a second mapping table to map the recovered bit pattern to RUs to thereby determine the RU allocation to the first STA.

22. The method of claim 18, further comprising:
recovering from the identified set of RUs of the received DL MU-PPDU allocated to the STA downlink traffic data directed to the first STA.

23. A first station (STA), comprising:
a wireless receiver; and
a processor configured to:
operate the STA to receive a DL MU-PPDU;
operate the STA to recover a RU allocation type value communicated in an RU allocation type subfield of a PHY header of the received DL MU-PPDU;
determine an RU allocation type being used in the DL MU-PPDU based on the recovered RU allocation type value; and
identify, based on the determined RU allocation type, a set of RUs of the DL MU-PPDU which have been allocated to the first STA.

24. The first STA of claim 23, wherein said processor is configured to:
determine from the RU allocation type value if RU allocation type is a joint RU allocation type or an individual RU allocation type, as part of being configured to determine an RU allocation type being used in the DL MU-PPDU based on the recovered RU allocation type value.

25. The first STA of claim 24, wherein said processor is configured, as part of being configured to identify, based on the determined RU allocation type, a set of RUs of the DL MU-PPDU which have been allocated to the first STA, to:
use a first RU allocation bit pattern to RU allocation table when the determined RU allocation type is a joint RU allocation type; and
use a second RU allocation bit pattern to RU allocation table when the RU allocation type is determined to be an individual RU allocation type.
includes

26. The first STA of claim 24, wherein said processor is configured to:
perform a joint type allocation information processing operation to recover the RU allocation to the first STA, as part of being configured to identify, based on the determined RU allocation type, a set of RUs of the DL MU-PPDU which have been allocated to the first STA,
in response to said processor determining that the allocation type being used is a joint RU allocation type, as part of being configured to determine an RU allocation type being used in the DL MU-PPDU.

27. The first STA of claim 24, wherein said processor is configured to:
perform an individual RU type allocation information processing operation to recover the RU allocation to the first STA, as part of being configured to identify, based on the determined RU allocation type, a set of RUs of the DL MU-PPDU which have been allocated to the first STA,
in response to said processor determining that the allocation type being used is an individual allocation type, as part of said processor determining an RU allocation type being used in the DL MU-PPDU.

28. The first STA of claim 27, wherein said processor is configured to:
recover a bit patten in a user specific field corresponding to the first STA; and
use a second mapping table to map the recovered bit pattern to RUs to thereby determine the RU allocation to the first STA,
as part of being configured to perform an individual RU type allocation information processing operation to recover the RU allocation to the first STA.
